(19) United States
(12) Patent Application Publication
(10) Pub. No.: US 2014/0222349 A1
(43) Pub. Date: Aug. 7, 2014

(54) System and Methods for Pharmacogenomic Classification

(71) Applicant: AssureRx Health, Inc., Mason, OH (US)

(72) Inventors: Gerald A. Higgins, Mason, OH (US); C. Anthony Altar, Mason, OH (US); Ned Way, Mason, OH (US)

(21) Appl. No.: 14/155,863

(22) Filed: Jan. 15, 2014

Related U.S. Application Data
(60) Provisional application No. 61/834,494, filed on Jun. 13, 2013.
(60) Provisional application No. 61/753,318, filed on Jan. 16, 2013.

(51) Int. Cl. G06F 19/18

(52) U.S. Cl. CPC G06F 19/18
USPC 702/19

(57) ABSTRACT

The invention provides a system and methods for the determination of the pharmacogenomic phenotype of any individual or group of individuals, ideally classified to a discrete, specific and defined pharmacogenomic population(s) using machine learning and population structure. Specifically, the invention provides a system that integrates several subsystems, including (1) a system to classify an individual as to pharmacogenomic cohort status using properties of underlying structural elements of the human population based on differences in the variations of specific genes that encode proteins and enzymes involved in the absorption, distribution, metabolism and excretion (ADME) of drugs and xenobiotics, (2) the use of a pre-trained learning machine for classification of a set of electronic health records (EHRs) as to pharmacogenomic phenotype in lieu of genotype data contained in the set of EHRs, (3) a system for prediction of pharmacological risk within an inpatient setting using the system of the invention, (4) a method of drug discovery and development using pattern-matching of previous drugs based on pharmacogenomic phenotype population clusters, and (5) a method to build an optimal pharmacogenomics knowledge base through derivatives of private databases contained in pharmaceutical companies, biotechnology companies and academic research centers without the risk of exposing raw data contained in such databases. Embodiments include pharmacogenomic decision support for an individual patient in an inpatient setting, and optimization of clinical cohorts based on pharmacogenomic phenotype for clinical trials in drug development.

### FIELD OF THE INVENTION

The present invention relates to systems and methods for data processing and testing in relation to clinical decision support and clinical trial design for the determination of drug efficacy and safety for an individual or group of individuals. The invention utilizes techniques of biomedical informatics for the classification of a patient, clinical trial participant, or group of such individuals, into an unambiguous and discrete pharmacogenomic phenotype based on the totality of known variation in ADME (absorption, distribution, metabolism and excretion) genes derived from whole genome analysis that can be modified by clinical data.

### BACKGROUND OF THE INVENTION

Pharmacogenomics is the study of how an individual responds to a drug in terms of efficacy and toxicity based on their genomic profile. It is well understood that genetic variation between individuals is an important determinant of drug response and adverse drug reactions (ADRs). Since the draft human genome sequences were first published, a so-called ‘post-genomic’ era of research has focused on genome-wide association studies (GWAS) in many different medical specialties, which have been directed towards finding common SNP determinants of disease risk and pharmacologic response. In the search for the genetic basis of drug efficacy and ADRs, many important factors that contribute to response and toxicity have not been included in the analysis. This is partly because the incorporation of additional factors into the analysis would substantially increase the number of co-variables, making the identification of predictive associations more difficult.

One important application of pharmacogenomics is for clinical decision support in the electronic health record, to support clinicians in the recognition of ADRs for an individual patient, based on drug-drug and drug-gene interactions. The U.S. Food and Drug Administration (FDA) has estimated that close to sixty percent of avoidable (‘preventable’) ADRs are caused by mutations in the genes that encode drug metabolism enzymes and drug transporter proteins. Such genes are often collectively referred to as absorption, distribution, metabolism and excretion (ADME) genes. But understanding the impact of genetic polymorphisms in ADME genes is challenging. In part this is because the effect of a particular polymorphism may vary with concomitant exposure to other drugs, smoking, diet, lifestyle, etc., as well as comorbid disease. For example, the binning of various CYP genotypes into functional groups (extensive metabolizer, poor metabolizer, etc.) is often mistakenly considered to be drug-specific, and thus perceived to be difficult to determine without direct experimental evidence.

Another important application of pharmacogenomics is to provide the ability to accurately stratify potential clinical trial participants based on risk profile prior to conducting the clinical trials themselves. Indeed, the ability to accurately stratify potential participants is an important strategy in the drug development process for bringing a new molecular entity (NME) to market. This is evidenced by the fact that forty percent of exits from clinical trials are caused by pharmacokinetic toxicity of the test compound.

The growth spurred by next generation sequencing has led to an exponential increase in personal genomic data and increasing insight into which sequence variants correlate with drug response and ADRs. For example, it is now evident that copy number variants (CNVs) may contribute as much to an individual's pharmacogenomic profile as do single nucleotide polymorphisms (SNPs). But the combination of factors responsible for drug toxicity extends beyond the kind of genetic polymorphisms that can be detected using traditional GWAS. For example, ethnic differences in ADME isoform activity are major factors responsible for variability in drug and xenobiotic kinetics, response and toxicity. However, cluster analysis demonstrates that ethnicity or geographical ancestry is not as accurate as are methods subsumed in population structure that can determine pharmacogenomic phenotype using a priori knowledge of all current ADME variation as modified by population admixture and significant clinical co-variables. This is evidenced by work such as that reported in connection with the 1000 genomes project (Nature 467:1061-1073 (2010)) which examined many ethnic sub-populations around the world. In addition, some of the most significant attributes causing drug toxicity in humans involve not only genome variation but also clinical factors. But previous attempts to incorporate clinical factors into the analysis have been hampered by a number of factors. These include poor quality of data contained in some “de-identified” electronic health records (EHRs) which are a primary source of the relevant information. These de-identified EHR datasets are problematic for a number of reasons including missing values, integration errors, and problems associated with the vagueness of clinical concepts.

### SUMMARY OF THE INVENTION

The present invention is predicated on the hypothesis, demonstrated herein to be true, that with the use of statistical methods to identify population structure, it is possible to find population clusters that display large differences in drug toxicity and drug response using a sufficiently large dataset of whole human genome data. The identification of these population clusters is therefore essential to the accurate classification of individuals and groups of individuals into the correct drug metabolizer phenotype. As demonstrated by the present invention, the incorporation of additional clinical co-variables into the analysis provides excellent statistical power for the classification of any human individual into a one of a discrete set of pharmacogenomic phenotypes identified by the invention, which set of phenotypes represents the all known pharmacogenomic phenotypes in the human population at a given time. The methods of the invention are necessarily computerized methods and/or computer-assisted or computer implemented methods, including software algorithms.

The pharmacogenomic classification methods and systems of the invention combine machine learning, artificial intelligence, database systems, and computational statistics to identify hidden patterns in large datasets of genomic and clinical data. The methods of the invention are based on segregating pharmacogenomic subtypes using the population structure identified in whole human genome data, and, optionally further refining the classification using certain clinical co-variables. In particular, the methods of the invention identify population structure in a sufficiently large dataset of ADME genomic variation, such as that contained in a large dataset of whole human genome sequences or other genomic data Population structure refers to the underlying and sometimes cryptic genetic features that divide human populations by ancestry so that they do not represent a continuum of phenotypes, but rather deviate from “panmixia” (also referred as “random breeding”). The methods of the invention further comprise optionally incorporating a discrete set of pre-determined, significant clinical co-variables into the analysis. Such clinical data can be obtained from, for example, a database of electronic health records (EHRs) or similar clinical database.

According to the methods described here, all available information about the individual or group to be classified is incorporated into the classifier. The available information may include either genomic or clinical information, or both. In one embodiment, the available information is utilized by a learning machine that has been pre-trained on a training set of data attributes which form a set of ‘surrogate phenotypes’. The set of surrogate phenotypes is a pre-determined set of significant population cluster instances and attributes, determined according to the methods of the invention and provided herein. The methods of the invention are designed to ensure that the set of surrogate phenotypes correctly represents all known foundational pharmacogenomic phenotypes in the human population at a given time. Preferably, the set of surrogate phenotypes is pre-processed and tested for optimization of classification accuracy in a series of pre-processing steps. In one embodiment, the set is contained in the pharmacogenomic classification system 108 as a library of surrogate phenotypes against which the available information (phenotype) from an individual or group is compared.

In the context of a preferred embodiment of the present invention, machine learning is utilized in an inductive approach to pharmacogenomic classification based on the set of surrogate phenotypes. Using all available information about the individual or group to be classified (this information may be referred to herein as the individual or group's ‘phenotype’), a learning machine trained on this dataset is able to identify patterns in the information (phenotype) that can be used to classify it into one of a discrete set of pharmacogenomic phenotypes representing all known foundational pharmacogenomic phenotypes in the human population at a given time (referred to herein as ‘surrogate phenotypes’). In another embodiment, an automated classifier other than a learning machine is utilized to identify the patterns in the input phenotype data and compare them to the set of surrogate phenotypes using the data attributes provided by the invention. Examples of automated classifiers that can be used in accordance with this embodiment include Markov chain Monte Carlo computations, linear and non-linear classification algorithms including regression, Bayesian calculation of group member probabilities, decision trees and pattern-matching algorithms.

Using the methods of the invention, the pharmacogenomic metabolizer status of any individual or group can be determined even where the available information about the individual or group contains missing or incomplete data attributes. According to one embodiment, machine learning is utilized to build a model of an individual's (or group's) phenotype based on the available information about that individual (or group). In a pre-processing step, the classification system checks the completeness of the data attributes required to make an accurate decision about classifying the individual's phenotype into one of a member of the discrete set of surrogate phenotypes. When the required data attributes are insufficient to make a decision, the system replaces the missing data using the average value of the corresponding data feature(s) in the library of surrogate phenotypes embedded in the classification system. This provides a ‘best fit’ of the available data for any ‘live’ individual (or group) to the available data for the entire human population as represented by the discrete set of surrogate phenotypes.

The invention also provides methods and systems for updating the set of surrogate phenotypes by updating the underlying information (data attributes) on which the surrogate phenotypes are based. Thus, although the set of pharmacogenomically-discrete subpopulations may change over time due to human migration, genetic drift, etcetera, the invention provides methods for ensuring that the set of surrogate phenotypes represents all known pharmacogenomic phenotypes in the human population at a given time.

The methods of the invention provide a more accurate representation of the individual patient, clinical trial participant, or group of such individuals as to pharmacogenomic profile than can be obtained with prior art methods. The methods of the invention consequently provide a more accurate determination of an individual's actual drug response or risk of toxicity for a given therapy. This is useful in numerous applications, particularly in pharmacogenomic decision support, e.g., for the matching of therapies with specific individuals (and populations of individuals), and in selection of clinical trial participants based on pharmacokinetic risk because the methods of the invention provide a more accurate classification of potential clinical trial participants into a drug metabolizer phenotype that is more determinative of a participant's actual risk of toxicity.

In one embodiment, the invention provides a method for classifying an individual or group of individuals into one of a member of a discrete set of pharmacogenomic phenotypes, the method comprising using as a classifier a learning machine pre-trained on a training dataset comprising genes encoding proteins involved in the absorption, distribution, metabolism and excretion (ADME) of medications and xenobiotics (ADME genes) and specific variants of those genes, said variants comprising variant star alleles, single nucleotide polymorphisms (SNPs), and structural variants, wherein the ADME genes and gene variants are instantiated in the training set as a discrete set of ‘surrogate phenotypes’ obtained using methods of population structure and clustering, and wherein the surrogate phenotypes have been optimized for classification in one or more pre-processing steps. In this context, the term ‘surrogate phenotypes’ refers to the training set, not the resulting classified phenotypes (also referred to as ‘strata’).

The methods of the invention are necessarily computer-implemented methods. Accordingly, the methods of the invention may also comprise a step of receiving at a processor all available genotype and phenotype data for an individual or group to be classified. In addition, the step of receiving may itself, in certain embodiments, be performed by a computer system querying a database (for example, a database of genomic information, a database of electronic health records or similar clinical data, or any or all of these) or by the manual addition of known clinical or genomic data for the individual or group, or both.

In one embodiment, the ADME genes and gene variants are instantiated in the training set as a discrete set of ‘surrogate phenotypes’ obtained using methods of population structure and clustering comprising multivariate statistical analysis. In one embodiment, the multivariate statistical analysis comprises one or more of the following (1) allele-sharing distance (ASD) between populations and multi-dimensional scaling (MSD) or ASD and gap analysis; (2) principal components analysis (PCA) with eigenanalysis; and (3) automatic inference of number of clusters and population structure from admixed genotype data.

Certain pre-processing steps may optionally be included in the classification methods of the invention, for example to optimize the training set used to train a learning machine as the classifier. In one embodiment, the one or more pre-processing steps used to optimize the discrete set of surrogate phenotypes for classification is selected from the group consisting of (i) correction of any missing or erroneous ADME variation data; (ii) automated comparison to pharmacogenomic knowledge bases; (iii) manual validation through comparison to the known worldwide distribution of ADME variation in genes that encode phase I and phase II drug metabolizing enzymes (DMEs) and drug transporter proteins (DTPs); and (iv) examination of the training set to ensure appropriate dimensionality by transformation of coordinates as required. In one embodiment, each of these pre-processing steps is used in the methods of the invention. In another embodiment, the method further comprises a pre-processing step selected from one or more, or all, of the following steps: a step to equalize the data and ensure the correct dimensionality of the data; a step of reformatting or augmenting the data to provide missing data attributes necessary for accurate classification; and a pre-filtering step to prepare the data for classification by the learning machine.

In accordance with the methods of the invention, missing data attributes which have been determined according to the invention to be necessary for accurate classification are provided by the classification system. This includes any situation in which a set of features in the live phenotype or group of phenotypes is only partly available, in which case the pre-processed and optimized training set of surrogate phenotypes is replaced by an average value to the corresponding feature data in the training set library. Since each feature considered in the training set of surrogate phenotypes has different absolute values in different metrics, all of the feature values in the library are represented using a ‘zero mean, unit variance’ technique

$$Norm ( {feature}_{i} ) = \frac{{feature}_{i} - mean ( {feature}_{i} )}{standard ( {feature}_{i} )}$$

In this context, ‘the average of the mean’ of any such missing data refers to techniques for supplying missing data attributes as commonly used in machine learning. In one embodiment, the set of data attributes necessary for accurate classification comprises or consists of the ADME genes and gene variants shown in Table 1 or Table 2, or both Tables 1 and 2. In one embodiment, the set further comprises or consists of the following clinical data: self-reported ethnicity, self-reported sex, self-reported age, number of concomitant medications exceeding four, number of adverse events exceeding two, and number of medication refills showing a significant difference from a normative pharmacy profile. In one embodiment, the set further comprises ICD diagnoses selected from the group consisting of two or more, three or more, four or more, five or more, or all of the following: Esophageal reflux, Peptic ulcer, site unspecified, Ulcerative colitis, Diabetes mellitus, Acute pulmonary heart disease, Ischemic heart disease, Primary Hypertension, Cardiomyopathy, Cerebral thrombosis, Cardiovascular disease, unspecified, Major depressive disorder, Depression, bi-polar disorder, Depressive disorder, and Anxiety disorders. In one embodiment, the set of data attributes comprises or consists of the data attributes identified in Table 5.

In one embodiment, the learning machine is selected from the group consisting of a support vector machine, an extreme learning machine, and an interactive learning machine. In one embodiment, the learning machine is a support vector machine and the training dataset comprises the genes and gene variants set forth in Table 1. In one embodiment, the learning machine is an extreme learning machine and the training dataset comprises the genes and gene variants set forth in Table 1 or Table 2.

In one embodiment, the method comprises a second training dataset consisting of a set of clinical co-variables from a de-identified electronic health record (EHR) that are significantly associated with drug metabolizer phenotype. In one embodiment, the set of clinical co-variables comprises or consists of self-reported ethnicity, self-reported sex, self-reported age, number of concomitant medications exceeding four, number of adverse events exceeding two, number of medication refills showing a significant difference from a normative pharmacy profile, wherein the number of concomitant medications, adverse events, and medication refills are each determined on an individual basis where the method is directed to classifying a group of individuals. In one embodiment, the set of clinical co-variables further comprises or further consists of a set of ICD diagnoses selected from the group consisting of two or more, three or more, four or more, five or more, or all of the following: Esophageal reflux, Peptic ulcer, site unspecified, Ulcerative colitis, Diabetes mellitus, Acute pulmonary heart disease, Ischemic heart disease, Primary Hypertension, Cardiomyopathy, Cerebral thrombosis, Cardiovascular disease, unspecified, Major depressive disorder, Depression, bi-polar disorder, Depressive disorder, and Anxiety disorders. In one embodiment, the set of clinical co-variables comprises or consists of the data attributes identified in Table 5.

Certain optional post-processing steps are also included in the methods of the invention. In one embodiment, the method comprises a post-processing step performed on the learning machine output for comprehension by a human or computer. In one embodiment, the method comprises a post-processing step of altering the classification output of the learning machine using clinical and environment modifiers obtained for the individual or group, the modifiers being selected from one or more of the group consisting of incidence of childhood abuse, family history, positive lifestyle factors, negative lifestyle factors, polypharmacy, co-morbid disease, female sex, and age over 75 years. In one embodiment, the method comprises a post-processing step of annotating the data for use by a Clinical Data Management System.

The classification methods of the invention may further be applied, for example, to classify an individual or group as to pharmacokinetic risk of an adverse drug reaction. In accordance with this embodiment, a second training set is used in the method wherein the training set incorporates a set of clinical data values extracted from a large dataset of de-identified electronic health records, the set of clinical data attributes consisting of self-reported race or ethnicity, self-reported sex, self-reported age, ICD diagnoses, number of concomitant medications, number of adverse events reported, and frequency of pharmacy refills. The discrete set of pharmacogenomic phenotypes is identified by a method comprising the step of extracting each of the following data values from the large dataset of de-identified electronic health records: (a) requests for medication refills that differed significantly from the norm, which is utilized to determine whether an individual is a slow, intermediate, extensive or ultrarapid metabolizer, further refining classification into a discrete stratum; (b) number of Adverse Events Reported that exceeded 2, which is utilized to determine underlying medication problems associated with a given individual to bin into a stratum; (c) number of concomitant medications; and gender and ethnicity which are determinative and replicative, respectively; and (d) ICD-coded classification.

The invention also provides methods for identifying an individual or group of individuals at risk for having one or more of an adverse event, an adverse drug reaction, a sub-therapeutic effect, or a non-therapeutic effect compared to the general population. In one embodiment, the method comprises classifying the individual or group into one of a discrete set of pharmacogenomic phenotypes as described herein and further determining whether or not the individual or group falls outside the discrete set of pharmacogenomic phenotypes provided by the invention, wherein if the individual or group falls outside the discrete set of pharmacogenomic phenotypes the individual or group is a pharmacogenomic outlier and is at increased risk for having one or more of an adverse event, an adverse drug reaction, a sub-therapeutic effect, or a non-therapeutic effect, compared to the general population. In one embodiment, the method identifies a pharmacogenomic outlier for CYP2D6 and the training dataset consists of the following clinical data attributes: (1) age; (2) sex; (3) ethnicity; (4) patients on ±4 drugs, which have to be metabolized, in part, by CYP2D6; (5) number of adverse events >2; (6) requests for medication refills that differ significantly from the norm; (7) disease classification (ICD-9CM); and a set of genomic data attributes consisting of the set CYP2D6 mutations resulting in either a poor metabolizer phenotype or an ultrarapid metabolizer phenotype. In this context, the set of CYP2D6 mutations resulting in a poor metabolizer phenotype comprises or consists of the following star alleles: *3-*8, 11*-16*, 18*-21*, 31*, 36*, 38*, 40*, *42, *44, *47, *51, *56, *62 and wherein the set of CYP2D6 mutations resulting in an ultrarapid metabolizer phenotype comprises or consists of the following gene duplications: *1×N, *2×N, *33×N, *35×N, 13>N>2.

In one embodiment, the learning machine is a support vector machine, the training dataset consists of the following genes and their variants (a) CYP1A2; (b) CYP2C8; (c) CYP2C9; (d) CYP2C19; (e) CYP2D6; (f) CYP3A4; (g) NAT2; (h) TMPT; and (i) UGT1A1, and the method further comprises a second training dataset consisting of a set of clinical co-variables from a de-identified electronic health record (EHR), the set of clinical co-variables consisting of the following: age, race, gender, individuals taking medications metabolized by CYP2D6, a set of ICD-9 code diagnoses (cancer patients excluded), number of adverse events >2, frequency of medication refills that differed significantly from the norm, and CYP2D6 genotype data. In one embodiment, the set of ICD-9 code diagnoses used in the training dataset includes two or more of the following Esophageal reflux, Peptic ulcer, site unspecified, Ulcerative colitis, Diabetes mellitus, Acute pulmonary heart disease, Ischemic heart disease, Primary Hypertension, Cardiomyopathy, Cerebral thrombosis, Cardiovascular disease, unspecified, Major depressive disorder, Depression, bi-polar disorder, Depressive disorder, and Anxiety disorders.

The invention also provides methods for pharmacogenomic decision support in a hospital, clinic or other inpatient setting for the avoidance of pharmacological risk of an adverse event or adverse drug reaction. In one embodiment, the method comprises classifying an inpatient into a pharmacogenomic phenotype as described herein, wherein the classification is modified by one or more clinical and/or environment modifiers, receiving at a processor of a clinical decision system the modified pharmacogenomic phenotype for the inpatient, executing a set of instructions which cause the processor to query one or more drug databases for evidence of a potential adverse event based on hazardous drug-drug interactions, drug-gene interactions and producing an alert signal if an adverse event is detected. In one embodiment, the method further comprises a step of providing the physician with an alternative, optimal therapeutic regimen for the inpatient.

The invention also provides methods for drug development. In one embodiment, the method comprises identifying a drug that does not exhibit pharmacokinetic toxicity by pattern-matching of pharmacogenomic phenotype population clusters between 2 or more similar drugs, wherein the pattern-matching can be used to identify optimal as well as potentially hazardous pharmacogenomic phenotypes for the intended use of the drug, and wherein the pharmacogenomic phenotype population clusters are determined according to the method of claim 1.

The invention also provides methods for developing a pharmacogenomic knowledge database using as source data pharmacogenomic data contained in private databases of pharmaceutical companies, biotechnology companies and academic research centers. In one embodiment, the method comprises subjecting the source data to pharmacogenomic phenotype classification according to the methods described herein, and consolidating the resulting set of surrogate phenotypes into a single database.

### BRIEF DESCRIPTION OF FIGURES

FIG. 1 shows the system, the sub-systems, and the data inputs and outputs of the pharmacogenomic classification system 108. These include inputs 100, 101, 102, integration of known data from ‘live’ phenotype 103, federated databases 104 that are curated 105 for the knowledge update engine 106. Optional human health variome 109 contribution to the pharmacogenomic classification system 108, and the human genome sequence population variome 110 filtered by ADME significant co-variables 111, that provide the input to the training set of surrogate phenotypes in 108. The live phenotype inputs 100, 101 or 102 are pre-processed 107 before being classified by 108. As an option, outputs of the pharmacogenomic classification system 108 can be post-processed 112 for use in clinical trials 114, or to add clinical modifiers 113 for more accurate decision support 115.

FIG. 1A demonstrates the steps involved in the development and testing of the training set of surrogate phenotypes 203. A massive dataset of significant ADME variants extracted from 17,131 whole genome sequences 200 is processed into a discrete set of pharmacogenomic phenotypes using population structure 201 and clustering methods 202 for development of the ‘surrogate phenotypes’ 203 of the training set for the learning machine. The training set 203 is tested using other ADME variant data 204 to optimize the generalization of the pharmacogenomic classification system. The training set is validated is validated by independent pre-processing 205 by automated comparison to pharmacogenomic knowledge bases 206 and by manual checking of known ADME 207 variation. This process leads to an optimized training set of surrogate phenotypes as input to the learning machine 208.

FIG. 1B shows the results of a clinical trial using the CYP2D6 probe drug dextromethorphan (DMP) (FIG. 1B-A), and how these data can be binned using first two eigenvectors for the results of sub-populations in terms of response to the drug dextromethorphan (DMP), which correspond to different metabolizer subtypes based on CYP2D6 genotype (FIG. 1B-B). Populations B (popB) and C (popC) correspond to intermediate and extensive metabolizers, and show significant evidence for admixture based on a dine using PCA and cluster analysis. Populations A (popA) and D (popD) correspond to ultra-rapid and poor metabolizers.

FIG. 1C shows example of inter-ethnic minor allele frequencies for the cytochrome P450 gene CYP2D6 (FIG. 1C-A) and the phase II drug metabolizing gene NAT2 (FIG. 1C-B) that encodes N-acetyl-transferase 2.

FIG. 1D demonstrates a compelling example of ethnic-specific heterogeneity in the 5′ promoter of the SLC6A4 gene that encodes the serotonin transporter protein, a primary target of antidepressant drugs. The asterix identifies a variant that was only found in African-American and Caucasian (Hispanic) population of whole genome sequences.

FIG. 1E shows example of a portion of the ADME population clusters identified in the database of 17,131 whole genome sequences, with partial examples of subsets of specific cytochrome P450 gene variants, phase II metabolizer gene variants and drug transporters that comprise discrete ADME population clusters and be used to develop surrogate phenotypes that can be used as the training for a learning machine. Their composition as to instance and attribution is indicated.

FIG. 1F shows the results of our experiments in which it was possible to classify over 99% of individual whole genome sequences into 54 discrete pharmacogenomic populations based on highly significant differences in hundreds of ADME genes, and includes an overview of the various populations as discretized by statistical analysis, as well as visualization of the different population clusters using allele-sharing distance (ASD) and multi-dimensional scaling (MSD). The results are consistent with a model that preserves many ancestral ADME variants 300, which can be classified to 54 discrete pharmacogenomic populations with a small percentage of outliers 301 to form highly circumscribed clusters 302.

FIG. 1G provides a table summarizing significant human genome and clinical co-variables as extracted from de-identified electronic health records (EHRs) that are used for pharmacogenomic classification and to predict the risk of adverse drug reaction (ADRs).

FIG. 1H shows the pre-processing of ‘live’ patient, participant or phenotype group data for stratification by the learning machine used for pharmacogenomic classification. It also shows interactive components of the learning machine. The ‘live’ phenotype input 400 is strengthened by the addition of any known clinical or genotype data from the input 401 then is pre-processed in the same manner as the training set of surrogate phenotypes 402. Whole genome analysis (WGA) comprising the significant ADME variant co-variables 404 that can be adjusted in an interactive learning machine or pre-programmed 403 along with de-identified electronic health record data (EHR) 405 to power the learning machine-based pharmacogenomic classifier 406. Pharmacogenomic classification in the learning machine involves pre-filtering of pre-processed input data and classification by the training set 406 as to comprehensive pharmacogenomic stratum 407. Post-processing 408 can include optional interactive or preprogrammed steps to check that the classification profile fits an assigned cluster 409, to change the decision support as modified using clinical and/or environmental variables 410, or prepare the decision for clinical trial management 411 to arrive as the final pharmacogenomic classification available for use 412.

FIG. 1I shows how clinical and environmental modifiers can be used to adjust or change the pharmacogenomic decision as originally derived from the foundational population clusters. This embodiment is especially useful for predictions of adverse drug reactions (ADRs). The fundamental pharmacogenomic phenotype stratum for a given ‘live’ phenotype input to the learning-machine-based classifier 500 can be modified by clinical and/or environmental factors for an individual or group of individuals 501, such factors may include epigenomic changes produced by childhood abuse, inherited traits through family history, co-morbid disease state, sex, age, lifestyle and the degree of poly-pharmacy. These modifiers can shift a phenotype or group to a different pharmacogenomic population cluster, changing the pharmacogenomic decision 502.

FIG. 2 shows a prophetic extrapolation of the results from the pharmacogenomic classification to ancestral alleles worldwide to define 212 discrete populations of metabolizer phenotypes and their implementation in an interactive, reference-based mapping system. Extrapolation of pharmacogenomic population clusters 600 from the pharmacogenomic classification system 108 can be made to worldwide pharmacogenomic phenotype populations 601 as described in the invention.

FIG. 3 shows comprehensive pharmacogenomic classification of an individual from the 17,131 whole genome sequences who was an ‘outlier’ separate from any of the population clusters and contained many potentially deleterious ADME mutations.

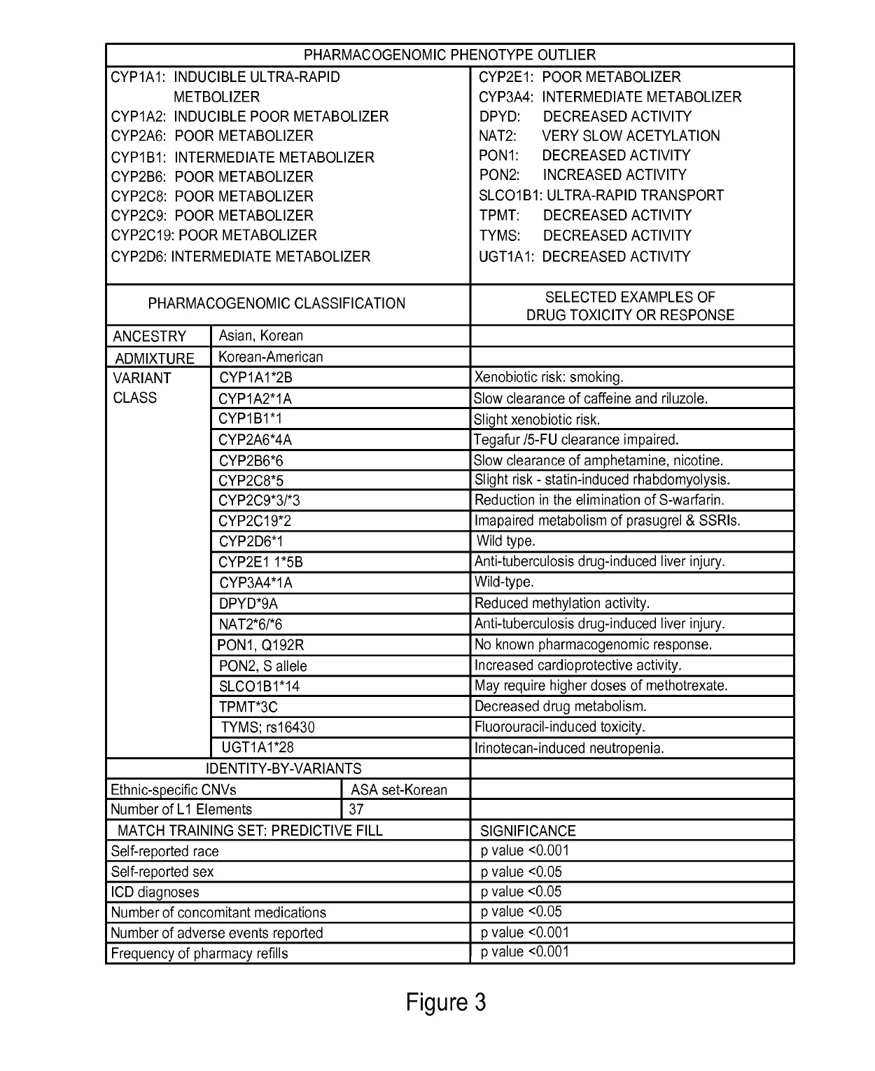

FIG. 4 shows how a learning machine 701 trained on a de-identified EHR dataset containing corresponding pharmacogenomic genotype data 700 corresponding to each patient record that has been tested as to its ability to perform accurate classification 702 can accurately classify a de-identified EHR dataset that does not contain genotype data 703 into accurate drug metabolism phenotypes 704.

FIG. 4A shows the results from an experiment using 2 de-identified EHR datasets 800 and 804, a learning machine 802 trained on EHR dataset ‘#1’ containing both phenotype and genotype data 801 that was tested for accurate classification of CYP2D6 metabolizer phenotype 803 was able to accurately classify both CYP2D6 poor metabolizers (PM) and ultra-rapid metabolizers (UM) using only phenotype data from EHR dataset ‘#2’ 804. After adding back genotype data to each patient record in EHR dataset #2 805, tests of statistical significance using ANOVA in R:**p<0.00001, *p<0.0005 showed high concordance with known phenotype 806.

FIG. 4B shows the results from an experiment where the learning machine 807 trained using the optimized training set of surrogate phenotypes 208 was used to classify 808 an EHR dataset containing a large number of phase I and phase II metabolic genotypes 809. After classification 810, when the all of the pharmacogenomic genotypes were added back to each of the patient records 811, all of the available genotype data from each patient record was stratified by the learning machine 807 with a high degree of accuracy 812.

FIG. 5 shows the demographic profile of 17,131 whole genome sequences identified as to age, race and gender.

FIG. 6 shows an exemplary embodiment of the invention would be its application to proactive detection of a potential ADR risk for an inpatient in a hospital, clinical or other setting where a EHR is used that contains a clinical decision support (CDS) system. The newly admitted inpatient 900 is classified by the learning machine-based system 901 as to pharmacogenomic population 902 and the data is stored in the EHR 904. In an interactive or preprogrammed manner, the admitting clinician can alter the decision based on clinical and/or environmental modifiers 903. Whenever the inpatient is prescribed a new drug 905, the pharmacy information system alerts the EHR 904 to undertake checking of drug databases for adverse drug-drug or drug-gene interactions 906, which prompts 907 the clinical decision support system 908 to update a recommended therapeutic regimen for optimal treatment of the patient by the physician 909.

FIG. 7 shows the use of the pharmacogenomic classification system in an exemplary embodiment for use in drug development. Pattern analysis using population clusters can be used to guide the development of a new drug 1013 called (‘Drug C’) 1012 to be developed by pharmaceutical company 3 1011 based on the pattern if population clusters for a similar drug (‘Drug B’) 1010 developed by pharmaceutical company 2 1008 that was effective with a good side effect profile 1010 compared to the pattern observed with a drug (‘Drug A’) 1001 developed by pharmaceutical company 1 1000 that was removed from the market due to a high incidence of adverse drug reactions (ADRs) 1002. Using the learning machine-based classification system 1004, ‘Drug A’ 1001 and ‘Drug B’ 1009 showed different but overlapping pharmacogenomic population cluster outputs 1005. From pattern matching, it can be seen in this exemplary embodiment that certain populations visualized using cluster analysis should be avoided because of potential pharmacokinetic toxicity 1006 from ‘Drug A’ 1001, but those that are shared between ‘Drug A’ 1001 and ‘Drug B’ 1009 can be used 1014 for the development of ‘Drug C’ 1012.

FIG. 8 shows the use of the invention in an exemplary embodiment as a solution to organize a comprehensive pharmacogenomics knowledge base through secure sequestration of diverse and ‘cloistered’ pharmacology, pharmacogenomic, genomic, biomedical informatics, and regulatory databases in the context of a collaborative, pre-competitive informatics sharing system. Pharmaceutical companies, academic research centers and biotechnology companies 2000 have a wealth of ‘private’ pharmacogenomic data 2001 that can be classified using this invention 2002 so that only the derivative pharmacogenomic populations are used as primary data after learning machine-based classification which cannot be reverse engineered 2003. The different pharmacogenomic data 2004 can be manipulated using a variety of tools and applications 2006 in the pharmacogenomic knowledge base 2007 in a secure but open pre-competitive data-sharing platform 2005.

### DETAILED DESCRIPTION OF THE INVENTION

The methods of the invention utilize the embedded stratification of human populations, as discussed infra, as a means to classify any given individual or group into one member of a discrete set of pharmacogenomic phenotypes identified in the human population according to the invention. The invention provides methods and systems to incorporate ADME population structural variation as the major determinant into the classification analysis to provide an accurate determination of pharmacogenomically discrete metabolizer-based subpopulations of individuals. A discrete ADME-based subpopulation identified according to the methods of the invention is referred to herein as a “pharmacogenomic phenotype”. The systems and methods of the invention are able to predict with accuracy not only the drug metabolism phenotype of any individual, or group of individuals, by incorporating the ADME population structure into the analysis, but are also able to incorporate additional genomic data, including data from drug transporter proteins (DTPs), as well as clinical data determined by the methods of the invention to be significant for the classification. The combination of specific genomic and clinical data co-variables according to the methods of the invention provides an accurate pharmacogenomic classification system.

The methods and systems of the present invention offer a significant advancement over prior art techniques, particularly those which incorporate genotyping of patients or potential trial participants based solely on SNPs, or based on SNPs and limited clinical factors. These prior art techniques ignore the known panoply of human genome variants and often fail to access important clinical data beyond a few variables. The present invention also overcomes prior art problems associated with the use of both personal genomic sequence data and the often variable quality of the clinical data maintained both in EHRs and other data repositories. This is accomplished by using de-identified data large enough in size to accurately model both the human genome variome and the human health variome.

According to invention, the de-identified datasets used as source data for the systems and methods described herein are large enough to provide an accurate statistical representation of the genomic and health variation found in the human population. This data is then used to produce a training set consisting of a population of surrogate phenotypes representing all known pharmacogenomic phenotypes in the human population at a given time. This set of surrogate phenotypes is used to train the classifier. Preferably, the training set is subjected to one or more pre-processing steps and tests both to optimize the data for accuracy and to prepare the data for classification by the classifier, which is preferably a learning machine. In one embodiment, the training set is embedded into a predictive pharmacogenomic classifier, preferably a learning machine, most preferably a support vector machine, an extreme learning machine, or an interactive learning machine. As demonstrated herein, a classifier trained in accordance with the methods of the invention is able to accurately classify individuals (or groups of individuals) into a pharmacogenomic phenotype that can be used, for example, to provide an accurate determination of the individual's actual risk of toxicity for a given therapy or response efficacy.

The present invention provides methods and systems, including sub-systems, for accurately predicting the pharmacogenomic metabolizer phenotype (also referred to herein as “metabolizer phenotype”, “strata”, “metabolizer status” or “pharmacogenomic phenotype”, which terms are used interchangeably herein) of an individual, or population of individuals. The term “metabolizer phenotype” refers to the defined ability of an individual (or population) to metabolize particular drugs or classes of drugs. For example, a metabolizer phenotype may be defined as poor, intermediate, extensive, rapid, or ultra-rapid, based upon the metabolism of a particular drug or class of drugs.

The present invention also provides a discrete set of pharmacogenomically discrete metabolizer-based subpopulations (also referred to interchangeably herein as “strata”, or “pharmacogenomic phenotypes”). The discrete set of pharmacogenomic phenotypes represents all known clusters of pharmacogenomic metabolizer subpopulations in the human population at a given point in time, determined according to the methods of the invention. The set of pharmacogenomic phenotypes is defined by the present invention using criteria based on a set of co-variable data values (also referred to herein as “data attributes” or “data values”). The data attributes comprising the set are identified by the present invention as having a significant association with drug metabolism phenotype. The data attributes of the invention include genotype information as well as clinical data which can be used separately or in combination with additional input phenotype data. The terms “data” and “information” are used interchangeably herein. Additional data attributes can be identified according to the methods described herein.

The present invention also provides for the updating of the information underlying the data attributes using a knowledge update engine, as described infra. Accordingly, the actual number of metabolizer strata comprising the discrete set may vary according to changes in the available information. In one embodiment, the discrete set of strata consists of from 10-100 strata, from 100 to 150 strata, from 150 to 200 strata, from 200 to 250 strata, from 250 to 300 strata, or from 300 to 500 strata. In one embodiment, the discrete set of metabolizer strata consists of from 175 to 225 strata or from 200 to 225 strata, from 200 to 250 strata from 250 to 300 strata, or from 300 to 400 strata. In one embodiment, the invention provides a discrete set of fifty-four (54) pharmacogenomic population clusters derived from ADME variation from a large dataset of 17,131 whole genome sequences of U.S. residents.

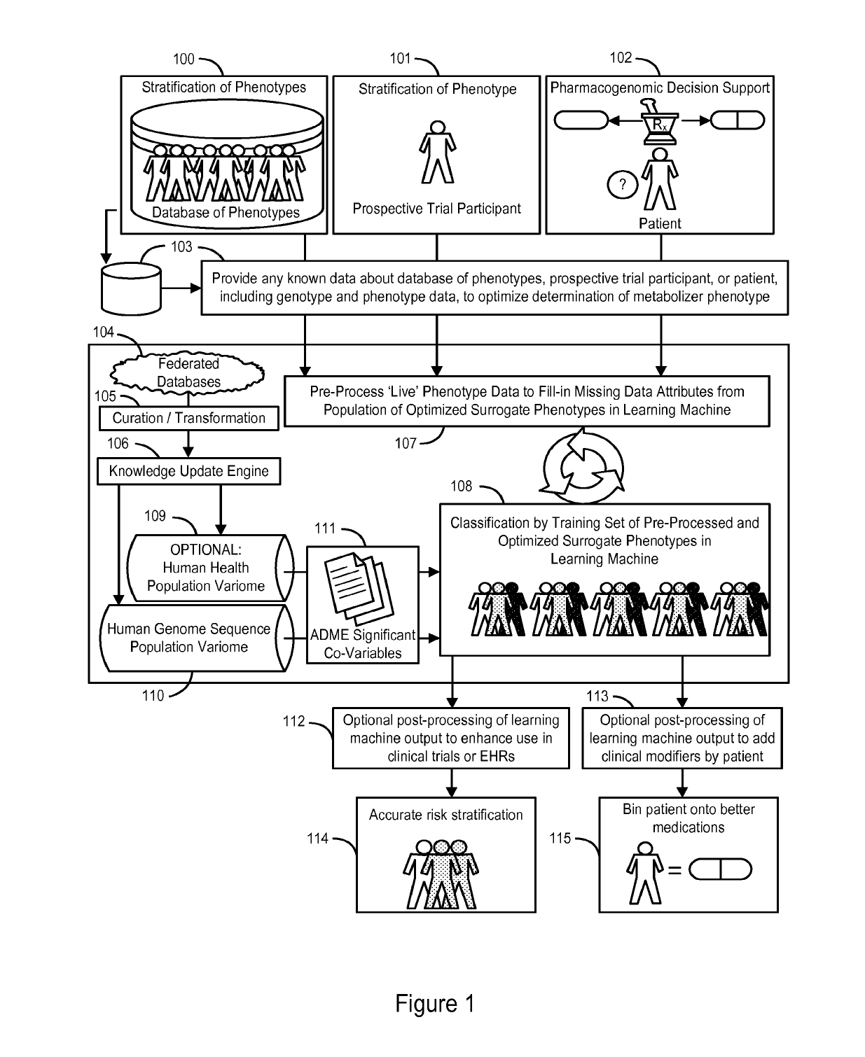

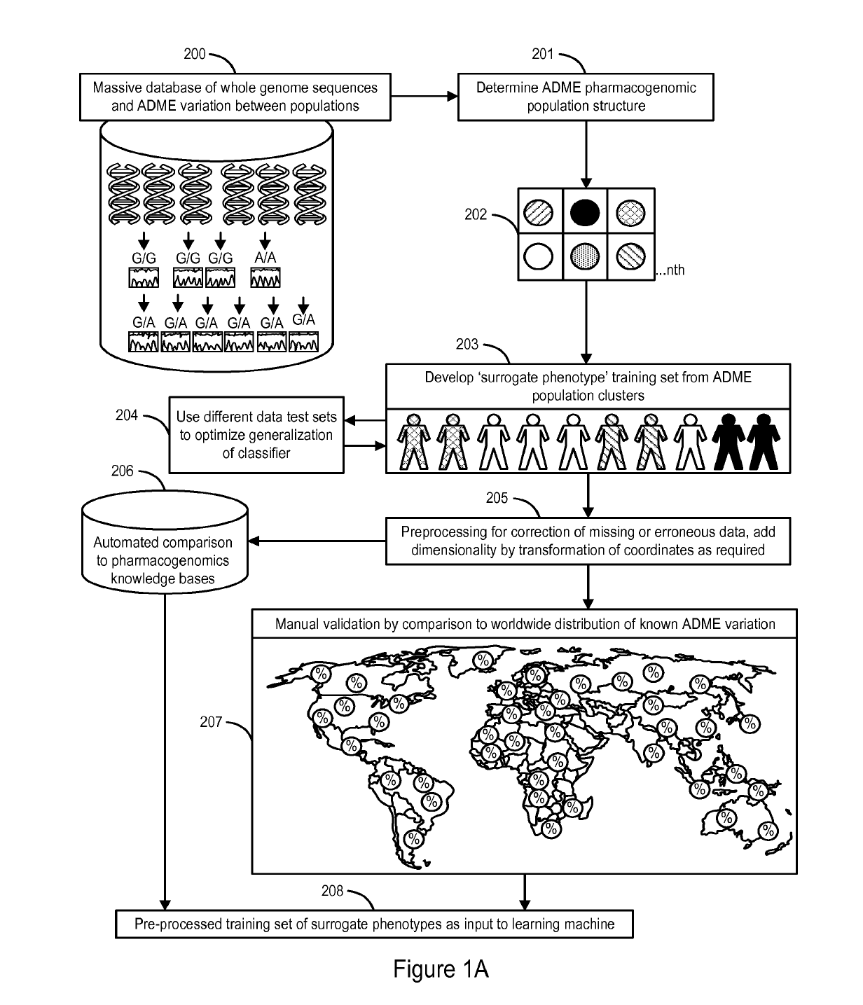

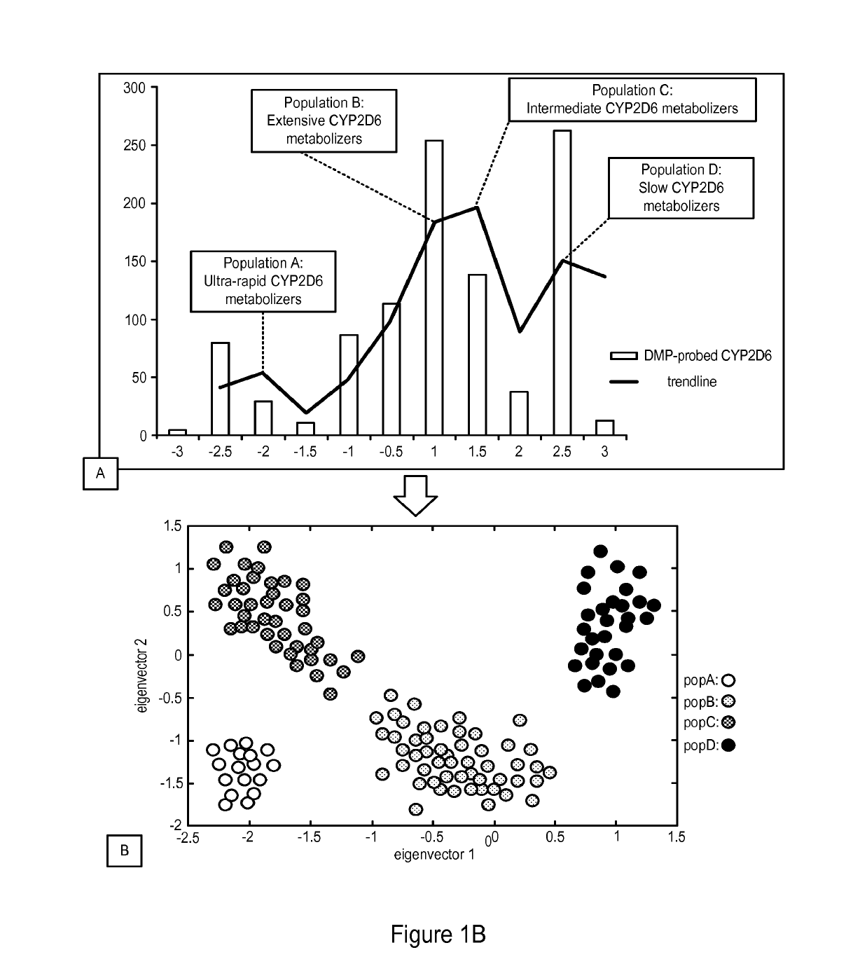

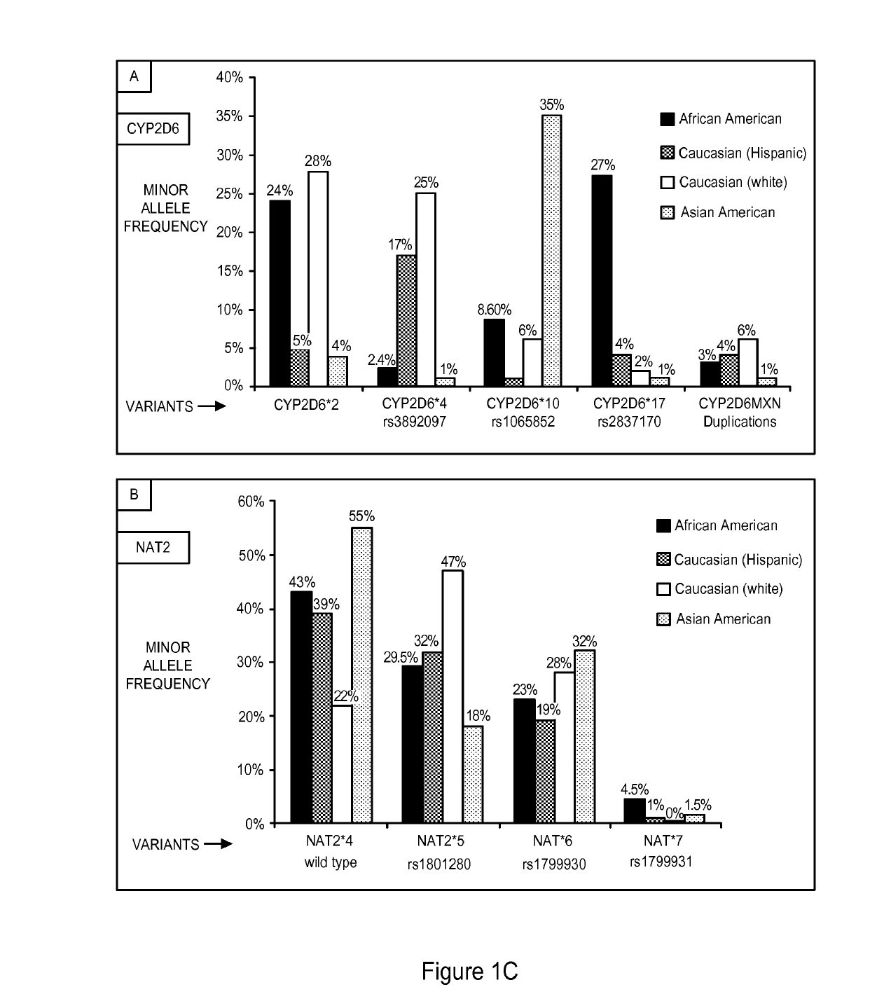

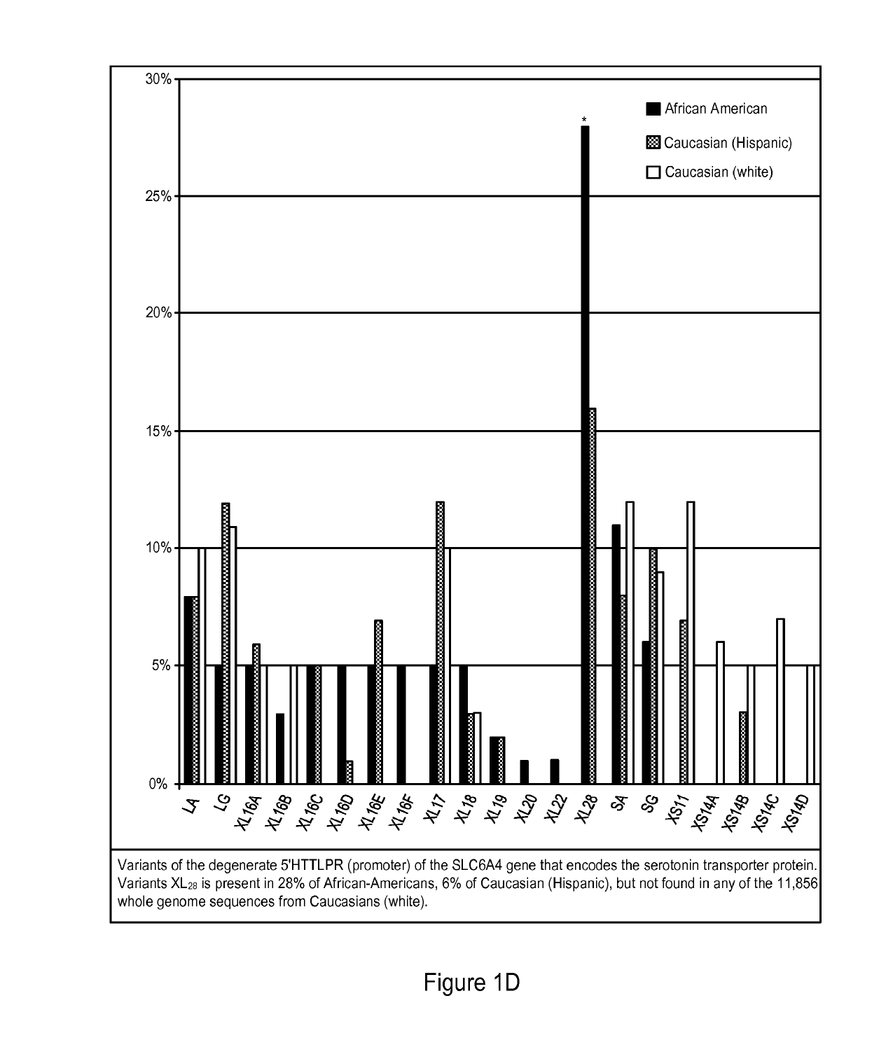

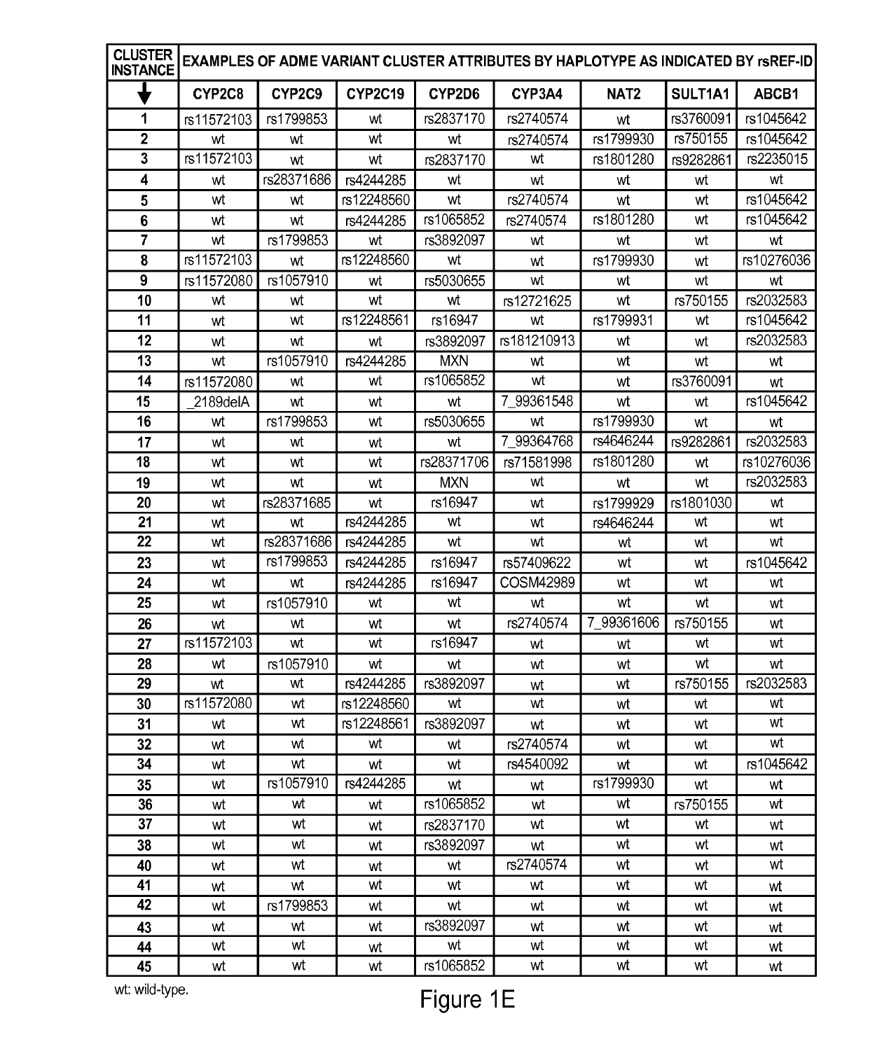

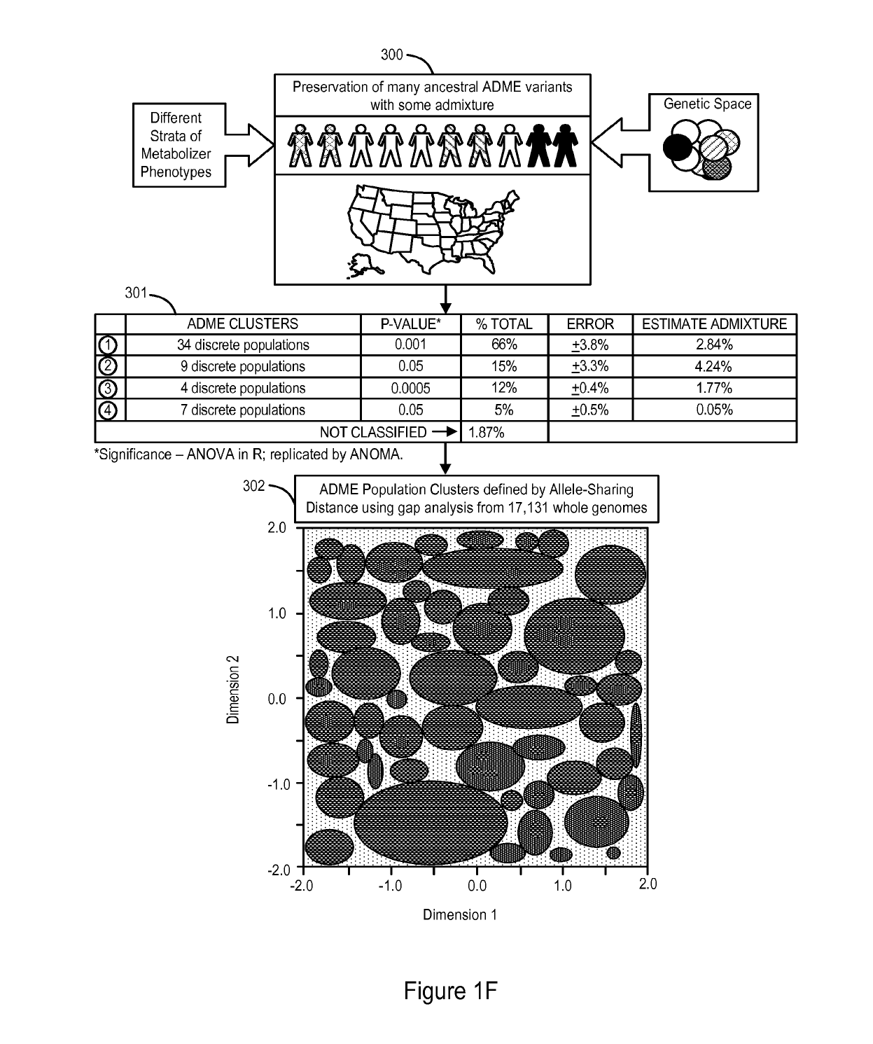

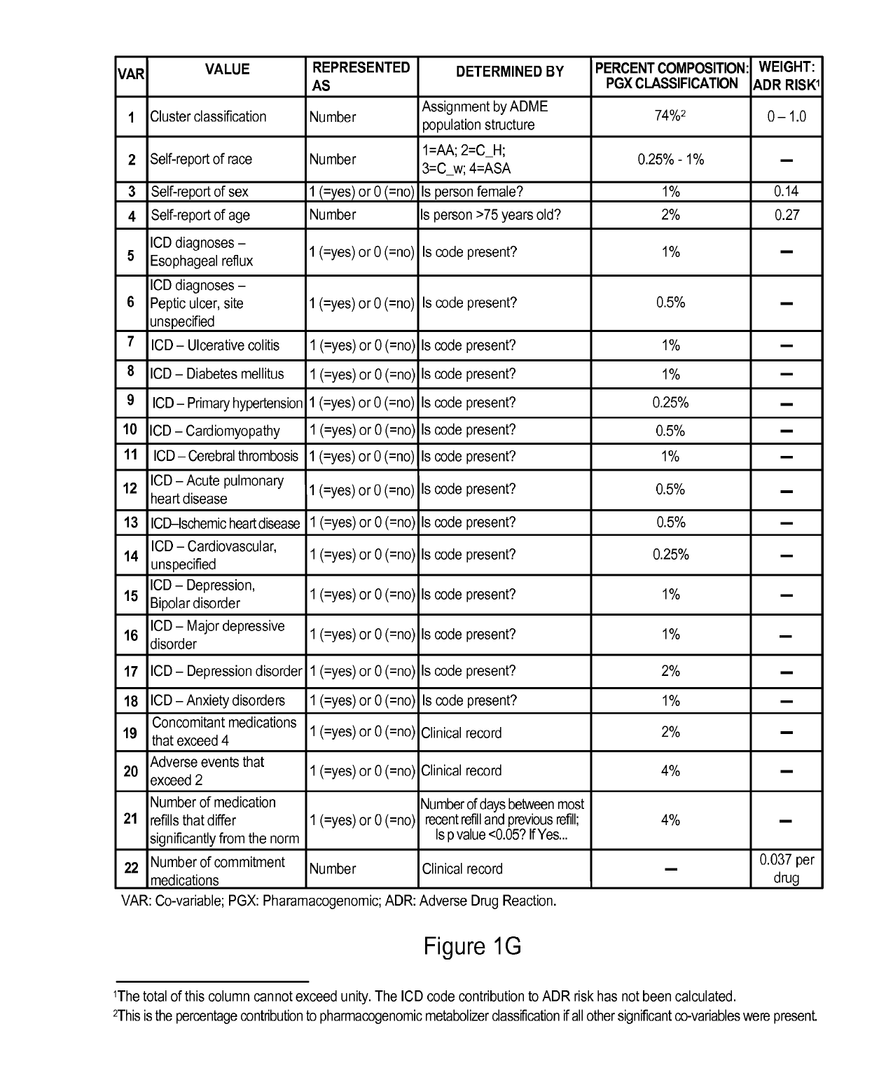

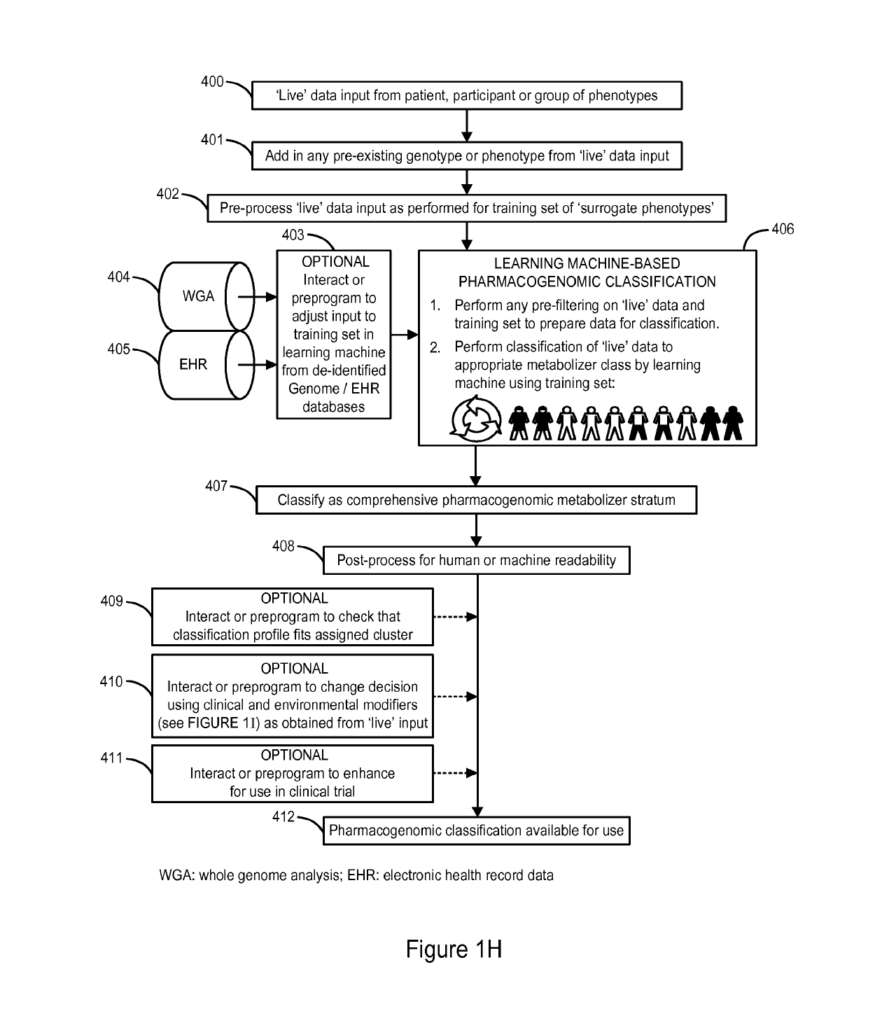

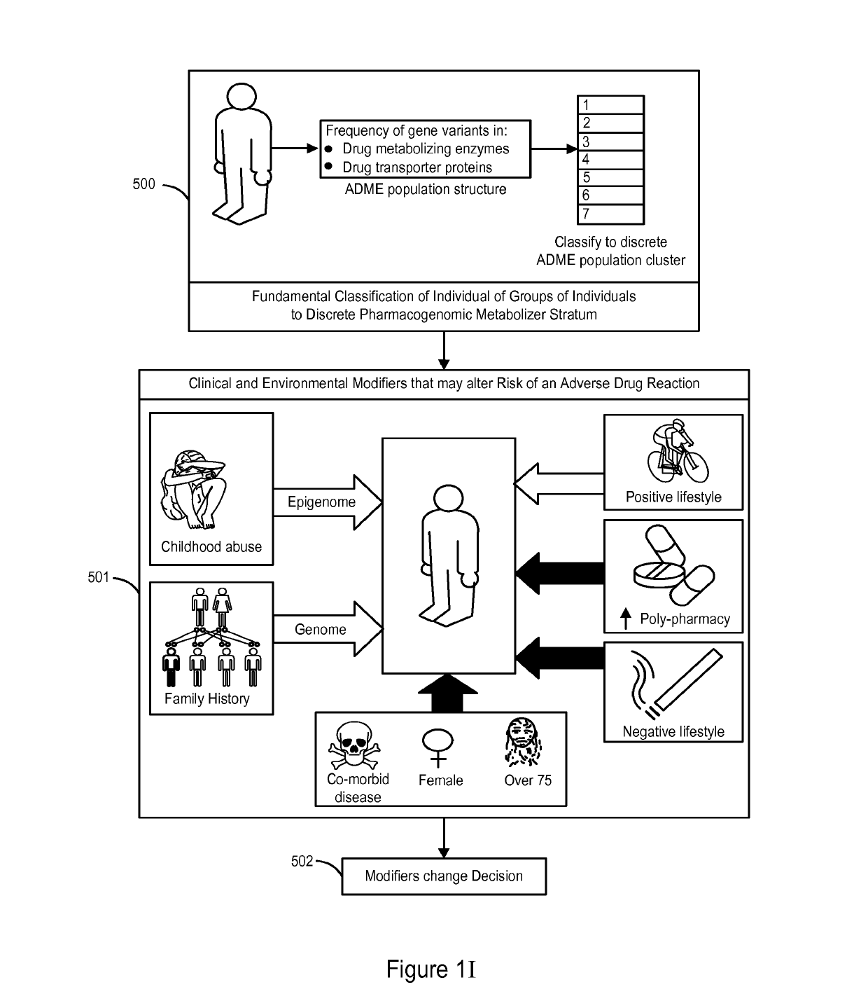

The methods of the invention can be used to identify an ‘outlier’ from any of the pharmacogenomic phenotype population clusters. The identification of such outliers identifies an individual or group of individuals at increased risk (compared to the general population) for any one (or more) of the following: an adverse event, an adverse drug reaction, a sub-therapeutic effect, or a non-therapeutic effect. In this context, a ‘sub-therapeutic effect’ refers to a therapeutic effect that is less than the intended therapeutic effect, or less than the optimal therapeutic effect for an individual receiving a particular therapy. The term ‘non-therapeutic effect’ refers to the absence of the intended therapeutic effect for an individual receiving a particular therapy. FIG. 1E shows an outlier from any of the 54 pharmacogenomic population clusters derived from the 17,131 whole genomes. This outlier contains an unusual number of deleterious metabolizer mutations.

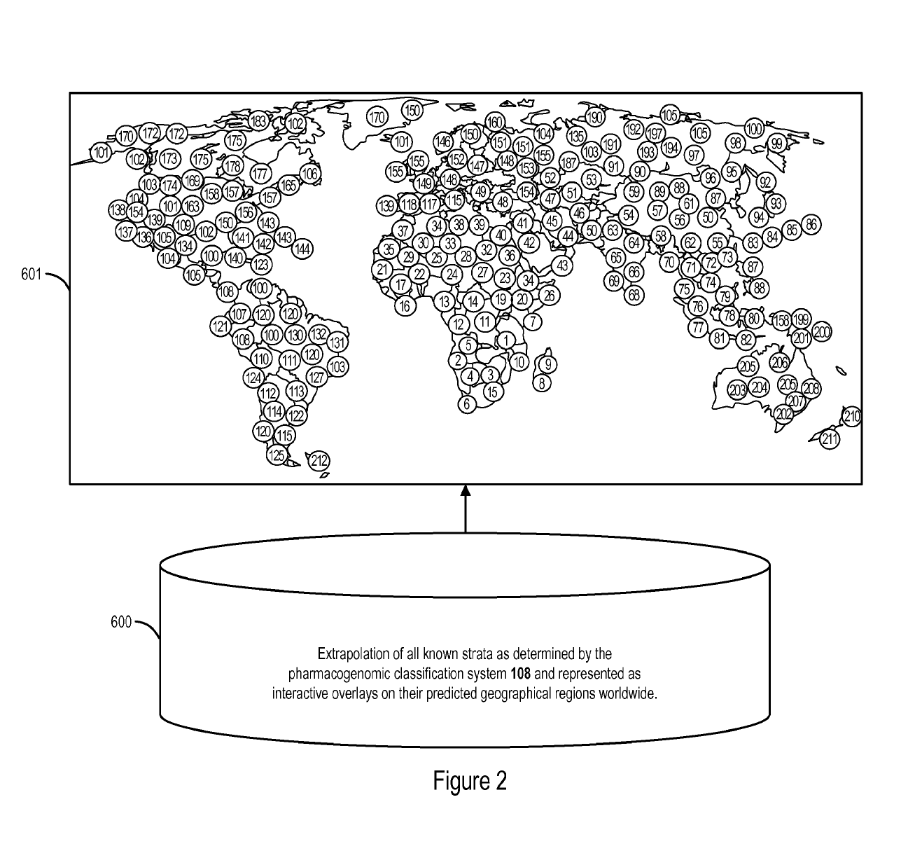

The invention also provides a subsystem and methods that consist of an interactive reference map (FIG. 2) that displays a map of the world in which a prophetic instantiation from ADME variation in U.S. residents is extrapolated to ancestral populations worldwide, with all of the known pharmacogenomic strata overlaid on their respective geographical regions. The interactive reference map is linked to a database containing all known discretized strata at a given time point as determined by the pharmacogenomic classification system 108. This extrapolation is accomplished by methods known to those skilled in the art, including diffusion approximation, likelihood-based inference, assumptions about the evolution of single nucleotide variants (see e.g., Gutenkunst RN et al., Inferring the joint demographic history of multiple populations from multidimensional SNP frequency data. PLoS Genetics. 2009; 5 (10): e1000695) and the use of software programs such as ADMIXTURE (see e.g., Alexander DH and Lange K., Enhancements to the ADMIXTURE algorithm for individual ancestry estimation. BMC Bioinformatics. 2011; 12: 246-252).

According to the methods of the invention, an individual's pharmacogenomic phenotype can be more accurately compiled based upon ‘live’ input from the individual of all available data about that individual, including genotype data and the clinical record of the individual 103 (FIG. 1). Based on this input, which may include incomplete or missing data, an automated classifier, preferably a pre-trained learning machine trained according to the methods described herein, is used to assign the individual into one of a discrete set of pharmacogenomic strata as defined herein 108. Missing data attributes about a new phenotype or group of phenotypes are resolved during a pre-processing step 107, in which a set of features in the live phenotype or group of phenotypes is only partly available, in which case the pre-processed and optimized training set of surrogate phenotypes is replaced by an average value to the corresponding feature data in the training set library. Since each feature considered in the training set of surrogate phenotypes has different absolute values in different metrics, all of the feature values in the library are represented using a ‘zero mean, unit variance’ technique as:

$$Norm ( {feature}_{i} ) = \frac{{feature}_{i} - mean ( {feature}_{i} )}{standard ( {feature}_{i} )}$$

corresponding to the feature data provided by the pharmacogenomic classification system. Thus, according to the methods of the invention, the available information from the individual or group of individuals to be classified is augmented, if needed, by the classification system which provides missing or incomplete data attributes based on an average value of those data attributes in the training set (library of surrogate phenotypes) which represents all known clusters of pharmacogenomic metabolizer subpopulations in the human population at a given point in time, as determined by the methods of the invention.

In one embodiment, the training set further comprises a set of clinical co-variables determined according to the methods described herein to be significantly associated with, for example ADR risk. In one embodiment, the data are obtained from large clinical and/or health datasets, such as might be contained in a large electronic health record (EHR) dataset. In one embodiment, the data comprise or consist of the following variables per individual participant or patient: (a) age as reported; (b) gender as reported; (b) ethnicity as reported; (c) number of concomitant medications per individual that exceeds 4; (d) number of Adverse Events Reported that exceeds 2; (e) requests for medication refills that differed significantly from the norm; and (f) ICD-9 codes selected from the group consisting of ICD—Ulcerative colitis, ICD—Diabetes mellitus, ICD—Primary hypertension, ICD—Cardiomyopathy, ICD—Cerebral thrombosis, ICD—Acute pulmonary heart disease, ICD—Ischemic heart disease, ICD—Cardiovascular, unspecified, ICD—Depression, bipolar disorder, ICD—Major depressive disorder, ICD—Depression disorder, and ICD—Anxiety disorders.

### The Pharmacogenomic Classifier

The classifier of the invention is a predictive pharmacogenomic classifier, preferably a learning machine, trained on all known significant human genomic variants. In one embodiment, the training set includes the set of genes and variants shown in Table 1 or Table 2. In one embodiment, the training set includes, in addition to the genomic variants, a set of significant clinical co-variables as provided by the invention.

The invention provides learning machine-based methods that can be used for pharmacogenomic decision support. Learning machines utilize nonlinear mapping to transform the original training data into a higher dimensional space, within which they search for the linear optimal separating hyperplane, or ‘decision boundary’, to separate the classes. Compared with other methods such as Neural Networks, Decision Trees, or Adaptive Boosting, the advantages of using a learning machine include:
More accurate results due to the learning machine's ability to model complex nonlinear decision boundaries;
Less possible to run into over-fitting problems than other methods; and
Wide application areas including prediction, classification and regression.

The machine learning algorithms used in the methods and systems of the invention provide inductive, data-driven approaches including prediction and classification. Classification tasks group individual data entries into a known set of categories, as exemplified by the stratification classifier of the invention. A broad range of statistical techniques can be used, including one or more of correlation analysis, measurement of allele-sharing distance (ASD) with determination of statistical and multi-dimensional scaling (MDS) and gap analysis with significance determined by ANOVA or ANOMA, principal component analysis (PCA) and eigenanalysis. These statistical techniques are used for attribute selection, ADME population cluster classification, and pharmacogenomic outlier investigation, and are further used to correct models so that they do not “over fit” the data. In addition, these techniques are used to evaluate data mining models and to express their significance.

Learning machines comprise algorithms that may be trained to generalize using data with known outcomes. According to the invention, the learning machine is trained on a dataset consisting of a library of ‘surrogate phenotypes’. The surrogate phenotypes are derived from a large dataset of, for example, whole human genomes, alone or in combination with a large dataset of clinical co-variables as provided by the invention. The set of clinical co-variables can be obtained, for example, from databases of electronic health records. The learning machine may be, for example, a support vector machine (SVM), an extreme learning machine (ELM) (e.g., as described by Huang G-B. Extreme learning machine for regression and multiclass classification. IEEE Transactions on Systems, Man, and Cybernetics, Part B: Cybernetics. 2012; 42 (2): 513-529.), an interactive learning machine (ILM) (e.g., as described by Kapoor A et al. Performance and preferences: Interactive refinement of machine learning procedures. Association for the Advancement of Artificial Intelligence. 2012.), or other learning machine.

The underlying basis of a learning machine is the process of finding a decision function that creates a hyperplane separating the data. Additionally, the selected hyperplane should not only correctly separate the classes but should also maximize the margin between the hyperplane and the nearest training data. In a multidimensional classification task such as described in this invention, a line separates the classes and the margins maximize the space between the line and the nearest sample data. Those margins are referred to as the “support vectors.” In the learning machine algorithm, an optimization is used to find the support vectors. Several approaches exist for cases where the data are not linearly separable. In one approach, the constraints can be “softened,” thus allowing for some errors. This is carried out by adding an error term to the original objective function of the optimization, and minimizing the error term as well as the margin. Another approach is to find a mapping of the data that transforms the data to a new, higher-dimensional space (the “feature space”) in which the data are linearly separable, and then proceeds with regular learning machine-based classification. Within a learning machine, the dimensionally of the feature space may be huge. The kernel trick and the Vapnik-Chervonenkis dimension allow the learning machine to thwart the “curse of dimensionality” limiting other methods and effectively derive generalizable answers from this very high dimensional feature space. If the training vectors are separated by the optimal hyperplane (or generalized optimal hyperplane), then the expectation value of the probability of committing an error on a test example is bounded by the examples in the training set. This bound depends neither on the dimensionality of the feature space, or on the norm of the vector of coefficients, or on the bound of the number of the input vectors. Therefore, if the optimal hyperplane can be constructed from a small number of support vectors relative to the training set size, the generalization ability will be high, even in infinite dimensional space. Thus, learning machines provide a desirable solution for the problem of discovering knowledge from vast amounts of input data.

In one embodiment of the present invention, the learning machine is a support vector machine (SVM). Since the ability of a learning machine such as an SVM to discover knowledge from a dataset may be limited in proportion to the information included within the training data set, in certain embodiments the training set is minimized to include only the most significant ADME genes and gene variants identified in the dataset. In one embodiment, the ADME genes and gene variants used to train the SVM comprise or consist of those shown in Table 1. In one embodiment, the training set includes only the ADME variants having a P-value of at least 0.0001.

TABLE 1
Variants in Genes that Encode ADME Proteins for Use in the Development of
a Training Set for SVM-based Pharmacogenomic Classification

| Gene | | | |
|---|---|---|---|
| Symbol | Variant Star Alleles | Haplotype by rsREF-ID | Structural Variants |
| ABCB1 | | rs1045642; rs2235015; | |
| | | rs10276036; rs2032583 | |
| CYP1A2 | | rs206951485; rs762551 | |
| CYP2C8 | | rs11572103; rs11572080; | _2189delA |
| CYP2C9 | | rs1799853; rs28371686; | |
| | | rs1057910; | |
| CYP2C19 | | rs4244285; rs12248560; | |
| CYP2D6 | | rs2837170; rs1065852; | MXN2; MXN3; MXN4; |
| | | rs3892097; rs5030655; rs16947; | MXN5; MXN10; MxN13 |
| CYP3A4 | *1B; *3; *20; | rs776746; rs2740574; rs4540092 | 7_99381694; COSM42988; |
| | | | COSM35658; COSM42989; |
| | | | 7_99364768; 7_99361606; |
| GTM1 | | | *1AX2 |
| NAT2 | NAT2*4 | rs1801280; rs1799930 | |
| SLCO1B1 | *1; *5; *9 | | |
| SLC6A2 | | rs5564; rs168924 | NT_010498.15_9300464 |
| SLC6A4 | | rs25531 | 5-HTTPLR - XL₂₈ |
| SULT1A1 | | rs3760091; rs750155; | SULT1A1_CNV_1_5 |
| | | rs9282861; rs1801030 | |
| TMPT | *2; *3C | | |

In another embodiment, the learning machine is an extreme learning machine (ELMs). ELMs offer several enhancements over SVMs, including allowing more simple human intervention in parameter tuning and time-consuming iteration in the training phase, a straightforward extension into multiple classification and regression cases, and overcoming potentially suboptimal results of support vector nodes due to gradient descent algorithms being trapped at local minima during iteration. In one embodiment, the ADME genes and gene variants used to train the ELM comprise or consist of those shown in either Table 1 or Table 2.

TABLE 2
Variants in Genes that Encode ADME Proteins for Use in the Development of a
Training Set for ELM-based Pharmacogenomic Classification

| Gene | | | |
|---|---|---|---|
| Symbol | Variant Star Alleles | SNPs | Structural Variants |
| ABCB1 | | rs1045642; rs2235015; | |
| | | rs10276036; rs2032583 | |
| ABCA1 | | rs207470459; rs202195655; | |
| | | rs201905765; rs201893501; | |
| | | rs20189265; rs202180259; | |
| | | rs202161597; rs202141617; | |
| | | rs202138068; rs202097159; | |
| | | rs202087810; rs202067417; | |
| | | rs202059465; rs202051679; | |
| | | rs201992557; rs201989320; | |
| | | rs201983749; rs201966762; | |
| | | rs201665886; rs201642049; | |
| | | rs201599169; rs20; 1586430; | |
| | | rs201577783; rs201555773; | |
| | | rs201483791; rs201469136; | |
| | | rs201464281; | |
| ABCC1 | | rs8058696 | HCV34257260) in-del |
| ABCC3 | | rs146920162; rs143491192; | |
| | | rs137911252; rs4793665; | |
| | | rs4148416; | |
| ABCC5 | | rs7636910; rs1053386; | (HCV32501489) in-del |
| | | rs939336; rs1053351; | |
| | | rs3749442; rs1053387; rs562; | |
| | | rs3805114; | |
| ABCC8 | | rs193929369; rs80356642; | |
| | | rs1800853; | |
| ABCC10 | | rs9349256; rs2125739; | |
| ABCC11 | | rs149334541; rs144420816; | |
| | | rs17822931; rs8047091; | |
| | | rs7203695; | |
| ABCC12 | | rs144810262; rs16945874; | |
| | | rs16945869; | |
| ALDH2 | | rs440; | |
| CYP1A1 | *2A; *2B; *2C; *3; *4; | | |
| | *5; *6; *7; *8; *9; | | |
| | *10; *11 | | |
| CYP1A2 | | rs206951485; rs762551 | |
| CYP1B1 | *4; *5; *6; *7*8; *9; | | |
| | *10; *11; *12; *13; | | |
| | *14; *15; *16; *17; *18; | | |
| | *19; *20; *21; *22; | | |
| | *23; *24; *25; *26 | | |
| CYP2C8 | | rs11572103; rs11572080; | _2189delA |
| CYP2C9 | | rs1799853; rs28371686; | |
| | | rs1057910; | |
| CYP2C19 | | rs4244285; rs12248560; | |
| CYP2D6 | | rs2837170; rs1065852; | MXN2; MXN3; MXN4; |
| | | rs3892097; rs5030655; | MXN5; MXN10; MxN13 |
| | | rs16947; | |
| CYP2E1 | *1A; *1B; *1C; *1Cx2; | | |
| | *1D; *2; *3; *4; *5A; *5B | | |
| | *6; *7A; *7B; *7C | | |
| CYP2F1 | *1; *2A; *2B; *3; *4; *5A | | |
| | *5B; *6 | | |
| CYP2S1 | *1A; *1B; *1C; *1D; *1E | | |
| | *1F; *1G; *1H; *2; *3; * | | |
| | 4; *5A | | |
| CYP2W1 | *1A; *1B; *2; *3; *4; | | |
| | *5; *6 | | |
| CYP3A4 | *1B; *3; *20; | rs776746; rs2740574; | 7_99381694; COSM42988; |
| | | rs4540092 | COSM35658; |
| | | | COSM42989; 7_99364768; |
| | | | 7_99361606; |
| CYP3A5 | *1A; *1B; *1C; *1D; *1E | | |
| | *2; *3A; *3B; *3C; *3D; | | |
| | *3E*3F; *3G; *3H; *3I; | | |
| | *3J; *3K; *3L; *4; *5; *6 | | |
| | *7*8; *9 | | |
| CYP3A43 | *1A; *1B; *2A; *2B; *3 | | |
| CYP3A7 | *1A; *1B; *1C; *1D; *1E | | |
| | *2; *3 | | |
| CYP4A11 | *1 | | |
| CYP4A22 | *1; *2; *3A; *3B; *3C; | | |
| | *3D; *3E; *4; *5; *6; *7; | | |
| | *8; *9; *10; *11; *12A; * | | |
| | 12B; *13A; *13B; *14; * | | |
| | 15; | | |
| CYP4F2 | *1; *2; *3 | | |
| CYP5A1 | *1A; *1B; *1C; *1D; *2; | | |
| | *3; *4; *5; *6; *7; *8; *9 | | |
| DYDP | *1; *2A; *3; *4; *5; *6; *7 | | |
| | *8; *9A; *9B; *10; | | |
| | *11; *12; *13 | | |
| GSTA1 | *1A; *1B; | | |
| GSTA2 | *2A; *2B; *2C; 2E; | | |
| GTM1 | | | *1AX2 |
| GSTM2 | *3A; *3B; | | |
| GTT2 | *1A; *1B; | | |
| GSTZ1 | *1A; *1B*1C; *1D; *1E; | | |
| | *1F; *2A; *2B; | | |
| NAT1 | | rs4986989 | |
| NAT2 | NAT2*4 | rs1801280; rs1799930 | |
| PON1 | | rs662; rs854547; rs854548; | |
| | | rs854555; rs854560; | |
| PON2 | | rs6954345; rs13306702; | |
| | | rs987539; rs11982486; | |
| | | rs4729189; | |
| | | rs11981433; rs17876205; | |
| | | rs17876183; | |
| SLCO1B1 | *1; *5; *9 | | |
| SLCO1C1 | | rs36010656; rs10770705; | |
| | | rs3794271; | |
| SLCO2B1 | | | |
| SLCO5A1 | *1; *3 | rs16936455; rs10504461; | |
| | | rs10504460; | |
| SLCO6A1 | | rs151287898; rs150046652; | |
| | | rs140549680; | |
| SLC6A2 | | rs5564; rs1861647 | NT_010498.15_9300464 |
| SLC6A3 | | | 3′-VNTR_2_12 |
| SLC6A4 | | rs25531 | 5-HTTPLR-XL₂₈ |
| SLC10A1 | | rs2296651; rs4646285; | |
| SLC15A1 | | rs45628337; rs45513193; | |
| | | rs45562741; rs8187823; | |
| | | rs45569639; rs2297322; | |
| | | rs8187821; rs8187836; | |
| | | rs4646227; rs1339067; | |
| | | rs2274828; rs8187838; | |
| | | rs2274827 rs45545032; | |
| | | rs8187832; rs8187830; | |
| SLC16A1 | | rs12727968; rs12090418; | |
| | | rs1049434; rs11585690; | |
| | | rs7169; rs11811205; | |
| | | rs9429505 | |
| SLC19A1 | | rs1051266; rs1051298; | |
| | | rs1131596; rs12482346; | |
| | | rs1888530; rs2838958; | |
| | | rs3788200; rs3788205; | |
| SLC13A1 | | rs1880179; rs2204295; | |
| | | rs10281158; rs2140516; | |
| | | rs45621838; rs6466854; | |
| | | rs6962039; | |
| SLC15A2 | | rs1143669; rs1920305; | |
| | | rs2293616; rs2257212; | |
| | | rs1143670; rs1143671; | |
| | | rs1143672 rs1920314; | |
| | | rs1920313; rs4388019; | |
| SLC22A1 | | | SLC22A1_rs35191146_in- |
| | | | del |
| SLC22A2 | | | SLC22A2_>(134insA) in- |
| | | | del |
| SLC22A4 | | rs10479002; rs1050152; | |
| | | rs11568500; rs11568503; | |
| | | rs11568506; rs11568510; | |
| | | rs12777; rs2073838; rs272879; | |
| | | rs272889; rs272893; | |
| | | rs3792876; | |
| SLC22A7 | | rs2651185; rs36040909; | |
| SLC22A8 | | rs10792367; rs11231299 | |
| SLC22A9 | | rs7101446 | |
| SLC22A11 | | rs17300741; rs3782099; | |
| | | rs3759053; rs2078267; | |
| | | rs1783811 | |
| SLC22A16 | | rs6938431 | |
| SULT1A1 | | rs3760091; rs750155; | SULT1A1_CNV_1_5 |
| | | rs9282861; rs1801030 | |
| SULT1B1 | | | SULT1B1_CNV_2 |
| SULT1C1 | | | SULT1C1_CNV_3-5 |
| SULT1C2 | | | SULT1C2_CNV_1-7 |
| SULT1E1 | | | SULT1E1 _CNV_12 |
| SULT2A1 | | | SULT2A1_CNV_3-5 |
| SULT2B1B | | | SULT2B1B_CNV_12 |
| TAP1 | | rs1057141; rs17422866; | |
| | | rs1135216; rs121917702; | |
| | | rs1351383; rs2071480; | |
| TMPT | *2; *3C | | |
| TYMS | | rs2847153; rs2853539; | |
| | | rs34489327; rs34743033; | |
| | | rs45445694 | |
| UGT1A1 | | | rs8175347 = A(TA)7TA; |
| | | | rs8175347 = A(TA)8TA |
| UGT1A3 | *1A; *1B; *1C; | | |
| | *1D; *1E; *1F; *2A; *2B | | |
| | *2C; *2D; *2E; *3A; *3B | | |
| | *4A; *5A; *6A; *7A; | | |
| | *8A; *9A; *10A; *10B; | | |
| | *11A | | |
| UGT1A5 | *1; *2; *3; *4; *5; *6; *7 | | |
| UGT1A6 | *1A; *1B; *1C; *1D; *1E | | |
| | *1F; *1G; *2A; *2C; | | |
| | *2D; *2E; *3; *3B; *4A; | | |
| | *4B; *4C; *5; *6; | | |
| | *7; *8; *9 | | |
| UGT1A7 | *1A; *1B; *2; *3; | | |
| | *4; *5; *6; *7; *8; *9; | | |
| | *10; *11; *12; *13; *14 | | |
| UGT1A9 | *1A; *1B*1C; *1D; *1E; | | |
| | *1F*1G; *1H; *1J; *1K; | | |
| | *1L; *1M*1N; *1P; *1Q | | |
| | *1R; *1S; *1T; *1U; *1V | | |
| | *1W; *1X; *2; | | |
| | *3A; *3B; *4; *5; | | |
| UGT2B4 | *1A; *1B*1C; *1D; *1E; | | |
| | *1F*1G; *1H; *1J; *1K; | | |
| | *1L; *1M*1N; *1P; *1Q | | |
| | *1R; *1S; *1T; *2A; *2B; | | |
| | *3; *4; *5; *6; | | |
| UGT2B7 | *1A; *1B*1C; *1D; *1E; | | |
| | *1F*1G; *1H; *1J; *1K; | | |
| | *2A; *2B; *2C; *2D; *2E | | |
| | *2F; *2G; *3; *4; | | |
| UGT2B15 | *1; *2; *3; *4; *5; | | |
| | *6; *7; | | |
| UGT2B17 | *1; *2; | | |
| UGT2B28 | *1; *2; *3; | | |

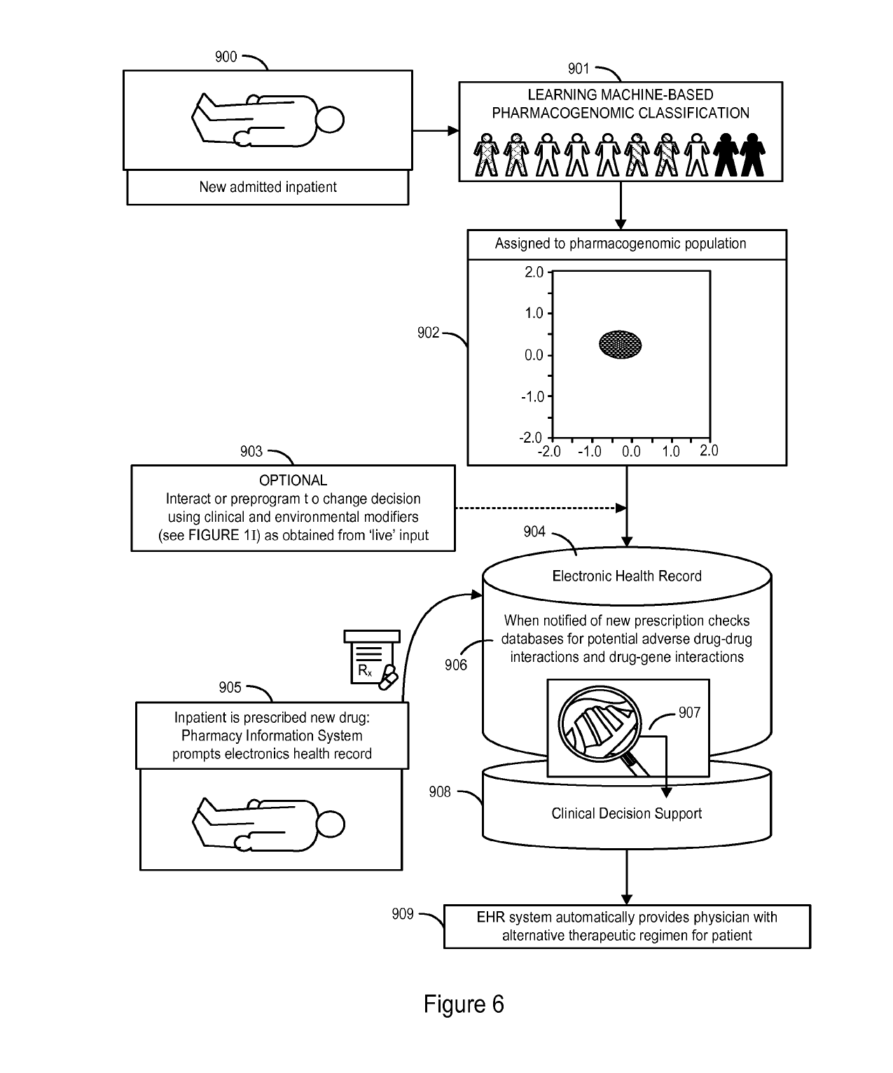

In another embodiment, the learning machine is an interactive learning machine. In an interactive learning machine, supervised, multi-class learning is leveraged so that a ‘leave-one-out’ matrix provides end-users real-time control of model space. Examples shown in this invention are the optional use-controlled features 103, 112, 113, 205, 401, 403, 409, 410, 411, 501, and 903 shown in FIGS. 1, 1A, 1H, 1I and 6 where control of pre-processing, post-processing and decision alteration by modifiers can be performed in real-time.

The invention also provides a system and method for pre-processing data so as to augment the training data to maximize the knowledge discovery by the learning machine. Since the raw output from a learning machine may not fully disclose the knowledge in the most readily interpretable form, the invention also provides systems and methods for post-processing data output from a learning machine in order to maximize the value of the information delivered for human comprehension, further automated processing, or to modify the output for an intended application.

### Surrogate Phenotypes

According to the invention, the training set of surrogate phenotypes consists of a large number of ‘virtual patients’ derived from a massive, de-identified whole human genome dataset (‘the human genome variome’) 110, which can optionally be augmented by clinical co-variables from a de-identified electronic health record (EHR) dataset (‘the human health variome’) 109 that are significantly associated with drug metabolizer phenotype. For purposes of increasing the accuracy of classification of metabolizer phenotype, the trained learning machine is tested using test data 204 to ensure that its output is validated within an acceptable margin of error prior to live input of a new patient or participants, or new groups of patients or participants. As described infra, the criteria chosen to define the discrete pharmacogenomic strata to be used for the classifier are based on the results of the analysis of population structure, determined using inter-ethnic differences in the frequency and the variation of such frequencies of single nucleotide polymorphisms (SNPs), structural variants such as copy number variants and indels in Cytochrome P450 drug metabolism, phase II metabolism and pharmacodynamic genes (See FIG. 1C and FIG. 1D).

In one embodiment, the present invention enhances knowledge discovery by pre-processing the data 205 prior to its use by the classifier. The pre-processing steps may comprise reformatting or augmenting the live phenotype to provide missing data attributes necessary for accurate classification. Where the significant genomic and clinical co-variables have been determined a priori, it is critical that the surrogate phenotypes within the training set are derived from high quality data, particularly where the classifier is a learning machine.

FIG. 1A shows schematically how the training set of ‘surrogate phenotypes’ is developed. The first step involves multivariate statistical testing of all ADME variants in a massive dataset, e.g., the dataset of 17,131 whole human genomes, 200 to determine whether ADME population structure is present such that it can be used in a quantitative manner to classify an individual or group of individuals into a discrete pharmacogenomic population cluster. The next step utilizes statistical methods known in the art to determine and validate the ADME population structure. These methods include, for example, allele-sharing distance (ASD) and multi-dimensional scaling, (see e.g., Gao and Martin, “Using allele sharing distance (ASD) for detecting human population stratification”, Human Heredity. 2009; 68:182-191), as validated by principal component analysis (PCA—involving eigenanalysis, see e.g., Patterson et al., Population Structure and Eigenanalysis. PLoS Genet. 2006; 2(12): e190), as well as verification using a state-of-the-art software program for analysis of human population structure called StructHDP (see e.g., Shringarpure S, Won D, and Xing EP. StructHDP: automatic inference of number of clusters and population structure from admixed genotype data. Bioinformatics. 2011; 27(13):i324-32 —obtained from the Department of Machine Learning at Carnegie Mellon University). The set of ADME genes and gene variants is thus instantiated as a discrete set of “surrogate phenotypes” using population structure and clustering methods. These methods are effective to produce an extremely accurate training set that when used according to the methods of the invention to train a learning machine can accurately determine the pharmacogenomic phenotype of any individual using the set of data attributes provided herein, even where there are missing or incomplete data attributes for the individual. According to the methods of the invention, the missing or incomplete information is provided using the training set of surrogate phenotypes that have been pre-processed 205, 206 and tested 204 to represent all known metabolizer phenotypes 203, as embedded into the predictive pharmacogenomic classifier 108. Pre-processing of the training set may include one or more of the following steps:
1. Correction of any missing erroneous ADME variation data;
2. Automated comparison to pharmacogenomic knowledge bases 206;
3. Manual validation through comparison to the known worldwide distribution of ADME variation in genes that encode phase I and phase II drug metabolizing enzymes (DMEs) and drug transporter proteins (DTPs); and
4. Examination of the training set to ensure appropriate dimensionality by transformation of coordinates as required.

The training set of tested and pre-processed surrogate phenotypes provides a ‘best fit’ of the available data for any ‘live’ individual (e.g., patient or prospective clinical trial participant) in the context of the available data for the entire human population which is represented by the set of surrogate phenotypes.

### Methods for Classification

In one embodiment, the invention provides methods and systems for the pharmacogenomic classification of an individual or group of individuals (e.g., a patient or clinical trial participant) using the available data from the individual or group as input into the classifier of the invention, wherein the classifyer is a learning machine pre-trained on a training set of surrogate phenotypes as described herein. FIG. 1H depicts a flow chart of the classification process. In accordance with this embodiment, the process is comprised of the following sequential steps:
1. Collecting a live dataset of a phenotype 101, 102 or group of phenotypes 100 (400);
2. Adding known clinical or genomic data about the ‘live’ input to improve the accuracy of subsequent classification 401.
3. Pre-processing the live data set to equalize the data and ensure correct dimensionality, inputting the pre-processed live data set into the trained learning machine for processing to generate a live output 402.
4. Perform any pre-filtering on ‘live’ data and training set to prepare data for classification 406.
5. Perform classification of ‘live’ data to appropriate pharmacogenomic population classified by the learning machine using a training set of surrogate phenotypes that have been pre-processed in the same manner as the ‘live’ input 406.
6. Classification of the ‘live’ input by the trained learning machine as to comprehensive pharmacogenomic metabolizer stratum 407.
7. Post-processing of the learning machine output for comprehension by a human or computer 408.

In one embodiment, the learning machine is an interactive learning machine in real-time or as pre-programmed into the learning machine as shown in FIG. 1H, and the following additional optional steps can be undertaken:
1. Adjust input to the training set of surrogate phenotypes in the learning machine from de-identified genome/EHR databases 403.
2. As part of post-processing, check that classification profile fits assigned cluster as per 206 and 207, which are used are for pre-processing of the training set (FIG. 1A) 409.
3. Alter the classification output of the learning machine decision using clinical and environmental modifiers (see FIG. 1I) as obtained from ‘live’ input 410.
4. Enhance the learning machine output to prepare the date for use in clinical trials, for example, by annotating the data as one would for a Clinical Data Management System 411.

Although the invention accurately classifies an individual or group of individuals into the stratum that provides the ‘best fit’ based on ADME variance, in certain embodiments where the classification is to be used for particular applications, such as for the prediction of ADR risk, the initial classification may be modified based on certain clinical and environmental variables as described herein. FIG. 1I provides exemplary clinical and environmental variables 501 that be used to modify the pharmacogenomic classification decision.

In one embodiment, the invention provides for the post-processing of the output from the learning machine. The post-processing methods of the invention comprise interpreting the output of the learning machine in order to communicate meaningful characteristics of that output. The meaningful characteristics to be ascertained from the output may be problem or data specific. Post-processing involves interpreting the output into a form that is comprehendible by a human or one that is comprehendible by a computer. Where the learning machine is an interactive learning machine, the post-processing may further comprise allowing user adjustment in real-time.

The present invention also provides methods and subsystems for continually updating the whole genome database 110 and EHR database 109 using a knowledge update engine 106 which obtains ongoing research results by extracting data from a specified federation of databases 104. Thus, in accordance with the methods of the invention, the composition of the simulated data may vary over time to reflect changes in the knowledge of change in population structure and personal health variation.

The knowledge update engine 106 functionality is provided by a dedicated web service drawing information from a variety of databases, to act in a federated manner 104, to provide validated data by manual or semi-automated curation 105, for refreshing both whole genome 110 and health variome databases 109. Thus, all data, especially that which is derived from scientific and medical literature and other content databases must be curated by humans for the evaluation of the following characteristics: (1) Replication: Any new results that could better inform the pharmacogenomic classifier, such as those related to subpopulation differences in allele frequency, novel drug-gene mutation associations, genome variant data, etc, must be replicated by one other independent studies before it is passed to the data engine for variome derivation. Negative and positive findings must be evaluated based on the presence of underlying population structure that could skew the results. (2) Study quality: Sample size, study design, tests of significance and confounding factors must be assessed to determine if a new publication is worthy of inclusion. If it does pass such inspection, it won't be sent to the data engine until it has been replicated as stated in point #1.

The present invention further provides methods and subsystems containing a semi-automated or manual curation method to power a data engine 105 for new information obtained from one or more federated databases 104. This ensures that the information meets the most stringent conditions of peer-review based on replication and other characteristics to ensure the validity and value of the data. In accordance with the present invention, a data engine 106 for generation of new whole human genome and EHR data continually and selectively mines public and private databases and knowledge sources, and is constantly updated by the Knowledge Update Engine 106 to provide an accurate statistical representation of the health data of the population of interest.

In one embodiment, the public health data is selected from the federation of online or other accessible databases 104. To mine such data, several knowledge discovery methods can be used. The knowledge discovery process used in this invention is a multistep life cycle that begins with problem and data understanding, explicitly highlights the large effort necessary for data preparation and semi-automated or manual curation, and then proceeds to modeling and evaluation. The final phase is the deployment of predictive models into existing systems. The allowable data types and data file formats may include one or more of the following:

### EHR and Other Clinical Data/Knowledge Resources:

1. Administrative EHR System Components. In the EHR, the major data type is the Registration, Admission, Discharge and Transfer (RADT). The data obtained through these components are collectively termed as the RADT data. RADT includes information that is vital for identifying and assessing the patients. These data also includes various parameters, such as name, demographics, next of kin, employer information, major complaint, patient disposition, image of a driver's license.
2. The unique patient identifier that forms the core of an EHR is called the Medical Record Number (MRN) or Master Patient Index (MPI). The MRN code forms the prime linkage for various clinical observations, such as tests, procedures, complaints, evaluations, and diagnoses with the patient.
3. Laboratory System Components. Laboratory Information Systems (LISs) are used as hubs, which facilitate various processes, such as, integrating orders, acquiring results from various laboratory instruments, creating schedules, performing billing activities, and performing other tasks related to administrative information.
4. Logical Observation Identifiers Names and Codes (LOINC). LOINC is a voluntary effort housed in the Regenstrief Institute, associated with Indiana University. LOINC facilitates the exchange and pooling of results, such as blood hemoglobin, serum potassium, or vital signs, for clinical care, outcomes management, and research. Currently, most laboratories and other diagnostic services use HL7 to send their results electronically from their reporting systems to their care systems. Similar to SNOMED CT, LOINC is used by CDA documents, CCR documents, and other EHR standards as a vocabulary domain, encoding EHR components and terminologies into a standard database of terms.

5. Pharmacy System Components: There are 2 major components that may, or may not, be integrated into the EHR system. They are: (1) Computerized Physician Order Entry (CPOE), this is used by clinical providers to order laboratory, pharmacy, and radiology services electronically; and (2) E-prescribing or electronic prescribing is a technology framework that allows physicians and other medical practitioners to write and send prescriptions to a participating pharmacy.

6. RxNorm. This is a standardized, controlled terminology for medications in the U.S., including medication name (both generic and brand), dosage, route of administration, ingredients, and fully-specified “common dose forms” (i.e., what a physician might enter as part of a prescription to a pharmacy). These multiple components are linked together through a relational file structure, easily portable into database format. RxNorm is part of the Unified Medical Language System (UMLS) used to integrate and map diverse and competing controlled medical terminologies in order to facilitate interoperability and data exchange across healthcare providers. Its development was accelerated by the corresponding development of HL7 (Health Level 7) data exchange standards.

7. Clinical Documentation. Electronic clinical documentation systems augment the value of EHRs by capturing various annotations, such as clinical notes, patient assessments, and clinical reports such as contained in Medication Administration Records (MARs).
8. HL7: Health Level Seven (HL7). HL7 is a non-profit organization involved in the evelopment of international healthcare informatics interoperability standards “HL7” also refers to some of the specific standards created by the organization (e.g., HL7 v2.x, v3.0, HL7 RIM). HL7 and its members provide a framework (and related standards) for the exchange, integration, sharing, and retrieval of electronic health information. The Reference Information Model (RIM) and the HL7 Development Framework (HDF) are the basis of the HL7 Version 3 standards development process. RIM is the representation of the HL7 clinical data (domains) and the life cycle of messages or groups of messages. HDF is a project to specify the processes and methodology used by all the HL7 committees for project initiation, requirements analysis, standard design, implementation, standard approval process, etc. Examples of HL7 standards include:
1. Version 2.x Messaging Standard—an interoperability specification for health and medical transactions;
2. Version 3 Messaging Standard—an interoperability specification for health and medical transactions, based on RIM;
3. Version 3 Rules/GELLO—a standard expression language used for clinical decision support;
4. Arden Syntax—a grammar for representing medical conditions and recommendations as a Medical Logic Module (MLM);
5. Clinical Context Object Workgroup (CCOW)—an interoperability specification for the visual integration of user applications;
6. Claims Attachments—a Standard Healthcare Attachment to augment another healthcare transaction;
7. Clinical Document Architecture (CDA)—an exchange model for clinical documents, based on HL7 Version 3;
8. Electronic Health Record (EHR)/Personal Health Record (PHR)—in support of these records, a standardized description of health and medical functions sought for or available; and
9. Structured Product Labeling (SPL)—the published information that accompanies a medicine, based on HL7 Version 3.

### Whole Genome or Exome Data:

1. AGP (Advanced Graphics Pipeline). AGP is a tab delimited, column oriented file describing the construction of a larger sequence object from smaller objects (contigs, scaffolds or chromosomes). The large object can be a contig, a scaffold (supercontig), or a chromosome. Each line (row) of the AGP file describes a different piece of the object, and has the column entries defined below.
2. SAM (Sequence Alignment/Map) format. SAM is the most commonly used generic format for storing large nucleotide sequence alignments. SAM Tools provide various utilities for manipulating alignments in the SAM format, including sorting, merging, indexing and generating alignments in a per-position format.
3. The Basic Local Alignment Search Tool (BLAST). BLAST finds regions of local similarity between sequences. The program compares nucleotide or protein sequences to sequence databases and calculates the statistical significance of matches. BLAST can be used to infer functional and evolutionary relationships between sequences as well as help identify members of gene families.
4. FASTA format. FAST is a text-based format for representing either nucleotide sequences or peptide sequences, in which nucleotides or amino acids are represented using single-letter codes. The format also allows for sequence names and comments to precede the sequences. The definition line and sequence character format used by NCBI.
5. FASTQ format. FASTQ is a text-based format for storing both a biological sequence (usually nucleotide sequence) and its corresponding quality scores. Both the sequence letter and quality score are encoded with a single ASCII character for brevity. It was originally developed at the Wellcome Trust Sanger Institute to bundle a FASTA sequence and its quality data, but has recently become the de facto standard for storing the output of high throughput sequencing instruments such as those made from Illumina sequencing machines.
6. BED. The BED format provides a flexible way to define the data lines that are displayed in an annotation track. BED lines have three required fields and nine additional optional fields. The number of fields per line must be consistent throughout any single set of data in an annotation track. The order of the optional fields is binding: lower-numbered fields must always be populated if higher-numbered fields are used.
7. WIG. Wiggle format (WIG) allows the display of continuous-valued data in a track format. The wiggle (WIG) format is for display of dense, continuous data such as GC percent, probability scores, and transcriptome data.
8. bigWIG. The bigWig format is for display of dense, continuous data that will be displayed in the Genome Browser as a graph. BigWig files are created initially from wiggle (wig) type files, using the program wigToBigWig.
9. GFF (General Feature Format). The General Feature Format lines are based on the GFF standard file format. GFF lines have nine required fields that must be tab-separated. If the fields are separated by spaces instead of tabs, the track will not display correctly.
10. MAF (Multiple Alignment Format). The multiple alignment format stores a series of multiple alignments in a format that is easy to parse and relatively easy to read. This format stores multiple alignments at the DNA level between entire genomes.
11. VCF (Variant Call Format). VCFi s a flexible and extendable format for variation data such as single nucleotide variants, insertions/deletions, copy number variants and structural variants. When a VCF file is compressed and indexed using tabix, and made web-accessible, the Genome Browser can fetch only the portions of the file necessary to display items in the viewed region. VCF line-oriented text format was developed by the 1000 Genomes Project for releases of single nucleotide variants, indels, copy number variants and structural variants discovered by the project. When a VCF file is compressed and indexed using tabix, and made web-accessible, a genome browser can fetch only the portions of the file necessary to display items in the viewed region.

### EXAMPLES

The following section describes our analysis of a dataset of ADME variation extracted from 17,131 whole genome sequences of United States residents that demonstrates the presence of pharmacogenomically-discrete subpopulations in that dataset. We further demonstrate that these subpopulations can be instantiated as “surrogate phenotypes” that can be utilized as a training set to train a learning machine for the classification of an individual or group of individuals into one of a discrete set of pharmacogenomic phenotypes.

### Pharmacogenomic Population Structure of a Large Dataset of Whole Human Genomes

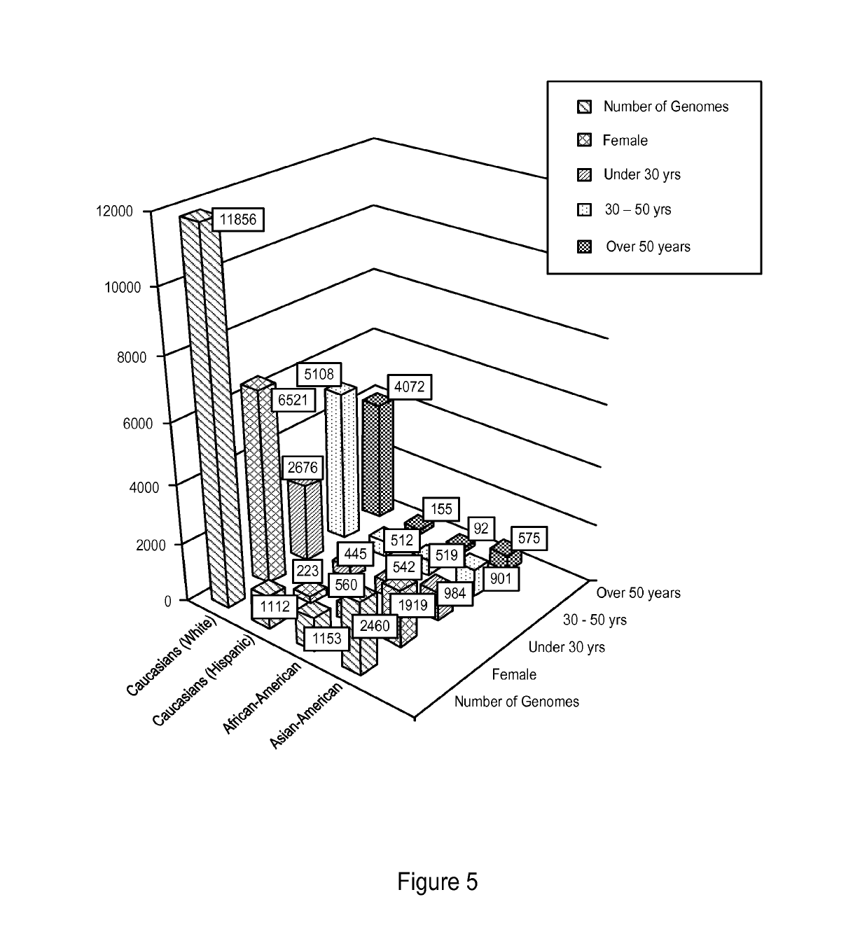

Our previous work analyzing a very large dataset of whole human genome sequences of healthy U.S. residents revealed tremendous inter-ethnic and inter-geographical differences in genomic variation and in the effects of those genetic variations, for example on CYP450 isoform activity (see U.S. Provisional Application No. 61/652,784, filed May 29, 2012, incorporated herein by reference in its entirety). The dataset consists of 17,131 whole human genome sequences from U.S. citizens identified only as to age, race and gender, which had been used as a control in an unrelated clinical study. The genomic sequences comprising the dataset were generated by ‘short read’ next generation sequencing under federal contract by Complete Genomics, Illumina and Life Technologies. The dataset was obtained under IRB approval. FIG. 5 provides an overview of the dataset 110.

The dataset has undergone a rigorous analyses whose first objective was to provide a comprehensive annotation of over 100 different variant types, including single nucleotide variants (SNPs), copy number variants (CNVs), insertions, deletions, rearrangements, enhancers, promoters, coding regions, transposons, splice sites, repeats, transcription factor binding sites, as well as known and unknown genomic functional elements. The analyses included the following:

1. Raw genomic DNA reads from 2nd generation platforms, including the Illumina HiSeq 2000 and Life Technologies' 5500x1 SOLiD™ machines. These instruments first captured images of many parallel reactions and ultimately yielded at least two and usually three pieces of information for each DNA sequencing step: the called base (which may be no-call), a quality score, and intensity values for all four possible bases. Collectively, this process is referred to as “primary” analysis or base calling. Once base calling has been performed, the raw image files were retained in this project. These are massive datasets, consisting of several primary data output files including image files such as *.tiff, *.csfasta, [CY3[CY3|CY5|FTC|TXR].fasta (color space reads), *.fasta, *.fastq, -QV.qual and *.stats. Every file format was converted to *.fastq.
2. After sequences were generated, they were aligned (‘mapped’) to a known human reference sequence (NCBI build 36-hg18) or GRCh37 (hg19) using BWA or SOAP, with base alignment and quality files including *.sam and *.bam.
3. Initial variant analysis was performed using SAMtools on all of the sequences from the Illumina and SOLiD platforms. Many different file formats, including *.vcf and *.gvf. Variant calls from the large Complete Genomics data were output as *.var files. Every file format was converted to *.vcf.

In the present context, this dataset was subjected to a detailed statistical analysis in order to determine whether, based on ADME variation, the dataset contained pharmacogenomically-discrete subpopulations that can be used in a quantitative manner to classify an individual or group of individuals into a discrete pharmacogenomic population cluster. First, it was necessary to determine whether this dataset is representative of the entire human genome variome with respect to ADME variants. This was accomplished using open source bioinformatics software tools to identify the totality of genetic variants known to influence drug metabolism. Exemplary software tools included the Genome Analysis Toolkit (GATK) (Mckenna et al., Genome Research (2010) 20:1297-1303) and the Variant Annotation, Analysis and Search Tool (Yandell et al. Genome Research (2011) 21:1529-1542). A comprehensive, computationally-based statistical assessment of the cytochrome P450 super-families of Phase I drug metabolizing enzymes, phase II metabolizing enzymes and several DTPs that have been associated with drug toxicity and response were examined in addition to other variants. This analysis indicated that this whole genome dataset contained all genome variants known to affect drug toxicity and response that have been published to date. Although additional mutations contained in the dataset may have no direct impact on adverse drug events (ADEs), adverse drug responses (ADRs), or efficacy of response, according to the methods of the present invention, they can be used to uncover population structure to identify subpopulations that display large differences in drug toxicity and drug response.

The next challenge in analyzing the variance of the massive genomic dataset was to determine if there was any evidence that the data came from a population that is structured according to pharmacogenomic variance, with emphasis placed on genes that encode phase I and phase II genes involved in drug metabolism and drug transporter proteins. Our experiments demonstrated that this dataset was large enough to contain pharmacogenomically-discrete subpopulations, and that these subpopulations could be quantified to enhance applications such as pharmacogenomic decision support and selection of clinical trial participants based on pharmacokinetic risk.

Next, it was necessary to determine the relative preservation of ancestral ADME variants, including single nucleotide variants (SNPs), copy number variants (CNVs), and other variants in ADME genes that constituted the major determinant of classification into the pharmacogenomically-discrete subpopulations. To accomplish this task, multivariate statistical testing (including multiple regression testing with multiple variables) was performed to determine statistically significant differences between the allele frequencies of ADME gene variants between Caucasian, Asian-American, and Africa-American populations derived from whole genome dataset 200. In particular, Constant Row Total-Multiple Correspondence Analysis (CRT-MCA) was used to examine ADME gene frequencies, including star alleles, single nucleotide variants (SNPs), copy number variants (CNVs) and structural variants. Over 350 genes were analyzed that included the most common phase I and phase II metabolic enzymes, as well as drug transporter protein gene frequencies. Comparisons focused on the most common variants as listed in Table 3, comparing: (1) European-Americans (Caucasian (white); (2) Caucasian (Hispanic) residents of the U.S.) versus other populations; (3) African-Americans versus other populations; and (4) Asian-Americans versus other populations. P-values are given as results of multivariate testing according to Guinand B., “Use of a multivariate model using allele frequency distributions to analyze patterns of genetic differentiation among populations”, Biol. J. Linnean Soc. (1996) 58(2): 173-195 and Multiple Comparisons and Multiple Tests Using SAS, Second Edition. Westfall P H, Tobias R D R and Wolfinger, R D. 2011. ISBN-60764-782-6. SAS Institute Inc., Cary, N.C. The ADME genes and gene variants tested (shown in Table 3) include all known human ADME single nucleotide variants and copy number variants that were found in the dataset of 17,131 whole human genome sequences. The results of significance testing are shown in Table 4.

These data show that ancestry is an important determinant of drug metabolizer phenotype. First, most variants in genes that encode the most important cytochrome P450 phase I enzymes involved in drug metabolism significantly differ between these populations when examined in this manner. In addition, many phase II metabolic enzyme gene variants, as well as those in specific genes that encode drug transporter proteins (DTPs), also exhibit significant differences between these ethnic/geographic populations. However, not all ADME polymorphic genes exhibit variation across these populations. For example there were no significant differences between U.S. populations using these methods in the ADME genes including AHR, ARNT, ARSA, ATP7B, ADH1A, ADH1B, ADH1C, ADH4, ADH5, ADH6, ADH7, ADHFE1, ALDH1A1, ALDH1A2, ALDH1A3, ALDH1B1, ALDH3A1, ALDH3A2, ALDH3B1, ALDH3B2, ALDH4A1, ALDH5A1, ALDH6A1, ALDH7A1, ALDH8A1, ALDH9A1, AOX1, CBR1, CBR3, CES1, CES2, CAT, CDA, CFTR, CHST1, CHST10, CHST11, CHST12, CHST13, CHST2, CHST3, CHST4, CHST5, CHST6, CHST8, CHST9, DDO, DHRS1, DHRS12, DHRS13, DHRS2, DHRS3, DHRS4, DHRS4L2, DHRS7, DHRS7B, DHRS7C, DHRS9, DPEP1, EPHX1, EPHX2, FMO1, FMO2, FMO3, FMO4, FMO5, GPX1, GPX2, GPX3, GPX4, GPX5, GPX6, GPX7, GSR, GSS, HAGH, HSD11B1, HSD17B11, HSD17B14, HNF4A, IAPP, KCNJ11, LOC731356, METAP1, NOS1, NOS2A, NOS3, PDE3A, PDE3B, PLGLB1, MAT1A, MPO, NR1I2, NR1I3, PPARA, PPARD, PPARG, RXRA, SOD1, SOD2, SOD3, PPARA, PPARD, PPARG, RXRA and XDH.

The analysis therefore also indicates that several co-variables contributed to discretization of populations of metabolizer subtypes apart from ancestry. However, the objective was to investigate to what extent ancestral variation contributes to the composition of different phenotypes, and thus could be used as a solution for the development of a training set of surrogate phenotypes to train a pharmacogenomic classifier. Table 3 and Table 4 provide the results of this analysis performed on the dataset of 17,131 whole human genomes. These results demonstrate that highly significant ADME population structure exists in the whole genome dataset 200.

Table 4 shows the significant population differences in ADME frequencies between the 4 subpopulations. The significant differences whose p-value is less than 0.01 are designated by bolded font. Methods of population structure were applied, which determine the degree of admixture, panmixia, and preservation of ancestral variation in ADME gene variants within the dataset of 17,131 whole genome sequences 200. These clusters are based on the analysis of characteristics unique to ancestral populations, including cluster analysis using PCA, eigenanalysis and ASD, as well as preservation of ethnic-specific gene variants. Different automatic classifiers could be used to bin an individual or population of individual into a defined pharmacogenomic stratum. The method of allele-sharing distance (ASD) for detection of human population stratification was used because it provides a simple approach for pharmacogenomic stratification and does not require dependency on any assumptions about population genetics that may become outdated over time. In addition, we have replicated these results using Principal Component Analysis (“eigenanalysis”) and with a software program called StructHDP.

The mathematical approach is described in detail in a publication by Gao and Martin [Gao S and Martin ER (2009) Using allele sharing distance for detecting human population stratification. Human Hered. 68:182-191], and is subsumed herein. ASD is a pair-wise measure between individuals, and is defined by the expression:

$$ASD = \frac{1}{L} {\sum }_{l = 1}^{L} d l$$

where dl=0 if two individuals have two alleles in common at the l-th locus; dl=1 with one allele in common, and dl=2 when there are no alleles in common.

Through derivation of ASD, it is possible to reduce the pharmacogenomic stratification problem to contrast the means of the different clusters. Diploid individuals from different subpopulations can thus be separated from half-matrix of pair-wise distances. Based on the ASD matrix, standard statistical clustering algorithms such as Ward's minimum variance and multidimensional scaling (MDS) methods, can be used to better resolve discrete pharmacogenomic subpopulations, and this is approach can be applied to bi-allelic SNPs, CNVs and multi-allelic variants. In this context, individuals within subpopulations have a higher proportion of allele sharing than between subpopulations since the match probabilities within is greater than between subpopulations due to co-ancestry. Using ASD derivation, when sufficient numbers of variant loci are used in the analysis, the distribution of within-subpopulation ASD and between-subpopulation ASD do not overlap with each other and the subpopulations are separable using appropriate MSD methods. There are additional advantages with this approach, as it does require explicit specification of allele frequencies. Thus, discrete human subpopulations can be separated simply through a pair-wise distance matrix, which have been shown in large empirical studies using gene variant datasets. See Hinds et al. (2005) “Whole genome patterns of common DNA variation in three human populations”, Science 307: 1072-1079.

Population stratification is often a consequence of geographic isolation with low rates of migration and gene flow for a human subpopulation for several generations. Subpopulation isolation results in the non-random mating across the larger population of humans, and geographic separation allows for divergent random genetic drift due to sampling differences in the set of parental alleles that are passed on to offspring in subsequent generations of each subpopulation. Thus, allele frequencies change over time and this process is independent for each isolated subpopulation, ultimately causing detectable differences in the frequency of alleles after many generations of separation and differentiation. In this invention, we use this embedded stratification of the human population as a means to classify any given individual into a discrete pharmacogenomic subpopulation. ASD is especially sensitive for the detection of pharmacogenomic ‘outliers’, as might be expected to constitute any specific poor or ultra-rapid metabolizer phenotype, based on genome variation. The assumption is that the human population has reached equilibrium, as defined by the F-statistic (F_{ST}), also designated as θ. If θ is small, it means that the allele frequencies at a marker are similar between populations, and when it is large, it means that the allele frequencies are different. The probability for either allele to ultimately be fixed is equal to their starting allele frequency and the following guidelines have been suggested for interpreting values of F_{ST} or θ (Edwards TL and Gao X “Methods for detecting and correcting for population stratification”, Current Protocols in Human Genetics (2012) 1.22.1-1.22.14): 0 to 0.05 indicates little differentiation; 0.05 to 0.15 indicates moderate differentiation; 0.15 to 0.25 indicates great differentiation; and >0.25 indicates very great differentiation.

Testing selected pharmacogenomic subpopulations using ASD and MDS, revealed that all of the human subpopulations with their associated pharmacogenomic variants, as defined by all variants in the ADME genes showed values of θ that ranged between 0.13 to 0.37 in our population of 17,131 whole human sequences 110, indicating that drug metabolizing gene variants range from the upper end of moderate differentiation to very great differentiation. Therefore, the use of even a limited subset of genomic markers can discretize pharmacogenomic subpopulations that can be exploited to classify any given individual or cohort based on this simple scheme, because all of the corresponding θ or F_{ST} values indicated that these 4 ethnic subpopulations in a very large dataset of whole human genome variants differ by a range of p-values from <0.05 to <0.00001.

To determine whether this sample of genotyped patients exhibited a distribution reflecting underlying population structure in ADME genes, three independent tests were conducted by different statisticians familiar with the methods of population structure analysis. These were (1) the determination of allele-sharing distance (ASD) between populations using multi-dimensional scaling (MSD) or gap analysis (See e.g., Gao and Martin, “Using allele sharing distance (ASD) for detecting human population stratification”, Human Heredity 0.2009; 68:182-191); (2) eigenanalysis; and (3) the software application StructHDP (Shringarpure S, Won D, and Xing EP. StructHDP: automatic inference of number of clusters and population structure from admixed genotype data. Bioinformatics, 27(13):i324-32, 2011—obtained from the Department of Machine Learning at Carnegie Mellon University). All three methods produced nearly identical results—that the massive whole genome sequence database 200 exhibited highly significant population structure to the extent that it could be classified into a finite set of discrete pharmacogenomic populations that could be visualized using cluster analysis. These methods are described in more detail below.

1. Allele-Sharing Distance (ASD)

ASD is especially sensitive for the detection of pharmacogenomic ‘outliers’, as might be expected to constitute any specific poor or ultra-rapid metabolizer phenotype, based on genome variation. The assumption is that the human population will reached equilibrium, as defined by the F-statistic. So, although it may presume a simple interpretation of relatedness is the average genetic distance, with the assumption that ADME mutations accumulate in a clock-like manner on a segment of DNA, the allele-sharing distance reflects the minimum time in the past that DNA was present in a single ancestor—it shows independence from current assumptions in medical genetics that inherited traits must behave according to Hardy-Weinberg equilibrium, so that is it does not depend on the following assumptions: Non-random mating; Accumulation of de novo mutations; Natural selection; Random genetic drift; Gene flow; and Meiotic drive. In human populations, all of these phenomena are present, so a method that can provide some independence from them is optimal. For example, numerous examples from the Encyclopedia of DNA Elements program (ENCODE; See e.g., Batut P J, Dobin A, Plessy C et al. High-fidelity promoter profiling reveals widespread alternative promoter usage and transposon-driven developmental gene expression. Genome Res. 2013; 23: 169-180) demonstrate the ubiquity of allele-specific binding and allele-specific gene expression, as well as the presence of transposable elements in the human genome. Thus, the most accurate clustering algorithms given our current knowledge do not depend on notions currently popular in medical genetics and GWAS.

2. Eigenanalysis

Eigenanalysis, also known as principal components analysis (PCA), is an analytic technique commonly used in genetics to determine the underlying structure of populations (See e.g., Patterson et al., Population Structure and Eigenanalysis. PLoS Genet. 2006; 2(12): e190). For example, it can be used to determine whether subpopulations of selected samples are more closely related to each other than they are to the population as a whole. In this context, the term is being used to emphasize the fact that not just the eigenvectors (principal components) are important, but also the eigenvalues. The application of PCA to genomic data—and this approach for analyzing the data—provides a natural method of uncovering population structure. In most applications of PCA, the multivariate data has an unknown covariance, and PCA is attempting to choose a subspace on which to project the data that captures most of the relevant information. In many such applications, a formal test for whether the true covariance is the identity matrix makes little sense. For statistical analysis, for example in a clinical trial of experimental versus controls, the test we used was Wright's ANOVA F-statistic (also known as FST or θ)

3. StructHDP

This software application has been optimized for the correction of sample selection bias in machine learning using a mathematical framework that easily detects such biases and provides solutions. It was first developed to address sample selection bias in an unsupervised clustering setting. However, in Dr. Shringarpure's doctoral thesis, she demonstrates problems with algorithmic solutions and clustering algorithms that are popular in population genetics (See e.g., Lawson DJ and Falush D. Population identification using genetic data. Annu. Rev. Genomics Hum. Genet. 2012.13:337-61). Specifically, Dr. Shringarpure demonstrated that numerous similarity matrices and clustering algorithms for population identification using genetic data show significant sampling bias and have trouble coping with large genomic datasets, including the software applications STRUCTURE and ADMIXTURE.

TABLE 3
ADME and variants found in the Human Population Genome Variome dataset of
17,131 whole genome sequences that showed significant differences in ethnic frequency among 3
different U.S. populations (for results of the statistical analysis, see Table 2).

| | |
|---|---|
| Gene | Variants (star allele, rsID, or if not indicated - all known human variants) |

Cytochrome P450 Phase I Drug Metabolizing Enzymes (DMEs)

| | |
|---|---|
| CYP1A1 | *1; *2A; *2B; *2C; *3; *4; *5; *6; *7; *8; *9; *10; *11 |
| CYP1A2 | *1A; 2*1B; *1C; *1D; *1E; *1F; *1G; *1H; *1J; *1K; *2; *3; *4; *5; *6; *7; *8; *9; |
| | *10; *11; *12; *13; *14; *15; *16; *17; *18; *19; *20; *21 |
| CYP1B1 | *1; *2; *3; *4; *5; *6; *7*8; *9; *10; *11; *12; *13; *14; *15; *16; *17; *18; *19; |
| | *20; *21; *22; *23; *24; *25; *26 |
| CYP2A6 | *1A; *1B1; *1B2; *1B3; *1B4; *1B13; *1B14;; *1B15; *1B16; *1B1; *1C; *1E; *1F; *1G; |
| | *1K; *1L; *1X2A; *1X2B; *2; *3; *4A; *4B; *4C*; 4D; * 4E; *4F; *4G; *4H; *5; *6; *7; |
| | *8; *9B; *10; *11; *12C; *13; *14; *15; *17 |
| CYP2A13 | *1A; *1B; *1C; *1D; *1E; *1F; *1G; *1H; *1J; *1K; *1L; *2A; *2B; *3; *4; *5; *6; *7; *8; *9; *10; |
| CYP2B6 | *1A; *1B; *1C; *1D; *1E; *1F; *1G; *1H; *1J; *1K; *1L; *1M; *1N; *2A; *2B; |
| | *3; *4A; *4B; *4C; *4D; *5A; *5B; *5C; *6A; *6B; *6C; *7A; *7B; *8; *9; *10 |
| | *11A; *11B; *13A; *13B; *15B; *16; *17A; *17B; *18; *19; *20; *21; *22; *23 |
| | *24; *25; *26; *27; *28; *29; *30 |
| CYP2C8 | *1A; *1B; *1C; *2; *3; *4; *5; *6; *7; *8; *9; *10; *11; *12; *13; *14 |
| CYP2C9 | *1A; *4; *5; *6; *7; *8; *9; *10; *12; *13; *14; *15; *16; *17; *18; *19; *20; *21 |
| | *22; *23; *24*25; *26; *27; *28; *29; *30; *31; *34; *35; *36; *52 |
| CYP2C19 | *1A; *1B; *1C; *2A*2B; *2C; *2D; *3A; *3B; *4A; *4B; *5A; *5B; *6; *7; *8 |
| | *9; *10; *11; *12; *13; *14; *15; *16; *17; *18; *19; *20; *21; *22; *23; *24; |
| CYP2D6 | *1A; *1B; *1C; *1D; *1E; *1XN; *2A; *2B; *2C; *2D; *2E; *2F; *2G; *2H; *2J; *2K; *2L; *2XN; |
| | *3A; |
| | *3B; *4A; *4B; *4C; *4D; *4E; *4F; *4G; *4H; *4J; *4K; *4L; *4M; *4N; *4X2; *5; *6A; *6B; * |
| | 6C; *6D; *7; *8; *9; *9x2; *10A; *10B; *10C; *10D; *10X2; *11; *12; *14A; *14B; *15; *16; * |
| | 17; *17XN; *18; *19; *20; *21A; *21B; *22; *23; *24; *25; *26; *27; *28; *29; *30; *31; *32; |
| | *33; *34; |
| | *35A; *35B; *35X2; *36; *36Duplicate; *37; *38; *39; *40; *41; *42; *43; *44 |
| | *45A; *45B; *46; *47; *48; *49; *50; *51; *52; *53; *54; *55; *56A; *56B; *57; |
| | *58; *59; *60; *61; *62; *63; *64; *65; *66; *67; *68A; *68B; *69; *71; *72; *73; *74; *75; |
| | *76; *78; *79; *80; *81; *82; *83*92; *102; *103; *104; *105 |
| CYP2E1 | *1A; *1B; *1C; *1Cx2; *1D; *2; *3; *4; *5A; *5B; *6; *7A; *7B; *7C |
| CYP2F1 | *1; *2A; *2B; *3; *4; *5A; *5B; *6 |
| CYP2J2 | *1; *2; *3; *4; *5; *6; *7; *8; *9; *10 |
| YP2R1 | *1; *2 |
| CYP2S1 | *1A; *1B; *1C; *1D; *1E; *1F; *1G; *1H; *2; *3; *4; *5A |
| CYP2W1 | *1A; *1B; *2; *3; *4; *5; *6 |
| CYP3A4 | *1A; *1B*1C; *1D; *1E; *1F; *1G; *1H; *1J; *1K; *1L; *1M*1N; *1P; *1Q; *1R; |
| | *1S; *1T; *2; *3 *4; *5; *6; *7; *8 *9; *10; *11*12; *13; *14; *15A; *15B; |
| | *16A; *16B; *17; *18A; *18B; *19; *20; *21; *22; also: rs57409622; rs146568511; |
| | rs4646437; rs59418896; rs3091339; rs142296281; rs139541290; rs75726589; |
| | rs4646450; rs144721069; rs12721625; 7_99361548; rs71581998; rs113716682; |
| | rs143966082; rs72552797; rs72552796; rs71583803; rs78764657; rs140422742; |
| | rs57409622; rs71581996; rs188389063; 1000 GENOMES_7_99381694; |
| | COSM42988; |
| | rs145582851; rs148633152; rs149870259; rs28371760; rs150559030; COSM35658 |
| | rs140355261; COSM42989; rs147752776; rs3208361; rs113667357; rs181612501; |
| | rs3208363; 1000GENOMES_7_99364768; rs138675831; rs10250778; rs145669559; |
| | 1000GENOMES_7_99361606; rs142425279; rs139109027; rs1041988; |
| | rs181210913 |
| | rs138105638; rs34784390; rs72552795; rs207468334; rs12114000; rs17277546 |
| CYP3A5 | *1A; *1B; *1C; *1D; *1E; *2; *3A; *3B; *3C; *3D; *3E*3F; *3G; *3H; *3I; *3J; |
| | *3K; *3L; *4; *5; *6; *7; *8; *9 |
| CYP3A7 | *1A; *1B; *1C; *1D; *1E; *2; *3 |
| CYP3A43 | *1A; *1B; *2A; *2B; *3 |
| CYP4A11 | *1 |
| CYP4A22 | *1; *2; *3A; *3B; *3C; *3D; *3E; *4; *5; *6; *7; *8; *9; *10; *11; *12A; *12B; *13A; *13B; *14; |
| | *15; |
| CYP4B1 | *1; *2A; *2B; *3; *4; *5; *6; *7 |
| CYP4F2 | *1; *2; *3 |
| CYP5A1 | *1A; *1B; *1C; *1D; *2; *3; *4; *5; *6; *7; *8; *9 |
| CYP8A1 | *1A; *1B; *1C; *1D; *1E; *1F; *1G; *1H; *1J; *1K; *1L; *2; *3; *4 |
| CYP19A1 | *1; *2; *3A; *3B; *4B; *4C; *4D |
| CYP21A2 | *1A; *1B; *2; *3; *4; *5; *6; *7; *8; *9; *10; *11; *12; *18; *19; *21; *22 *23; |
| | *24; *25; *26; *27; *28; *29; *30; *31; *32; *33; *34; *35; *36; *37; *38; |
| | *39; *40; *41; *42; *43; *44; *45; *46; *47; *48; *49; *50; *51; *52; *53; *54; |
| | *55; *56; *57; *58; *59; *60; *61; *62; *63; *64; *65; *66; *67; *68; *69; *70; |
| | *71; *72; *73; *74; *75; *76; *77; *78; *79; *80; *81; *82; *83; *84; *85; *86; *87; |
| | *88; *89; *90; *91; *92; *93*94; *95; *96; *97; *98; *99; *100; *101; *102; *103; |
| | 104; *105; *106; *107; *108; *109; *110; *111; *112; *113; *114; *115; *116; |
| | *117; *118; *119; *120 |
| CYP26A1 | *1; *2; *3; *4 |

P450 oxidoreductase (POR)

| | |
|---|---|
| POR | *1; *2; *3; *4; *5; *6; *7; *8; *9; *10; *11; *12; *13; *14; *15; *16; *17; *18; *19; *20; *21*22; |
| | *23; |
| | *24; *25; *26; *27; *28; *29; *30; *31; *32; *33; *34; *35; *36; *37; *38; *39; *40; *41; *42; |
| | *43; |
| | *44; *45; *46; *47; *48; |

Phase II Drug Metabolizing Enzymes (DMEs)

| | |
|---|---|
| DPYD | *1; *2A; *3; *4; *5; *6; *7; *8; *9A; *9B; *10; *11; *12; *13 |
| GSTA1 | *1A; *1B; |
| GSTA2 | *2A; *2B; *2C; 2E; |
| GTM1 | *1A; *1B; *10; *1AX2; |
| GTM3 | *3A; *3B; |
| GTM4 | *4A; *4B; |
| GTP1 | *1A; *1B; *1C; *1D; |
| GTT1 | *1A; *1B; 1*0; |
| GTT2 | *1A; *1B; |
| GTZ1 | *1A; *1B*1C; *1D; *1E; *1F; *2A; *2B; |
| NAT1 | *5; *11A; *11B; *11C; *14; *15; *16; *17; *19; *22; also rs4986989; rs5030809; |
| | rs4986782; rs1801280 |
| NAT2 | *4; *5; *5A; *5B; *5C; *5D; *5E; *5F; *5G; *5H; *5I; *5J; *5K; *5L; *5M; |
| | *5N; *5O; *6; *6A; *6B; *7; *7A; *7B; *12A; *13A; *14A; *14C; *14D; |
| | Also: rs1799929; rs1799930; rs1799931; rs4646244; rs46462 |
| PON1 | rs662; rs854547; rs854548; rs854555; rs854560; |
| PON2 | rs6954345; rs13306702; rs987539; rs11982486; rs4729189; |
| | rs11981433; rs17876205; rs17876183; |
| TPMT | *1; *2; *3; *3A; *3B; *3D; *3E; *4; *5; *6; *7; *8; *9; *10; *11; *12; *13; *14; *15*16; *17; *18; |
| | *19*; *20; *21; *22; *23; *24; *25 |
| TYMS | rs2847153; rs2853539; rs34489327; rs34743033; rs45445694 |
| SULT | SULT1A1; SULT1A2; SULT1A3; SULT1B1; SULT1C1; SULT1C2; SULT1C3; SULT1E1; |
| | SULT2A1; SULT2B1; SULT2B1B; SULT4A1; SULT6B1 |
| UGT1A1 | *1; *2; *3; *4; *5; *6; *7; *8; *9; *10; *11; *12; *13; *14; *15; *16; *17; *18; *19; |
| | *20; *21; *22; *23; |
| | *24; *25; *26; *27; *28; *29; *30; *31; *32; *33; *34; *35; *36; *37; *38; *39; *40; *41; *42; |
| | *43; |
| | *44; *45; *46; *47; *48; *49; *50; *51; *52; *53; *54; *55; *56; *57; *58; *59; *60; *61; *62; |
| | *63; |
| | *64; *65; *66; *67; *68; *69; *70; *71; *72; *73; *74; *75; *76; *77; *78; *79; *80; *81; *82; |
| | *83; |
| | *84; *85; *86; *87; *88; *89; *90; *91; *92; *93; *94; *95; *96; *97; |
| | *98; *99; *100; *101; *102; |
| | *103; *104; *105; *106; *107; *108; *109; *110; *111; *112; *113; |
| UGT1A3 | *1A; *1B; *1C; *1D; *1E; *1F; *2A; *2B; *2C; *2D; *2E; *3A; *3B; *4A; *5A; *6A; *7A; *8A; |
| | *9A; *10A; *10B; *11A |
| UGT1A4 | *1A; *1B; *1C; *1D; *1E; *1F; *1G; *1H; *1I; *2; *3A; *3B; *4; *5; *6; *7; *8 |
| UGT1A5 | *1; *2; *3; *4; *5; *6; *7 |
| UGT1A6 | *1A; *1B; *1C; *1D; *1E; *1F; *1G; *2A; *2C; *2D; *2E; *3A; *3B; *4A; *4B; *4C; *5; |
| | *6; *7; *8; *9 |
| UGT1A7 | *1A; *1B; *2; *3; *4; *5; *6; *7; *8; *9; *10; *11; *12; *13; *14 |
| UGT1A8 | *1A; *1B; *2; *3; |
| UGT1A9 | *1A; *1B*1C; *1D; *1E; *1F*1G; *1H; *1J; *1K; *1L; *1M*1N; *1P; *1Q; *1R; *1S; *1T; *1U; |
| | *1V; |
| | *1W; *1X; *2; *3A; *3B; *4; *5; |
| UGT1A10 | *1A; *1B; *1C; *1D; *2A; *3A; *3B; *4A; *4B; *4C; *5; *6; *7; |
| UGT2B4 | *1A; *1B*1C; *1D; *1E; *1F*1G; *1H; *1J; *1K; *1L; *1M*1N; *1P; *1Q; *1R; *1S; *1T; |
| | *2A; *2B; *3; *4; *5; *6; |
| UGT2B7 | *1A; *1B*1C; *1D; *1E; *1F*1G; *1H; *1J; *1K; *2A; *2B; *2C; *2D; *2E; *2F; *2G; *3; *4; |
| UGT2B10 | *1; *2; |
| UGT2B15 | *1; *2; *3; *4; *5; *6; *7; |
| UGT2B17 | *1; *2; |
| UGT2B28 | *1; *2; *3; |

Drug Transporter Proteins (DTPs) - (DTPs with demonstrable ADME or DMET effects were tested¹)

| | |
|---|---|
| ABCB1 | rs1002205; rs10248420; rs10276036; rs10280101; rs1045642; rs112850; |
| | rs1128503; rs11983225; rs1202184; rs1202186; rs12720067; rs17327442; |
| | rs2032582; rs2032583; rs2091766; rs2214102; rs2229107; rs2229109; rs223501; |
| | rs2235035; rs2235040; rs2235046; rs2235067; rs28364274; rs28373093; |
| | rs3213619; rs35023033; rs35730308; rs35810889; rs3789243; rs3842; rs4148739; |
| | rs4148740; rs72552784; rs7787082; rs9282564; |
| ABCA1 | rs207470459; rs202195655; rs201905765; rs201893501; rs20189265; |
| | rs202180259; rs202161597; rs202141617; rs202138068; rs202097159; |
| | rs202087810; rs202067417; rs202059465; rs202051679; rs201992557; |
| | rs201989320; rs201983749; rs201966762; rs201952658; rs202161597 |
| | rs202141617; rs202138068; rs202087810; rs202067417; rs202059465 |
| | rs202051679; rs201992557; rs201989320; rs201983749; rs201966762 |
| | rs201952658; rs201885403; rs201879964; rs201879057; rs201876980 |
| | rs201873960; rs201857140; rs202097159; rs201834866; rs201796412; |
| | rs201783755; rs201746450; rs201728177; rs201711958; rs201705347; |
| | rs201696650; rs201677131; rs201677057; rs201670638; rs201665886; |
| | rs201642049; rs201599169; rs201586430; rs201577783; rs201555773; |
| | rs201483791; rs201469136; rs201464281; rs201451718; rs201447364 |
| | rs201834866; rs201796412; rs201783755; rs201746450; rs201728177 |
| | rs201711958; rs201705347; rs201696650; rs201677131; rs201677057; |
| | rs201670638; rs201665886; rs201642049; rs201599169; rs20; 1586430; |
| | rs201577783; rs201555773; rs201483791; rs201469136; rs201464281; |
| ABCA4 | rs28938473; rs2070739; rs3803183; rs987525; rs3737548; rs2276455 |
| | rs13041247; rs560426; rs10863790; rs3112831; rs121909203; rs121909204; |
| | rs121909205; rs121909206; rs121909207; rs1800553; rs1800555; rs1801581; |
| | rs41292677; rs58331765; rs61748548; rs61748559; rs61749438; rs61750061; |
| | rs61750126; rs61750130; rs61750200; rs61751374; rs61751383; rs61751408; |
| | rs61753033; rs61753034; rs17110736; rs76157638; rs61751392; |
| ABCB5 | rs147879229; rs144572651; rs80123476; rs80059838; rs78309031; rs77409024; |
| | rs76179099; rs74552040; rs62453384; rs61741891; rs61732039; rs60197951; |
| | rs59334881; rs58976125; rs58795451; rs35885925; rs34603556; rs17143304; |
| | rs13222448; rs6461515; rs2301641; rs2074000; |
| ABCB6 | rs267599212; rs202234479; rs202232534; s202202894; rs202127374; |
| | rs202044523; |
| | rs202011349; rs201934550; rs201931275; rs201876128; rs201869586; |
| | rs201713868; rs201624397; |
| ABCB8 | rs72559734; rs72559733; rs72559732; rs10400391; rs72559731; |
| | rs60637558; rs1048098; rs1048096; rs1048094; rs1048093; rs72559729; |
| | rs45522932; rs59852838; rs72559728; rs112488640; rs72559727; rs72559726; |
| | rs199732808; rs111228378; rs72559722; rs111967655; rs72559721; rs72559720; |
| | rs67706538rs72559719; rs1799860; rs56945577; rs1048091; rs56924677; |
| | rs111603608; rs1129799; rs67767715; rs75218493; rs72559718; rs72559717; |
| | rs72559716; rs72559715; rs72559714; rs80075294; rs72559713; rs17846721; |
| ABCB11 | rs11568372; rs780094; rs1799884; rs560887; rs2287622; rs563694; rs10830963 |
| | rs31653; rs1387153; ABCB11_(HCV1010680) snp; ABCB11_(HCV27859364) snp; |
| | rs552976; rs121908935; rs11568372; rs780094; rs1799884; rs560887; rs2287622 |
| | rs563694; rs10830963; rs31653; rs1387153; ABCB11_(HCV1010680) snp; |
| | ABCB11_(HCV27859364) noncore snp; rs552976; rs121908935; rs72549397 |
| | rs72549401; rs569805; rs16856332; rs16856247; |
| ABCC1 | rs1045642; rs2032582; rs212090; ABCC1_(HCV34257260) noncore in-del; |
| | ABCC1_(R433S) noncore snp; rs4148330; rs4148382; rs212093; rs35621; |
| | rs3784862; rs246240; rs2238476; rs35592; rs28364006; rs119774; rs504348; |
| | rs4781699; rs45511401; rs4148356; rs35529209; rs3765129; rs35605; rs72653744; |
| | rs3743527; rs246221; rs8; 058696; rs72664226; |
| ABCC2 | rs17222723; rs2273697;; rs2804402; rs3740065; rs3740066; rs56199535; rs717620 |
| | rs72558200; rs72558201; rs72558202; rs8187710; rs927344; |
| ABCC3 | rs146920162; rs143491192; rs137911252; rs4793665; rs4148416; |
| ABCC4 | rs11568658; rs11568668; rs1729786; rs1751034; rs1926657; rs3765534; |
| | rs4148441; rs4148546; rs9561778; |
| ABCC5 | ABCC5_(HCV32501489) in-del; rs7636910; rs1053386; rs939336; rs1053351; |
| | rs3749442; rs1053387; rs562; rs3805114; |
| ABCC6 | rs8058696; rs8058694; rs4341770; rs7500834; rs6416668; rs2856585; rs2238472; |
| ABCC8 | rs193929369; rs193929366; rs193929364; rs193929360; rs193922407; |
| | rs193922405; rs193922402; rs193922401; rs193922400; rs137852676; |
| | rs113873225; rs80356653; rs80356651; rs80356642; rs80356640; rs80356637; |
| | rs80356634; rs2299641; rs2283257; rs2237984; rs2237981; rs2074312; rs1800853; |
| | rs1799854; rs1048095; rs916829; rs757110; rs722341; |
| ABCC9 | rs11046205; rs11046232; rs121909304; rs193922683; rs2900492; rs2955503; |
| | rs4148649; rs4762865; |
| ABCC10 | rs9349256; rs2125739; |
| ABCC11 | rs149334541; rs144420816; rs17822931; rs8047091; rs7203695; |
| ABCC12 | rs144810262; rs16945874; rs16945869; |
| ABCG1 | rs425215; rs2306283; ABCG1_rs1541290; snp; rs1541290; ABCG1_rs1044317; |
| | rs1044317; rs2234714; rs2234715; rs57137919; rs1044317; rs4148102; |
| ALDH2 | rs141629803; rs16941667; rs11613351; rs7296651; rs4648328; rs4646778; |
| | rs4646777; rs2238152; rs2238151; rs968529; rs886205; rs671; rs441; rs440; |
| SLC01A2 | *1; *2; *3; *4; *5; *6; *7; *8; *9A; *9B; *10; *11; |
| SLCO1B1 | *1A; *1B; *1C; *2; *3; *4; *5; *6; *7; *8; *9A; *9B; *10; *11; *12; *13; *14; *15; *16; *17; |
| | *18; *19; *20; *21; *22; *23; *24; *25; *26; *27; *28; *29; *30; *31; *32; *33; *34; *35; *36; |
| | Also: rs11045819; rs11045879; rs2306283; rs4149015; rs4149032; rs4149056; |
| | rs4149081; rs4363657; |
| SLCO1B3 | rs1045642; rs2032582; rs5219; rs4149056; rs11045585; rs1128503; rs2306283; |
| | SLCO1B3rs4149117; SLCO1B3rs7311358; SLCO1B3 SLCO1B_(hCV33090560) in- |
| | del; SLCO1B3SLCO1B3_(hCV33090599) in-del; rs887829; rs2117032; rs290487; |
| | rs766420; rs11045879; rs11045819; rs17680137; rs4149117; rs7311358; |
| | rs2417940; rs8175347; |
| SLCO1C1 | rs36010656; rs10770705; rs3794271; |
| SLCO2B1 | rs12422149; rs2306168; rs2306168; rs4149117; |
| SLCO3A1 | rs3924426; rs7495052; rs3743369; rs207954; |
| SLCO4A1 | rs872626 |
| SLCO5A1 | rs16936455; rs10504461; rs10504460; |
| SLCO6A1 | rs151287898; rs150046652; rs140549680; |
| SLC6A2 | rs17306977; rs13333066; rs11568324; rs10521329; rs8049681; rs3785157; |
| | rs3785155; rs3785152; rs3785151; rs3785143; rs2397771; rs2279805; rs2270935; |
| | rs2242447; rs2242446; rs1861647; rs1814269; rs1805065; rs1800887; rs1532701 |
| | rs1362621; rs998424; rs192303; rs187715; rs187714; rs168924; rs47958; rs42460 |
| | rs40434; rs40147; rs36030; rs36029; rs36024; rs36021; rs36020; rs36017; rs36009 |
| | rs15534; rs5569; rs5568; rs5566; rs5564; rs5563; rs5558 |
| SLC6A3 | rs23877306; rs28364998; rs2836499; rs28363170; rs13189021; rs11564773; |
| | rs11564752; rs11133767; rs8179029; rs6876225; rs6869645; rs3863145; |
| | rs3836790; rs3776513; rs3776512; rs2975226; rs2975223; rs2963238; rs2937639; |
| | rs2652511; rs2617605; rs2617604; rs2550936; rs2455391; rs2270912; rs2042449; |
| | rs1042098; rs464049; rs463379; rs460700; rs460000; rs429699; rs403636; |
| | rs393795; rs250682; rs250681; rs40358; rs40184; rs37022; rs37020; rs27072; |
| | rs27048; rs6350; rs6347; |
| SLC6A4 | rs147867056; rs146909785; rs142592345; rs56355214; rs41274284; rs41274280; |
| | rs28914834; rs28914833; rs28914832; rs28914831; rs28914830; rs28914829; |
| | rs28914828; rs28914827; rs28914826; rs28914825; rs28914824; rs28914823; |
| | rs28914822; rs16965628; rs13306796; rs12150214; rs11080122; rs11080121; |
| | rs8076005; rs8071667; rs7224199; rs7212502; rs4795541; rs4583306; rs4325622; |
| | rs4251417; rs3813034; rs3794808; rs3783594; rs2066713; rs2020942; rs2020939; |
| | rs2020936; rs2020935; rs2020934; rs2020933; rs2020932; rs1042173; rs140701; |
| | rs140700; rs25533; rs25532; rs25531; rs25528; rs6355; rs6354; rs6352; |
| SLC10A1 | rs2296651; rs4646285; |
| SLC13A1 | rs1880179; rs2204295; rs10281158; rs2140516; rs45621838; rs6466854; |
| | rs6962039; |
| SLC15A1 | rs45628337; rs45513193; rs45562741; rs8187823; rs45569639; rs2297322; |
| | rs8187821; rs8187836; rs4646227; rs1339067; rs2274828; rs8187838; |
| | rs2274827rs45545032; rs8187832; rs8187830; |
| SLC15A2 | rs1143669; rs1920305; rs2293616; rs2257212; rs1143670; rs1143671; |
| | rs1143672rs1920314; rs1920313; rs4388019; |
| SLC16A1 | rs12727968; rs12090418; rs1049434; rs11585690; rs7169; rs11811205; rs9429505 |
| SLC19A1 | rs1051266; rs1051298; rs1131596; rs12482346; rs1888530; rs2838958; rs3788200; |
| | rs3788205; |
| SLC22A1 | rs622342; rs2282143; rs628031; SLC22A1_rs35191146_in-del; rs662138; |
| | SLC22A1_(hCV34211645) snp; rs12208357; rs2292334; rs2048327; rs1810126 |
| | rs3088442; rs34059508; rs316019; rs651164; rs36103319; rs34130495 |
| | rs2282143; rs35191146; rs34305973; rs35167514; rs34104736; rs1564348; |
| SLC22A2 | rs8177516; SLC22A2_>(134insA) in-del; rs45592541; rs2048327; rs2289669; |
| | rs316019; rs3127573; rs2279463; rs8177516; rs8177517; |
| SLC22A3 | rs1810126; rs2048327; rs2292334; rs2504916; rs3088442; rs402219; rs7758229; |
| | rs9364554; |
| SLC22A4 | rs10479002; rs1050152; rs11568500; rs11568503; rs11568506; rs11568510; |
| | rs12777; rs2073838; rs272879; rs272889; rs272893; rs3792876; |
| SLC22A5 | rs11568513; rs11568520; rs121908886; rs121908887; rs121908888; rs121908889; |
| | rs121908890; rs121908891; rs121908892; rs121908893; rs17622208; rs2073643; |
| | rs2631367; rs28939705; rs68018207; rs72552727; rs72552735; |
| SLC22A6 | rs11568626; SLC22A6_(HCV33001840) in-del; rs11568634; |
| SLC22A7 | rs2651185; rs36040909; |
| SLC22A8 | rs45512894; rs45566039; rs11568482; rs45566039; rs11568496; rs11568493; |
| | rs11568492; rs10792367; rs11231299 |
| SLC22A9 | rs7101446 |
| SLC22A10 | rs515213 |
| SLC22A11 | rs17300741; rs3782099; rs3759053; rs2078267; rs1783811 |
| SLC22A12 | rs12800450; rs11602903; rs11231825; rs7932775; rs1529909; rs893006; rs505802; |
| | rs476037; |
| SLC22A16 | rs6938431 |
| SLC22A18 | rs6176332; rs16928809; rs1048047; rs1048046; rs367035; |
| TAP1 | rs1057141; rs17422866; rs1135216; rs121917702; rs1351383; rs2071480; |
| TAP2 | rs104893997; rs111033561; rs111033562; rs1800454; rs241447; rs241448; |
| | rs241453; |

¹Only genes and SNPs, CNVs and structural variants (e.g., indels) that had at least 1 peer-reviewed article in PubMed on pharmacogenomic impact were included in this analysis.

TABLE 4
Testing using CRT-MCA shows significant differences in the
frequencies of ADME variants among 4 different U.S.
ethnic populations.

| | Population Cluster Patterns |
|---|---|
| ADME Gene | Significant P-values after transformation |
| | Caucasian (white) versus other populations |
| ABCB1 | 0.0001 |
| ABCA1 | 0.008 |
| ABCB5 | 0.035 |
| ABCB6 | 0.028 |
| ABCC5 | 0.006 |
| ABCC6 | 0.031 |
| ABCC8 | 0.004 |
| ABCC9 | 0.032 |
| ABCC10 | 0.001 |
| ABCC11 | 0.002 |
| ABCC12 | 0.001 |
| ABCG1 | 0.041 |
| CYP1A1 | 0.005 |
| CYP1A2 | 0.0001 |
| CYP1B1 | 0.011 |
| CYP2A6 | 0.002 |
| CYP2A13 | 0.049 |
| CYP2B6 | 0.018 |
| CYP2C8 | 0.0001 |
| CYP2C9 | 0.0001 |
| CYP2C19 | 0.0001 |
| CYP2D6 | 0.0001 |
| CYP2E1 | 0.005 |
| CYP2F1 | 0.04 |
| CYP2J2 | 0.002 |
| YP2R1 | 0.032 |
| CYP2S1 | 0.005 |
| CYP2W1 | 0.0042 |
| CYP3A4 | 0.0001 |
| CYP3A7 | 0.003 |
| CYP4A11 | 0.007 |
| CYP4A22 | 0.006 |
| CYP4B1 | 0.042 |
| CYP4F2 | 0.039 |
| CYP5A1 | 0.002 |
| CYP8A1 | 0.04 |
| CYP19A1 | 0.034 |
| CYP21A2 | 0.0001 |
| CYP26A1 | 0.003 |
| DPYD | 0.03 |
| GSTA1 | 0.001 |
| GSTA2 | 0.0005 |
| GTM1 | 0.0001 |
| GTM3 | 0.01 |
| GTM4 | 0.022 |
| GTP1 | 0.04 |
| GTT2 | 0.001 |
| GTZ1 | 0.05 |
| NAT1 | 0.041 |
| NAT2 | 0.0001 |
| POR | 0.02 |
| SLCO1B1 | 0.0001 |
| SLCO1B2 | 0.01 |
| SLCO2B1 | 0.004 |
| SLCO3A1 | 0.042 |
| SLCO4A1 | 0.027 |
| SLCO5A1 | 0.001 |
| SLCO6A1 | 0.018 |
| SLC6A2 | 0.0001 |
| SLC6A3 | 0.0031 |
| SLC6A4 | 0.019 |
| SLC10A1 | 0.02 |
| SLC13A1 | 0.03 |
| SLC15A1 | 0.045 |
| SLC15A2 | 0.003 |
| SLC22A2 | 0.004 |
| SLC22A8 | 0.008 |
| SLC22A9 | 0.026 |
| SLC22A10 | 0.023 |
| SLC22A18 | 0.012 |
| SULT1A1 | 0.0001 |
| TPMT | 0.011 |
| TYMS | 0.024 |
| TAP2 | 0.01 |
| UGT1A1 | 0.0002 |
| UGT1A3 | 0.001 |
| UGT1A6 | 0.0024 |
| UGT1A9 | 0.001 |
| UGT2B4 | 0.04 |
| UGT2B7 | 0.009 |
| UGT2B10 | 0.02 |
| UGT2B15 | 0.0042 |
| UGT2B17 | 0.04 |
| UGT2B28 | 0.05 |
| | Caucasian (Hispanic) versus other populations |
| ABCB1 | 0.0001 |
| CCP2C8 | 0.0001 |
| CYP2C9 | 0.0001 |
| CYP2C19 | 0.0001 |
| CYP2D6 | 0.0001 |
| CYP3A4 | 0.005 |
| NAT2 | 0.0001 |
| SLCO1B1 | 0.0001 |
| SLC6A4 | 0.0001 |
| TPMT | 0.0001 |
| | African-Americans versus other populations |
| ABCA1 | 0.021 |
| ABCA4 | 0.042 |
| ABCB1 | 0.0001 |
| ABCB11 | 0.024 |
| ABCC1 | 0.005 |
| ABCC2 | 0.046 |
| ABCC3 | 0.005 |
| ABCC4 | 0.020 |
| ABCC6 | 0.031 |
| ABCC8 | 0.037 |
| ABCC10 | 0.003 |
| ABCC11 | 0.001 |
| ABCC12 | 0.001 |
| ALDH2 | 0.005 |
| CYP1A1 | 0.005 |
| CYP1A2 | 0.0001 |
| CYP1B1 | 0.041 |
| CYP2A6 | 0.020 |
| CYP2B6 | 0.0001 |
| CYP2C8 | 0.0001 |
| CYP2C9 | 0.0001 |
| CYP2C19 | 0.0001 |
| CYP2D6 | 0.0001 |
| CYP2E1 | 0.004 |
| CYP2F1 | 0.012 |
| CYP2J2 | 0.01 |
| YP2R1 | 0.02 |
| CYP2S1 | 0.001 |
| CYP2W1 | 0.002 |
| CYP3A4 | 0.0001 |
| CYP3A5 | 0.004 |
| CYP3A43 | 0.006 |
| CYP3A7 | 0.001 |
| CYP4A11 | 0.002 |
| CYP4A22 | 0.031 |
| CYP4B1 | 0.03 |
| CYP4F2 | 0.001 |
| CYP5A1 | 0.03 |
| CYP8A1 | 0.047 |
| CYP19A1 | 0.43 |
| CYP21A2 | 0.027 |
| CYP26A1 | 0.004 |
| DPYD | 0.011 |
| GSTA1 | 0.045 |
| GSTA2 | 0.045 |
| GSTM1 | 0.002 |
| GSTM2 | 0.032 |
| GSTM3 | 0.016 |
| GSTM4 | 0.013 |
| GSTZ1 | 0.008 |
| NAT1 | 0.005 |
| NAT2 | 0.0001 |
| PON1 | 0.013 |
| PON2 | 0.005 |
| SLCO1B1 | 0.0001 |
| SLCO1B3 | 0.001 |
| SLCO1C1 | 0.013 |
| SLCO2B1 | 0.028 |
| SLC01A2 | 0.048 |
| SLC13A1 | 0.006 |
| SLCO4A1 | 0.01 |
| SLCO5A1 | 0.01 |
| SLCO6A1 | 0.005 |
| SLC6A2 | 0.0005 |
| SLC6A3 | 0.0001 |
| SLC6A4 | 0.00001 |
| SLC10A1 | 0.003 |
| SLC13A1 | 0.004 |
| SLC15A1 | 0.005 |
| SLC15A2 | 0.006 |
| SLC16A1 | 0.007 |
| SLC19A1 | 0.002 |
| SLC22A1 | 0.045 |
| SLC22A2 | 0.003 |
| SLC22A3 | 0.031 |
| SLC22A4 | 0.002 |
| SLC22A5 | 0.027 |
| SLC22A6 | 0.013 |
| SLC22A7 | 0.001 |
| SLC22A8 | 0.044 |
| SLC22A9 | 0.004 |
| SLC22A10 | 0.025 |
| SLC22A11 | 0.001 |
| SLC22A12 | 0.011 |
| SLC22A16 | 0.008 |
| SLC22A18 | 0.038 |
| SULT1A1 | 0.0001 |
| SULT1A2 | 0.041 |
| SULT1A3 | 0.028 |
| SULT1B1 | 0.004 |
| SULT1C1 | 0.002 |
| SULT1C2 | 0.01 |
| SULT1C3 | 0.024 |
| SULT1E1 | 0.005 |
| SULT2A1 | 0.033 |
| SULT2B1 | 0.029 |
| SULT2B1B | 0.009 |
| SULT4A1 | 0.05 |
| SULT6B1 | 0.044 |
| TAP1 | 0.009 |
| TAP2 | 0.047 |
| TPMT | 0.0001 |
| TYMS | 0.0004 |
| UGT1A1 | 0.005 |
| UGT1A3 | 0.024 |
| UGT1A4 | 0.02 |
| UGT1A5 | 0.002 |
| UGT1A6 | 0.007 |
| UGT1A7 | 0.002 |
| UGT1A8 | 0.018 |
| UGT1A9 | 0.024 |
| UGT1A10 | 0.01 |
| UGT2B4 | 0.021 |
| UGT2B7 | 0.016 |
| UGT2B10 | 0.019 |
| UGT2B15 | 0.028 |
| UGT2B17 | 0.008 |
| UGT2B28 | 0.005 |
| | Asian-Americans versus other populations |
| ABCB1 | 0.0001 |
| ABCC5 | 0.001 |
| ABCC6 | 0.014 |
| CYP1A2 | 0.0001 |
| CYP2B6 | 0.018 |
| CYP2C8 | 0.0001 |
| CYP2C9 | 0.0001 |
| CYP2C19 | 0.0001 |
| CYP2D6 | 0.0001 |
| CYP3A4 | 0.005 |
| CYP2E1 | 0.025 |
| CYP3A4 | 0.0001 |
| DPYD | 0.001 |
| GSTM1 | 0.011 |
| GSTM2 | 0.012 |
| NAT2 | 0.0001 |
| PON1 | 0.009 |
| PON2 | 0.013 |
| POR | 0.012 |
| SLCO1B1 | 0.0001 |
| SLCO1B2 | 0.02 |
| SLCO1B3 | 0.047 |
| SLC6A2 | 0.002 |
| SLC6A3 | 0.005 |
| SLC6A4 | 0.0001 |
| SLC22A1 | 0.008 |
| SLC22A7 | 0.017 |
| SLC22A16 | 0.0045 |
| SULT1A1 | 0.0001 |
| SULT1A3 | 0.013 |
| SULT1A9 | 0.023 |
| SULT1C2 | 0.0001 |
| SULT2A1 | 0.008 |
| SULT2B1 | 0.032 |
| SULT4A1 | 0.02 |
| TPMT | 0.0001 |
| TYMS | 0.041 |
| UGT2B4 | 0.005 |
| UGT2B10 | 0.048 |
| UGT2B15 | 0.012 |

### Pharmacogenomic Population Structure in a Set of Clinical Trial Participants

Graphing the distribution of genotyped patients for CYP2D6 metabolizer status after use of the antitussive dextromethorphan (DMP) from a large sample of Caucasian (white) patients (N=1,246) that participated in a clinical trial at a large hospital system showed multiple peaks (FIG. 1B). Dextromethorphan O-demethylation has become a commonly used enzyme probe for studying CYP2D6 polymorphisms. The DMP test has an advantage over the standard debrisoquine probe assay in that it is a widely used over-the-counter drug with a faster and simpler urinary assay procedure. The metabolic ratio (MR) for DMP is calculated as the ratio of DMP to dextrorphan (DOP) metabolite recovered in urine 8 h after a 30-mg dose of oral DMP (FIG. 1B-A). The antimode used as a cutoff for PM using DMP as an enzyme probe is MR=0.3 (77% metabolized). It was previously thought that a disadvantage of using DMP as a CYP2D6 test probe was that it could not reliably discriminate extensive metabolizer (EM) from intermediate (IM) and ultra-rapid (UM) phenotypes. However, more recent research has shown that all CY2D6 metabolizer phenotypes can be accurately determined from the urinary metabolome using more sensitive assay methods. Following urine collection, each participant was genotyped as to CYP2D6 genotype status. FIG. 1B-A shows the results of the study, revealing a skewed distribution not consistent with a normal distribution, a subset of Gaussian graphing.

Subsequent analysis of a number of random participants demonstrated that the CY2D6 genotypes of the participants in this trial showed a significant correlation with metabolizer phenotype. Analysis of the urinary metabolite dextrorphan was able to accurately bin at least two different CYP2D6 metabolizer sub-types.as discriminated by at least two of the four different peaks indicated by number as: \textcircled{1} Ultra-rapid metabolizer (p-value of <0.02); \textcircled{2} potential intermediate metabolizer (p-value=0.09); \textcircled{3} potential extensive metabolizer (p-value=0.10), and \textcircled{4} Poor metabolizer (p-value of <0.01).

To determine whether this sample of genotyped patients exhibited a distribution reflecting underlying population structure; we performed an eigenanalysis of the sample. The results in FIG. 1B-B showed discrete subpopulations when Principal Component Analysis (PCA) was combined with modern statistical methods of cluster analysis that provide a sensitive approach for the detection of underlying structure in genetic subpopulations. Applying eigenanalysis to our data using PCA and Cluster analysis reveals very distinct metabolizer sub-populations that are clustered with some evidence of dine suggestive of genetically-distinct groups with some admixture, when plotted using eigenvectors. In FIG. 1B-B, the first two eigenvectors are plotted. Although population separation by CYP2D6 variant frequency is clear, the natural separation axes are not the eigenvectors that correspond to ethnicity. Populations A and D correspond to ultra-rapid and poor metabolizers. Importantly, Populations B and C show some evidence of dine, rather than two discrete clusters grouped around a central point.

These results provide evidence of partial genetic admixture, such as that involving a population in popB that is related to popC, and there is excellent agreement between the supervised and unsupervised analyses. In an admixed population, the expected allele frequency of an individual is a linear mix of the frequencies in the ancestry populations (this is true unless the subpopulation is very ancient, in which case the PCA methods will fail as everyone will have the same ancestry proportion). The mixing weights will vary by individual. Because of the linearity, admixture does not change the axes of variation, or, more exactly, the number of “large” eigenvalues of the covariance is unchanged by adding admixed individuals. Thus, this is proof that recent admixture does not abolish preservation of ancestral gene variants. From the eigenvalues, the determination is that popB and popC have allele frequencies that are clinal in nature, with an ANOVA p-value of <10⁻¹².

The eigenanalysis was used to further evaluate the results in FIG. 1B, to determine whether the complex distribution that was observed was due to underlying genetic population stratification based on structural heterogeneity. The assumption was made was that the observed pharmacogenomic markers were bi-allelic, for example, bi-allelic SNPs. One can consider the data in the contest of a large rectangular matrix C, with rows indexed by individuals, and columns indexed by polymorphic markers. For each marker choose a reference and variant allele. The supposition is that there are n such markers and m individuals. Let C (i,j) be the number of variant alleles for marker j, individual i. In this case, we assume there are no missing data.

From each column the means are subtracted. So the set for column j:

$$μ ( j ) = \frac{{\sum }_{i = 1}^{m} C ( i , j )}{m}$$

and then corrected entities are:

C(i,j)−μ(j)

When p (j)=μ(j)/2 is set, an estimate of the underlying frequency can be made. Then each entry in the resulting matrix approximates:

$$M ( i , j ) = \frac{C ( i , j ) - μ ( j )}{\sqrt{p ( j ) ( 1 - p ( j ) )}}$$

This last equation is a based on the assumption that frequency change of a genomic polymorphism is due to genetic drift, and occurs at a rate proportional to:

{square root over (p(j)(1−p(j)))}

Exploiting the processing power of distributed GPUs, the processing time for the 1,246 participants assuming four pharmacogenomic markers took 372 msecs, based on the time as recorded by the computer.

The use of PCA in this context provided a first determination of underlying population structure. To better understand if there is additional detail that can be recovered from population structure, we used the following approach—If our matrix X has the eigenvalues consisting of λ1, λ2, λ3, λ4, . . . λₖ, λₖ₊₁, . . . λm′, and the top k eigenvalues have been declared to be significant, then a test is made of λ₊₁, . . . λm′ as though X was a (m′−k) X (m′−k) Wishart matrix.

Applying cluster analysis and PCA, if the allele frequency of the variant in the ancestor population is P, and in population I is pᵢ; Conditional on P, assume that p=(p₁, p₂, . . . pₖ has mean (P, P, . . . P) and the covariance matrix P(1−P)B for some matrix B. This is a standard approach used in population genetics, with variations on the distribution of B, and on the detailed distribution of p conditional on P. In this context, sampling from K populations, assuming there are Mᵢ samples from population I, and set,

$$M = {\sum }_{i = 1}^{m} M i$$

The supposition is that the divergence of each population from a root population, as measured by F_{ST} (also referred to here as θ) is of order s, which is small. To determine the eigenvalues of the theoretical covariance C of the samples for the marker after our mean adjustment and normalization, M is considered large, while the relative abundance of the samples stays constant across populations. Then if B has full rank, then C has K−1 large eigenvalues that that tend to infinity with M, M−K eigenvalues are 1+0 (τ), and one zero eigenvalue that is a structural zero, based on the assumption that our mean adjusted columns all have zero sum. Then the case that τ is much less than 1 while M is much greater than 1. In this case, natural models of population structure predict that most of the eigenvalues of the theoretical covariance will be “small,” nearly equal, and arise from sampling noise, while just a few eigenvalues will be “large,” reflecting past demographic events. It is therefore expected that the theoretical covariance matrix (approximated by the sample covariance) will have K−1 “large” eigenvalues, with the remainder small and reflecting the sampling variance. The eigenvectors of the theoretical covariance, corresponding to the large eigenvalues, are termed “axes of variation.” These are a theoretical construct, as only observation is made of the sample covariance. However, for eigenvectors that are highly significant by testing, the corresponding eigenvector are expected to correlate well with the true “axis of variation.”

The application of PCA to genomic data—and this approach for analyzing the data—provides a natural method of uncovering population structure. In most applications of PCA, the multivariate data has an unknown covariance, and PCA is attempting to choose a subspace on which to project the data that captures most of the relevant information. In many such applications, a formal test for whether the true covariance is the identity matrix makes little sense. For statistical analysis, for example in a clinical trial of experimental versus controls, the best strategy is to use the ANOVA F-statistic (also known as F_{ST} or θ).

In an admixed population, the expected allele frequency of an individual is a linear mix of the frequencies in the parental populations. Unless the subpopulation is very ancient—in which case the PCA methods will fail as everyone will have the same ancestry proportion—then the mixing weights will vary by individual. Because of the linearity, admixture does not change the axes of variation, or, more exactly, the number of “large” eigenvalues of the covariance is unchanged by adding admixed individuals, From the eigenvalues shown in FIG. 1B-B, the determination is that popB and popC have allele frequencies that are clinal in nature, with an ANOVA p-value of <10⁻¹².

### Training Set for the Pharmacogenomic Classifier

For the training set, applications in population structure that were able to differentiate clusters of populations in the dataset of 17,131 whole genome sequences were utilized. As discussed below, the clusters were primarily compromised of ethnic differences in ADME variant and allele frequency, as reported by others (see, e.g., McGraw J and Waller D. Cytochrome P450 variations in different ethnic populations. Expert Opin. Drug Metab. Toxicol. 2012; 8(3):371-382; The LK and Bertilsson L. Pharmacogenetics of CYP2D6: Inter-ethnic differences and clinical importance. Metab. Pharmacokinet. 2012; 27(1): 55-67). But these clusters were of much greater accuracy because of the size of the dataset. The training set was configured according to the results of the three independent tests (ASD, eigenanalysis, and StructHDP) that replicated the significant ADME variant population structure found in the massive dataset of 17,131 whole genome sequences (See FIG. 1F).

\textcircled{1} First set of ADME Population Clusters

| | |
|---|---|
| Total | 66% |
| Overall ADME variance based on cluster | ±3.8% |
| analysis | |
| Number of ADME population clusters | 34 distinct clusters |
| Percent composition by race | 93.4% white; 3% Hispanic; |
| | 1% African-American; 1.73% |
| | Asian-American; 0.27% other |
| Estimate Admixture | 2.84% |

\textcircled{2} Second set of ADME Population Clusters

| | |
|---|---|
| Total | 15% |
| Overall ADME variance based on cluster | ±3.3% |
| analysis | |
| Number of ADME population clusters | 9 distinct clusters |
| Percent composition by ethnicity | 92% Hispanic; 4% African- |
| | American; 2.9% White; |
| | 1.1% other |
| Estimate Admixture | 4.24% |

\textcircled{3} Third Set of ADME Population Clusters

| | |
|---|---|
| Total | 12% |
| Overall ADME variance based on cluster | ±0.4% |
| analysis | |
| Number of ADME population clusters | 4 distinct clusters |
| Percent composition by ethnicity | 94% African-American; 2.1% |
| | white; 3.8% Hispanic; |
| | 0.1% other |
| Estimate Admixture | 1.77% |

\textcircled{4} Fourth Set of ADME Population Clusters

| | |
|---|---|
| Total | 5% |
| Overall ADME variance based on cluster | ±0.5% |
| analysis | |
| Number of ADME population clusters | 7 distinct clusters |
| Percent composition by ethnicity | 99% Asian-American; 0.6% |
| | white; 0.4% other |
| Estimate Admixture | 0.05% |

The training was performed using LIBSVM (Chang C-C and Lin C-J. LIBSVM: A Library for Support Vector Machines. ACM Transactions on Intelligent Systems and Technology. 2011; 2(3)). First, the dataset was trained to obtain a model. And second, the model was used to predict the pharmacogenomic classification of a testing dataset. For SVC and SVR, LIBSVM can also output probability estimates.

The first step was to define the discrete populations of pharmacogenomic phenotype by instances and attributes for use by the learning machine. An example of a subset of the fifty-four discrete pharmacogenomic populations is shown in FIG. 1E. Note that only some of the ADME variant attributes could be included in the FIG. 1E, and since some of the populations had the same ADME variation in the attributes that are shown, they may seem identical. However, when the totality of ADME variation for each attribute-based instance (or population cluster) is examined, it represents a finite and discrete set. For purposes of cluster differentiation, highly significant differences between the populations were determined by ANOVA in R and ANOMA 300 (FIG. 1F).

It is possible to visualize the population clusters using different visualization methods and software applications. In this example, since all methods produced identical results, we chose to use allele-sharing distance (ASD), because it allows adjustment of X and Y axes, which was critical to show all of the population clusters in a single plot. The different population clusters are defined as to subtype, admixture and variance in 300, and displayed in the scatter plot 301 in FIG. 1F.

The entirety of population clusters derived from whole genome dataset 200 are shown in 300 and 301 in FIG. 1F. The different ADME clusters were largely separated by ethnic differences in ADME variant and allele frequency, as has been shown in a similar manner by others, but with much greater accuracy because of the size of the dataset. The contribution of the totality of significant ADME variant allele differences shown in Table 4 defined a fundamental co-variable that provided approximately 62% of the power of the classification system. However, during pre-processing of the training set of ‘surrogate phenotypes’, inclusion of only the those significant ADME variant differences that had p-values >0.01, as indicated in bold font in Table 4, defined 54 discrete clusters of pharmacogenomic strata based on the dataset of 17,131 whole genome sequences 200, accounting for 87% of the power of the classification system (FIG. 1F). Within each of the different population structures, it is possible to observe various distribution of ADME variation. Using differential back-propagation techniques used in ancestry analysis, this could be hypothetically extrapolated to 212 population clusters worldwide as defined by pharmacogenomic metabolizer phenotype (FIG. 2) using the methods described above as per techniques known in the art (see e.g., Haasl, R. J et al. Genetic ancestry inference using support vector machines, and the active emergence of a unique American population. European Journal of Human Genetics. 5 Dec. 2012. However, migration patterns, admixture, genetic drift and other features of human populations change over time. Accordingly, this preliminary estimate of worldwide ADME variation should be updated, for example, using the Update Engine 106 described by this invention. In addition, these phenotypes may be further refined for any individual or group of individuals to include further data attributes defined by a set of clinical co-variables as provided by this invention (See FIGS. 1G and M.

### Clinical Data Attributes

In order to further enhance the power of the pharmacogenomics-based classifier, de-identified electronic health records (EHRs) were mined to identify co-variables that would impact pharmacogenomic decision support. First, the EHR data values most highly correlated with prediction of metabolizer phenotype needed to be determined. Initial experiments examined prediction of CY2D6 phenotype by the classification system. These were followed by experiments utilizing over three million (3,923,211) patient records in 3 EHR datasets from several large hospital systems. Data derived from statistical analysis of all data fields were used for the analysis. During this analysis, two challenges became apparent. First, EHR systems that contained high quality data that were not artificially constrained within a highly structured environment were most useful for statistical analysis. This could be before any ‘data cleansing’ that could introduce artifact, or after careful cleansing. It was important to obtain genuine data elements that would provide power to the testing. It was also critical to identify the minimal set of such data values. This is because learning machines such as support vector machines provide the most accurate results when driven by a necessary and complete set of input co-variables, with each co-variable having a range of dimensionality, such as some variance around a mean. The second challenge was that increasing the ability to use a pharmacogenomic classification system to improve therapeutic drug response was not the only objective. Instead, it was also important to define which clinical co-variables added to a patient's or participant's risk of experiencing an adverse event (AE) or adverse drug reaction (ADR) through a more direct manner than can be explained by population structure by itself.

Testing of significant clinical co-variables, as derived data values from de-identified EHR datasets, demonstrated that a finite but important group of limited values contributed to pharmacogenomic classification and/or ADR risk. The focus was on the discovery of clinical values that contribute to ADR risk, which can be used for regression-based analytics. Twenty one (21) data values, in addition to population structure, showed significant association with pharmacogenomic phenotype and/or ADR risk probability. The data values included (1) self-reported ethnicity; (2) self-reported sex for ADR risk only if patient is female; (3) self-reported age for ADR risk only if patient is over 75 years of age; (4) certain ICD codes (ICD codes represent a class of diagnostic criteria defined in the International Classification of Diseases, see FIG. 1G for a listing of the ICD codes) indicative of disease states that are most highly associated with ADR risk; (5) the number of concomitant medications that that a patient takes that exceed four; (6) a patient's history of the number of adverse events that exceed two; (7) the number of medication refills that differ significantly from a normative pharmacy profile; and for ADR risk only, (8) the extent of poly-pharmacy, indicated by the absolute number of concomitant medications. A complete listing of the significant clinical co-variables identified in this analysis is shown in FIG. 1G and Table 5, which also gives the associated p-values.

TABLE 5
Clinical data in the EHR was significantly associated with
either pharmacogenomic phenotype or probable ADR risk
as determined by ANOVA in R.

| | P-Value |
|---|---|
| De-identified EHR data | |
| Sex if female | 0.001 |
| Age over 75 years | 0.0001 |
| Number of concomitant medications that exceed 4 | 0.0023 |
| Ethnicity | 0.02 |
| Number of Adverse Events Reported that exceeded 2 | 0.03 |
| Requests for medication refills that differed | 0.001 |
| significantly from the norm | |
| Absolute number of concomitant medications | 0.000001 for |
| | ADR risk only |
| ICD Codes | |
| Esophageal reflux | 0.005 |
| Peptic ulcer, site unspecified | 0.01 |
| Ulcerative colitis | 0.001 |
| Diabetes mellitus | 0.001 |
| Acute pulmonary heart disease | 0.01 |
| Ischemic heart disease | 0.001 |
| Primary Hypertension | 0.05 |
| Cardiomyopathy | 0.01 |
| Cerebral thrombosis | 0.0005 |
| Cardiovascular disease, unspecified | 0.005 |
| Major depressive disorder | 0.0005 |
| Depression, bi-polar disorder | 0.03 |
| Depressive disorder | 0.001 |
| Anxiety disorders | 0.05 |

All of the data attributes shown in Table 5 were statistically significant in terms of association with pharmacogenomic phenotype and/or ADR risk when analyzed in the context of this large dataset of over three million individual patient records. The ICD-9 codes were of lower significance in the set compared to the smaller preliminary dataset while each of the following data attributes increased in significance: (a) Number of Adverse Events Reported that exceeded 2, p-value <0.0001; (b) Requests for medication refills that differed significantly from the norm, p-value <0.00001; (c) Number of concomitant medications, p-value <0.0001; and (d) Ethnicity, p-value <0.0005.

Significance of the clinical co-variables was determined for ADR risk when combined with ADME population structure by testing known determinants including female sex, age over 75 years, and the number of concomitant medications an individual patient takes each day. In all cases, ADME population structure was the largest determinant if ADR risk, as it was it was for pharmacogenomic classification (FIG. 1G). For ADR risk, assignment of the weight of each value was determined with unity being the case in which an ADR would occur in any given patient. Although this is largely dependent on pharmacogenomic phenotype, each additional drug the patient takes each day contributes 0.037 per drug. That may seem like an insignificant contribution to ADR risk, but in medical specialties such as psychiatry and cardiology, the degree of poly-pharmacy is often high, as shown below in Table 6:

TABLE 6
Extent of Poly-Pharmacy in Psychiatry¹ and Cardiology² in 2012

| | NUMBER OF | |
|---|---|---|
| | CONCOMMITANT | |
| PATIENT | DRUGS PER DAY | WEIGHTED VALUE |
| Office-based psychiatric | 5 | 5 × 0.037 = 18.5% |
| practice | | |
| Hospital inpatients - | 9 | 9 × 0.037 = 33% |
| psychiatry | | |
| Outpatients on anti- | 3.8 | .8 × 0.037 = 14% |
| hypertensive medications | | |

¹National Institute of Mental Health.
²American College of Cardiology.

Thus, a female inpatient over the age of 75 years with hypertension taking 9 medications for a psychiatric disorder and 3.8 antihypertensives has the following probability of having an adverse drug reaction:

### 14%+27%+33%+14%=88% Chance of Experiencing an ADR, Independent of Pharmacogenomic Phenotype.

This represents an extreme example, and in most cases, a patient's pharmacogenomic phenotype will be a larger determinant of probable ADR risk. There was no testing of the significance of ICD diagnostic codes for ADR risk.

In summary, the studies discussed above demonstrate that not only human genome variome data can be used to significantly classify any human as to potential pharmacogenomic genotype, but that additional co-variables derived from clinical data provide extra power for classification.

### Validation Studies

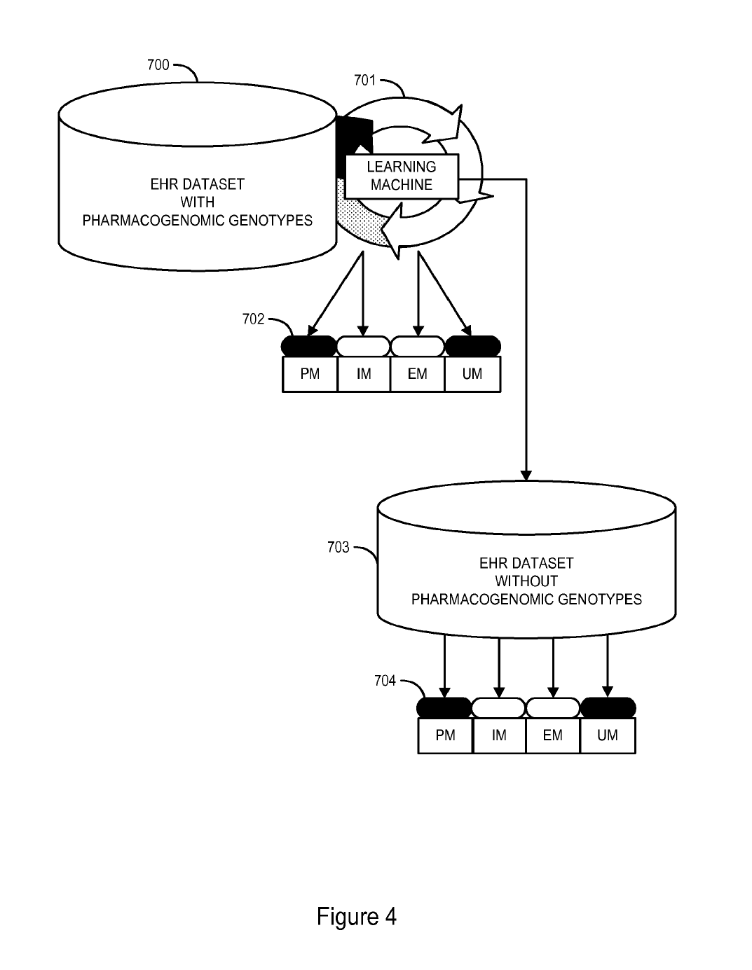

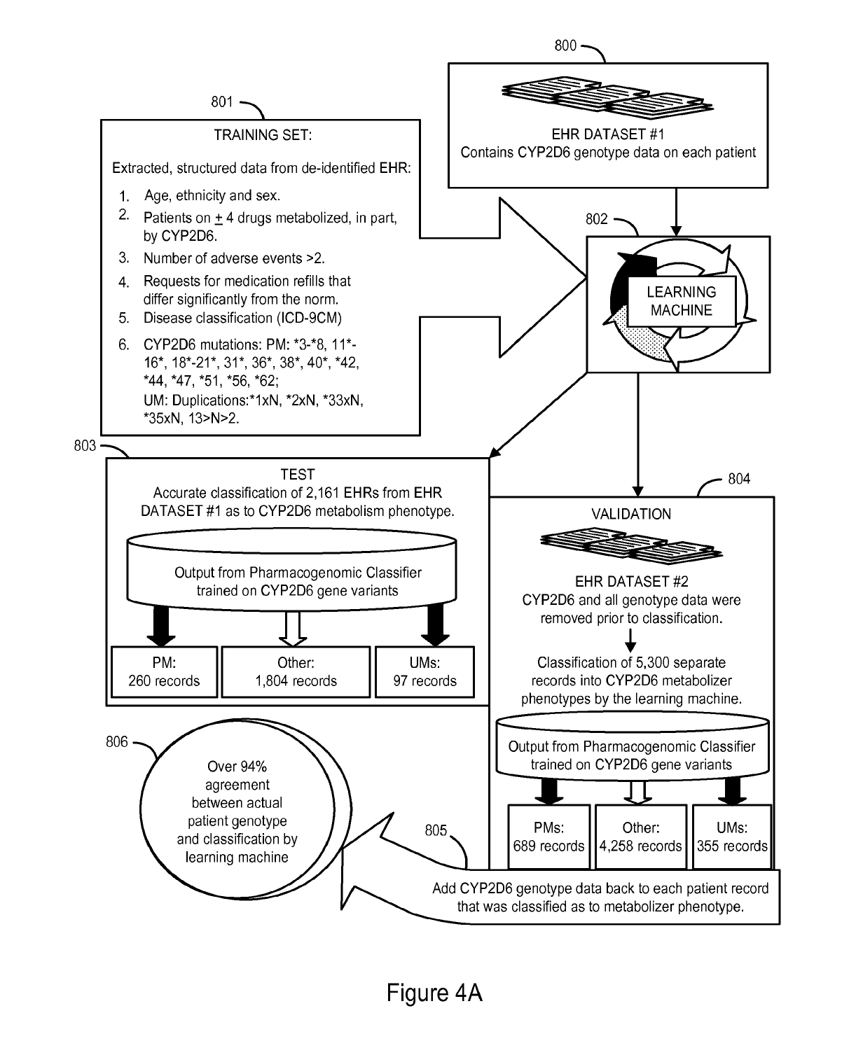

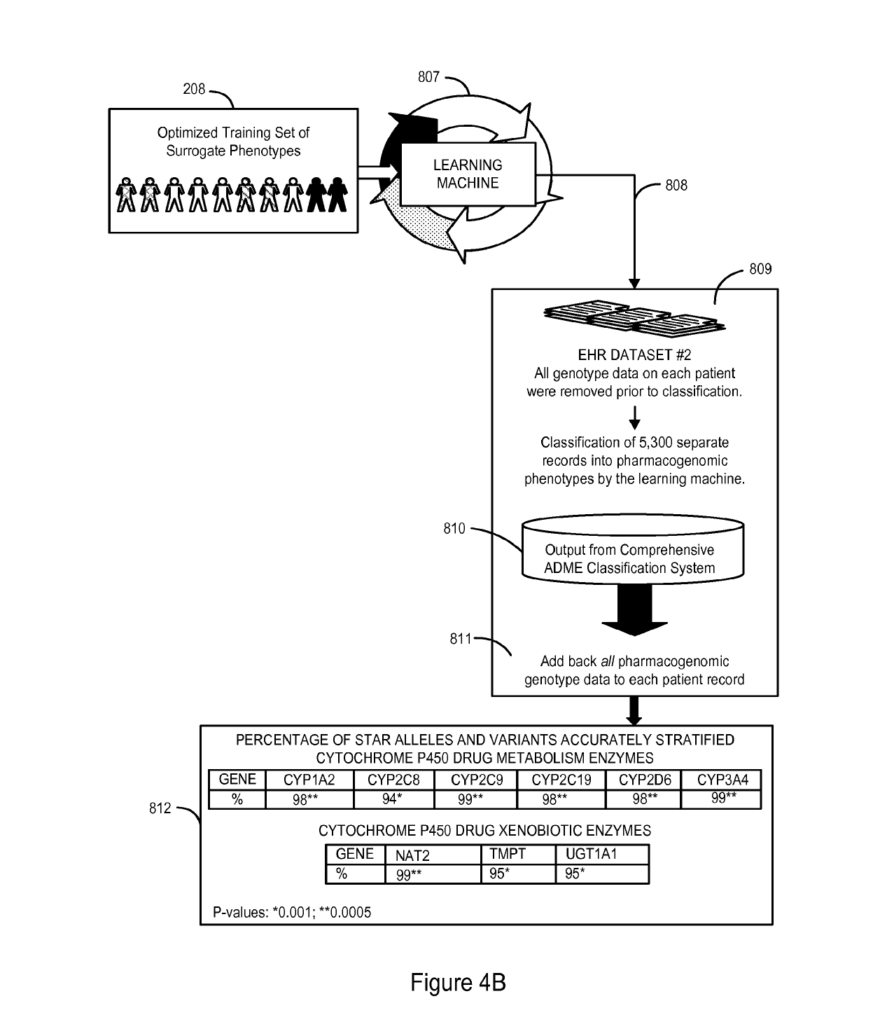

The objective of the first experimental study was to test whether a pre-trained learning machine could classify a cohort of participants into one of four CYP2D6 metabolizer phenotypes as shown in FIG. 4. In this embodiment, an EHR dataset lacking pharmacogenomic genotypes 700 is tested using a learning machine 701 for its ability to classify metabolizer subtypes into Poor Metabolizer (PM), Intermediate Metabolizer (IM), Extensive Metabolizer (EM) and Ultra-Rapid Metabolizer (UM) 702. Next, it is determined that the same learning machine 701 can classify an EHR dataset lacking any genomic data 703 in an accurate manner into metabolizer subtype 704.

The classifier was first validated with a simple stratification strategy using actual known variants as shown in FIG. 4A as the training set. The learning machine was trained on two de-identified EHR datasets—one labeled as the ‘#1’ EHR dataset 800, and a different group of records labeled the ‘#2’ EHR dataset 804. In addition, a subset of each of these EHR datasets had been ‘cleansed’ to remove missing data elements to enhance statistical prediction. Both of the EHR datasets used here have been used routinely for machine learning tasks using structured data contained in the datasets to meet the requirements of several ongoing epidemiological studies.

The learning machine was optimized utilizing ensemble techniques. Computational efficiency was measured with the central processing unit processing times required for model training. The ELM was tested using the full feature set, as well as the reduced feature set extracted from cleansed EHRs optimized using a merit-based dimensional reduction strategy. Experiments were completely blinded.

Populations of records were selected that contained de-identified EHR data meeting the following criteria and used as the training set 801:
1. Age, race and sex.
2. Patients were on ±4 medications that were metabolized by CYP2D6. These were selected by using the machine-readable, structured profiles contained in different EHR datasets, labeled ‘#1’ 800 and ‘#2 804.’
2. Other data from the EHR dataset ‘#1’ 800 were used: ICD-9CM diagnoses (cancer patients were excluded), number of adverse events >2, frequency of medication refills that differed significantly from the norm, and CYP2D6 gene mutations as shown in FIG. 4B 801. These data were used as the training set for the learning machine used in these instances.

In this experiment, all ‘clinical’ structured data from race, adverse event data, disease classification (ICD-9CM), and medication profiles were extracted from the records. A resulting 2,161 records each contained all of the requisite EHR data. The choice of EHR data types was based on either prospective or retrospective measures of significance, depending on the variable for their contribution to their ability to stratify in relation to CYP2D6 phenotype. This training set also included CY2PD6 SNP data that were available for each individual used to generate these records. We used the star allele nomenclature as defined in The LK and Bertilsson L (2012) “Pharmacogenetics of CYP2D6”, Metab. Pharmacokinet. 27(1): 55-67 for these feasibility tests.

Note that in these test cases, both data extracted from a real population of patients were used, as well as a dataset of CYP2D6 star alleles that have been shown to discriminate metabolizer phenotypes.

In order to provide the best “first pass” at observing a data-driven result, the experimental design was intentionally biased to obtain a significant result by including only the ‘metabolizer outliers’— PM and UM in the analysis. Since the selected records ranged from 97-98% Caucasians (white) in the EHR datasets ‘#1’ 800 and ‘#2’ 804, the machine learning tasks would need to have the sensitivity to detect greater than a 10% delta for definition of PM, and a resolving accuracy better than 2% to detect carriers of the CYP2D6 duplication/multi-duplication set for accurate classification. The mathematical approach is described in detail in a publication by Gao and Martin [Gao S and Martin ER (2009) Using allele sharing distance for detecting human population stratification. Human Hered. 68:182-191], and is subsumed herein. ASD is a pair-wise measure between individuals, and is defined by the expression:

$$ASD = \frac{1}{L} {\sum }_{l = 1}^{L} d l$$

where dl=0 if two individuals have two alleles in common at the l-th locus; dl=1 with one allele in common, and dl=2 when there are no alleles in common

The learning machine trained on de-identified clinical and genotype data contained in EHR dataset ‘#1’ 800 was tested for its ability to classify the data contained in dataset ‘#1’ 800. Then, without any information about patient genotype in EHR dataset #2 804, validation was performed to determine if the learning machine could accurately classify the outlier CYP2D6 phenotypes from EHR dataset #2 804. When the genotype data contained in the EHR dataset ‘#2’ 804 was retrospectively matched with the experimental outcome 805, the results showed that the learning machine had accurately classified both the PM phenotype (94% concordance; p-value <0.001) and the UM phenotype (90% concordance; p-value <0.05) 806.

In summary, the very tight concordance between predicted and actual metabolizer phenotypes for the PM and UM phenotypes demonstrates that accurate classification of pharmacogenomic metabolizer status can be accomplished using the methods of the invention, even in the absence of accompanying genotype values.

Next, we conducted an experiment to determine whether the classifier could accurately discretize EHR dataset #2 804 containing a larger number of ADME variants limited to a few phase I and phase I metabolic genotypes 809 using a learning machine trained on the optimized surrogate phenotype-based training set (see output on FIG. 1A, 208) that was used for classification of 54 different pharmacogenomic populations as defined by the present invention. This system is shown in FIG. 4B. The comprehensive ADME classification system 810 that is the core of this invention was able to stratify star allele and other variant data contained in the EHR dataset #2 809 when all the available pharmacogenomic genotype was added back 811 with a high degree of accuracy 812.

### Exemplary Applications of the Methods and Systems of the Invention

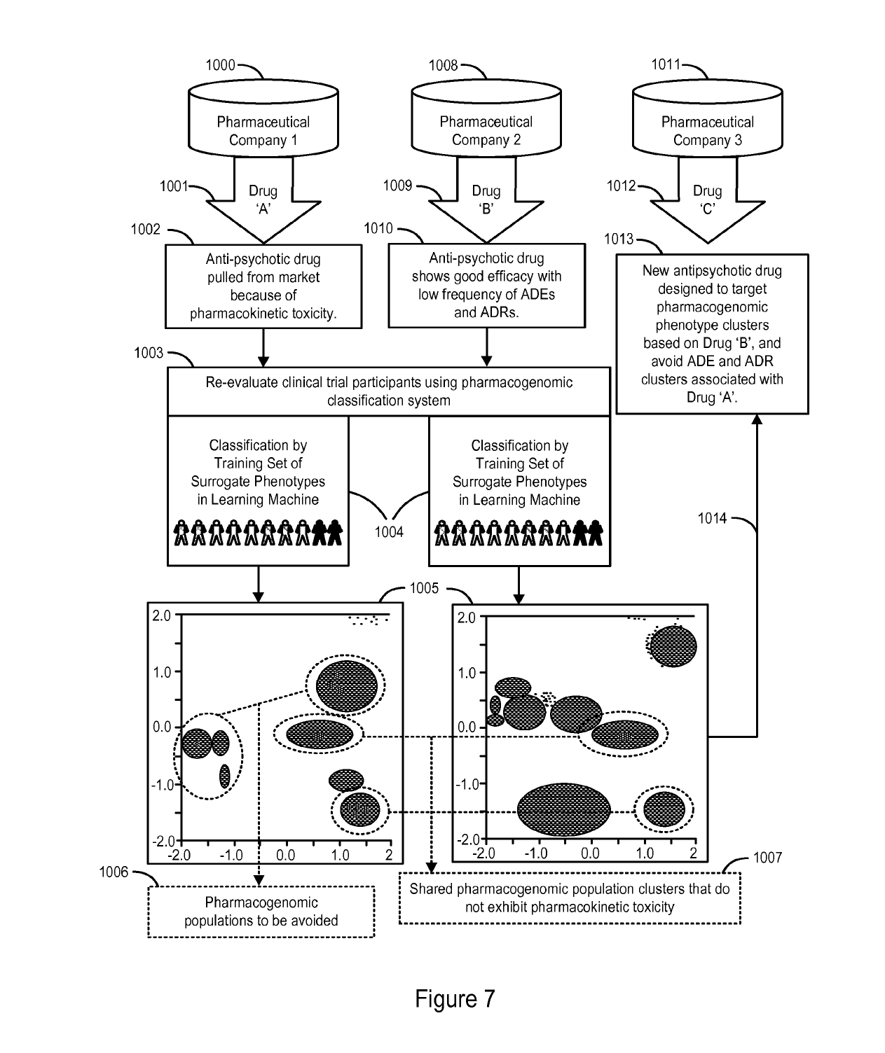

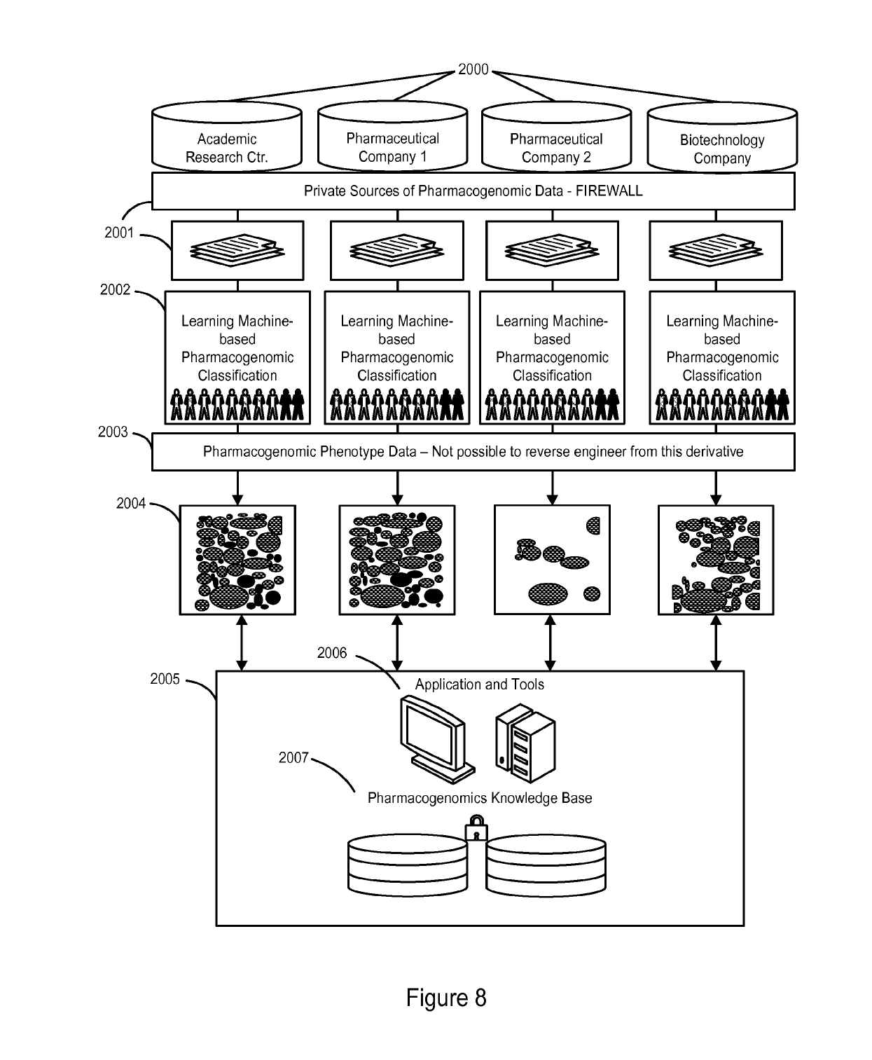

1. An exemplary embodiment of the invention would be its application to proactive detection of a potential ADR risk for an inpatient in a hospital, clinical or other setting where a EHR is used that contains a clinical decision support (CDS) system (FIG. 6). This embodiment involves the use of the invention 901 to classify 902 a patient 900 upon admission to a hospital, clinical or other inpatient setting. As an option, the admitting physician or clinician may change the pharmacogenomic classification by input of clinical and environmental modifiers, including known clinical characteristics of the patient, as derived from an EHR or other source, self-reporting by the patient, and/or other clinical values that might modify the foundational pharmacogenomic classification of the system as defined herein 903. These clinical co-variables might include such patient-specific data such as family history, number and type of medications the patient is currently taking, diagnoses as defined by ICD code, or genotype data. These data values can be entered using an interactive learning machine, with an interface that has been configured to provide the clinical end-user to be simple and usable.
   Using various systems and methods, the patient's pharmacogenomic phenotype as determined by the classifier described by this invention will be entered by assigned stratum into the EHR 904, where it will be available for any clinical application as warranted. Whenever the newly admitted patient is prescribed a new medication 905, the pharmacy information system will prompt the EHR to check the ADME variation profile 902 as determined by the pharmacogenomic classification system against all possible medications in the drug database, for automated prediction of ADR risk 906. This check will examine all possible known drug-drug interactions, drug-gene interactions, as well as the sex, age and number of concomitant medications currently taken by the patient, and ICD disease code status. This search will be undertaken in all relevant and available drug knowledge databases to find problems.
   To prevent ADR risk if a problem is detected based on the automated check of the new prescription, the EHR 906 will prompt 907 the CDS 908. The CDS 908 will generate an alert for the prescribing clinician, and an alternative therapeutic regimen will be provided for medical treatment of the patient 909.
2. An exemplary embodiment of the invention is application to drug discovery and development (FIG. 7) in which pharmacogenomic population clusters that are indicative of pharmacokinetic toxicity and generate a high incidence of ADRs detected by spontaneous reporting systems (SRS) during post-marketing surveillance, resulting in withdrawal of a drug from the market can provide guidance for future drug development.
   For example, in FIG. 7, use of the pharmacogenomic classification system described in this invention can identify the population clusters that were impacted in a negative manner by ‘Drug A’ 1001 developed by ‘Pharmaceutical Company 1’ 1000. In this example, ‘Pharmaceutical Company 2’ 1008 developed an effective antipsychotic ‘Drug B’ 1009 without the pharmacokinetic ADRs induced by ‘Drug A’ 1002.
   Comparison of the pharmacogenomic population clusters between ‘Drug A’ and ‘Drug B’ 1005, as derived from the pharmacogenomic classification system defined by this invention 1004, show that certain populations are shared 1007 and others are not 1006. Thus, when ‘Pharmaceutical Company 3’ 1011 wants to develop a new antipsychotic drug that is effective 1014, it should perform simple pattern analysis on the output of the pharmacogenomic phenotype classification system of this invention and include the intersection of the two sets of population clusters of ‘Drug A’ and Drug B′ 1007, which would not produce pharmacokinetic toxicity, but avoid any of the other population clusters 1006 in the output of the pharmacogenomic phenotype classifier 1004 for ‘Drug A’ 1002, which would likely produce an unacceptably high level of risk for any patient taking the medication.
3. An exemplary embodiment of the invention is to serve as the foundation for a pre-competitive data-sharing informatics platform such as tranSMART (FIG. 8—see, e.g., Perakslis, ED, Van Dam J and Szalma S. How informatics can potentiate precompetitive open-source collaboration to jump-start drug discovery and development. Nature. 2010. 87(5):614-616). For this application, private-public-partners in drug development, including pharmaceutical companies, biotechnology companies, and academic research centers 2000 can share pharmacogenomic knowledge in an open but secure setting.
   Although data resources such as the pharmacogenomics knowledge base (www.pharmgkb.org) are available, there exists a much greater wealth of pharmacogenomic knowledge from clinical trials and other sources that are ‘cloistered but distributed’ in pharmaceutical research and development 2001. During times when drug discovery and development is in jeopardy, fear that intellectual property may be compromised is less of a threat than the drive to collaborate for sharing of clinical trial participants, pharmacogenomic informatics and other resources in drug development.
   As shown in FIG. 8, this invention provides a secure system for access to pharmacogenomic data because only the output of the pharmacogenomic classification system of this invention can be visualized as pharmacogenomic populations 2002, with no ability to reverse engineer a learning machine-based process 2003. Thus, it provides a firewall between any component members of the tranSMART community 2001, unless there is an explicit collaborative agreement to share such data in a more direct fashion.
   Knowledge databases such as PharmGKB and Medline mine published articles as their source of primary, where publication bias can negatively affect ground truth. For example, various specialties and/or domains are less likely to publish negative results than are others, resulting in an uneven registry of knowledge. In contrast, by exposing negative and positive results from clinical trials in a secure environment in the context of a derivative data output, such as can be obtained from a learning machine 2004, all results can be examined without loss of intellectual property and without risk of personal identification.
   With the use of multiple learning machine-based pharmacogenomic classification systems as defined in this invention, the multiplicity of harvested data 2004 increases the accuracy of subsequent learning machine-based classification. This results from the use of a plurality of learning machine-based pharmacogenomic classifiers as outlined in the invention 2004, each tied to a specific database 2000 2001, where the amalgamation of such classifiers increases the accuracy of pharmacogenomic population clustering over time for the entire community of users. The community of end-users 2000 can take advantage of applications and tools 2006 in the informatics platform 2005 to manipulate this optimized pharmacogenomics knowledge base 2007 for their mutual benefit.

What is claimed is:

1. A method for classifying an individual or group of individuals into one of a member of a discrete set of pharmacogenomic phenotypes, the method comprising using as a classifier a learning machine pre-trained on a training dataset comprising genes encoding proteins involved in the absorption, distribution, metabolism and excretion (ADME) of medications and xenobiotics (ADME genes) and specific variants of those genes, said variants comprising variant star alleles, single nucleotide polymorphisms (SNPs), and structural variants, wherein the ADME genes and gene variants are instantiated in the training set as a discrete set of ‘surrogate phenotypes’ obtained using methods of population structure and clustering, and wherein the surrogate phenotypes have been optimized for classification in one or more pre-processing steps.

2. The method of claim 1, wherein the method comprises the step of receiving at a processor all available genotype and phenotype data for the individual or group.

3. The method of claim 2, wherein the step of receiving is performed by a computer system querying a database or by the manual addition of known clinical or genomic data for the individual or group, or both.

4. The method of claim 1, wherein the ADME genes and gene variants are instantiated in the training set as a discrete set of ‘surrogate phenotypes’ obtained using methods of population structure and clustering comprising multivariate statistical analysis.

5. The method of claim 4, wherein the multivariate statistical analysis comprises one or more of the following (1) allele-sharing distance (ASD) between populations and multi-dimensional scaling (MSD) or ASD and gap analysis; (2) principal components analysis (PCA) with eigenanalysis; and (3) automatic inference of number of clusters and population structure from admixed genotype data.

6. The method of claim 1, wherein the one or more pre-processing steps used to optimize the discrete set of surrogate phenotypes for classification is selected from the group consisting of
(i) correction of any missing or erroneous ADME variation data;
(ii) automated comparison to pharmacogenomic knowledge bases;
(iii) manual validation through comparison to the known worldwide distribution of ADME variation in genes that encode phase I and phase II drug metabolizing enzymes (DMEs) and drug transporter proteins (DTPs); and
(iv) examination of the training set to ensure appropriate dimensionality by transformation of coordinates as required.

7. The method of claim 6, wherein the one or more pre-processing steps used to optimize the discrete set of surrogate phenotypes for classification comprises each of (i) to (iv).

8. The method of claim 1, further comprising a pre-processing step to equalize the data and ensure the correct dimensionality of the data.

9. The method of claim 1, further comprising a pre-processing step of reformatting or augmenting the data to provide missing data attributes necessary for accurate classification.

10. The method of claim 1, further comprising a pre-filtering step to prepare the data for classification by the learning machine.

11. The method of claim 1, wherein the learning machine is selected from the group consisting of a support vector machine, an extreme learning machine, and an interactive learning machine.

12. The method of claim 10, wherein the learning machine is a support vector machine and the training dataset comprises the genes and gene variants set forth in Table 1.

13. The method of claim 10, wherein the learning machine is an extreme learning machine and the training dataset comprises the genes and gene variants set forth in Table 1 or Table 2.

14. The method of claim 1, further comprising a second training dataset consisting of a set of clinical co-variables from a de-identified electronic health record (EHR) that are significantly associated with drug metabolizer phenotype.

15. The method of claim 14, wherein the set of clinical co-variables comprises or consists of self-reported ethnicity, self-reported sex, self-reported age, number of concomitant medications exceeding four, number of adverse events exceeding two, number of medication refills showing a significant difference from a normative pharmacy profile, wherein the number of concomitant medications, adverse events, and medication refills are each determined on an individual basis where the method is directed to classifying a group of individuals.

16. The method of claim 1, further comprising a post-processing step performed on the learning machine output for comprehension by a human or computer.

17. The method of claim 1, further comprising a post-processing step of altering the classification output of the learning machine using clinical and environment modifiers obtained for the individual or group, the modifiers being selected from one or more of the group consisting of incidence of childhood abuse, family history, positive lifestyle factors, negative lifestyle factors, polypharmacy, co-morbid disease, female sex, and age over 75 years.

18. The method of claim 1, further comprising a post-processing step of annotating the data for use by a Clinical Data Management System.

19. The method of claim 1, wherein the individual is further classified as to pharmacokinetic risk of an adverse drug reaction using a set of clinical data values extracted from a large dataset of de-identified electronic health records, the set of clinical data attributes consisting of self-reported race or ethnicity, self-reported sex, self-reported age, ICD diagnoses, number of concomitant medications, number of adverse events reported, and frequency of pharmacy refills.

20. The method of claim 19, wherein the discrete set of pharmacogenomic phenotypes is identified by a method comprising the step of extracting each of the following data values from the large dataset of de-identified electronic health records:
(a) Requests for medication refills that differed significantly from the norm, which is utilized to determine whether an individual is a slow, intermediate, extensive or ultrarapid metabolizer, further refining classification into a discrete stratum;
(b) Number of Adverse Events Reported that exceeded 2, which is utilized to determine underlying medication problems associated with a given individual to bin into a stratum;
(c) Number of concomitant medications; and gender and ethnicity which are determinative and replicative, respectively; and
(d) ICD-coded classification.

21. A method for identifying an individual or group of individuals at risk for having one or more of an adverse event, an adverse drug reaction, a sub-therapeutic effect, or a non-therapeutic effect compared to the general population, the method comprising classifying the individual or group according to the method of claim 1 and determining whether or not the individual or group falls outside the discrete set of pharmacogenomic phenotypes, wherein if the individual or group falls outside the discrete set of pharmacogenomic phenotypes the individual or group is a pharmacogenomic outlier and is at increased risk for having one or more of an adverse event, an adverse drug reaction, a sub-therapeutic effect, or a non-therapeutic effect, compared to the general population.

22. The method of claim 21, wherein the method identifies a pharmacogenomic outlier for CYP2D6, and the training dataset consists of the following clinical data attributes: (1) age; (2) sex; (3) ethnicity; (4) patients on ±4 drugs, which have to be metabolized, in part, by CYP2D6; (5) number of adverse events >2; (6) requests for medication refills that differ significantly from the norm; (7) disease classification (ICD-9CM); and a set of genomic data attributes consisting of the set CYP2D6 mutations resulting in either a poor metabolizer phenotype or an ultrarapid metabolizer phenotype.

23. The method of claim 22, wherein the set of CYP2D6 mutations resulting in a poor metabolizer phenotype comprises or consists of the following star alleles: *3-*8, 11*-16*, 18*-21*, 31*, 36*, 38*, 40*, *42, *44, *47, *51, *56, *62 and wherein the set of CYP2D6 mutations resulting in an ultrarapid metabolizer phenotype comprises or consists of the following gene duplications: *1×N, *2×N, *33×N, *35×N, 13>N>2.

24. The method of claim 10, wherein the learning machine is a support vector machine, the training dataset consists of the following genes and their variants (a) CYP1A2; (b) CYP2C8; (c) CYP2C9; (d) CYP2C19; (e) CYP2D6; (f) CYP3A4; (g) NAT2; (h) TMPT; and (i) UGT1A1, and the method further comprises a second training dataset consisting of a set of clinical co-variables from a de-identified electronic health record (EHR), the set of clinical co-variables consisting of the following: age, race, gender, individuals taking medications metabolized by CYP2D6, ICD-9 code diagnoses (cancer patients excluded), number of adverse events >2, frequency of medication refills that differed significantly from the norm, and CYP2D6 genotype data.

25. The method of claim 24, wherein the set of clinical co-variables from the de-identified electronic health record (EHR) further comprises a set of ICD-9 code diagnoses selected from the group consisting of Esophageal reflux, Peptic ulcer, site unspecified, Ulcerative colitis, Diabetes mellitus, Acute pulmonary heart disease, Ischemic heart disease, Primary Hypertension, Cardiomyopathy, Cerebral thrombosis, Cardiovascular disease, unspecified, Major depressive disorder, Depression, bi-polar disorder, Depressive disorder, and Anxiety disorders.

26. The method of claim 25, wherein the set of ICD-9 code diagnoses consists of Esophageal reflux, Peptic ulcer, site unspecified, Ulcerative colitis, Diabetes mellitus, Acute pulmonary heart disease, Ischemic heart disease, Primary Hypertension, Cardiomyopathy, Cerebral thrombosis, Cardiovascular disease, unspecified, Major depressive disorder, Depression, bi-polar disorder, Depressive disorder, and Anxiety disorders.

27. The method of claim 26, wherein the individual or group of individuals has been diagnosed with a psychiatric disease or disorder.

28. A method of pharmacogenomic decision support in a hospital, clinic or other inpatient setting for the avoidance of pharmacological risk of an adverse event or adverse drug reaction, the method comprising classifying an inpatient into a pharmacogenomic phenotype according to the method of claim 1, wherein the classification is modified by one or more clinical and/or environment modifiers, receiving at a processor of a clinical decision system the modified pharmacogenomic phenotype for the inpatient, executing a set of instructions which cause the processor to query one or more drug databases for evidence of a potential adverse event based on hazardous drug-drug interactions, drug-gene interactions and producing an alert signal if an adverse event is detected.

29. The method of claim 25, further comprising providing the physician with an alternative, optimal therapeutic regimen for the inpatient.

30. A method for drug development, the method comprising identifying a drug that does not exhibit pharmacokinetic toxicity by pattern-matching of pharmacogenomic phenotype population clusters between 2 or more similar drugs, wherein the pattern-matching can be used to identify optimal as well as potentially hazardous pharmacogenomic phenotypes for the intended use of the drug, and wherein the pharmacogenomic phenotype population clusters are determined according to the method of claim 1.

31. A method for developing a pharmacogenomic knowledge database using as source data pharmacogenomic data contained in private databases of pharmaceutical companies, biotechnology companies and academic research centers, the method comprising subjecting the source data to pharmacogenomic phenotype classification according to the method of claim 1, and consolidating the resulting set of surrogate phenotypes into a single database.
